(19) United States
(12) Patent Application Publication
(10) Pub. No.: US 2009/0072615 A1
(43) Pub. Date: Mar. 19, 2009

(54) APPARATUS FOR AND METHOD OF CONTROLLING BRAKES

(75) Inventors: Toshiya OOSAWA, Yokohama-shi (JP); Katsuya ISWASAKI, Isehara-shi (JP)

Correspondence Address: FOLEY AND LARDNER LLP;SUITE 500, 3000 K STREET NW, WASHINGTON, DC, 20007, US

(73) Assignee: HITACHI, LTD.

(21) Appl. No.: 12/208,064

(22) Filed: Sep. 10, 2008

(30) Foreign Application Priority Data
Sep. 14, 2007 (JP) 2007-238741

(51) Int. Cl. B60T 8/34; B60T 7/12

(52) U.S. Cl. 303/113.1; 303/113.3; 701/79

(57) ABSTRACT

An apparatus for controlling brakes, includes a first brake circuit for supplying brake fluid, pressure-increased by a booster, to a wheel-brake cylinder, a first control valve disposed in the first brake circuit for establishing and blocking fluid communication between a master cylinder and the wheel-brake cylinder, a second brake circuit arranged in parallel with the first brake circuit for supplying brake fluid, pressure-increased by a fluid-pressure source, to the wheel-brake cylinder, and a second control valve disposed in the second brake circuit for establishing and blocking fluid communication between the fluid-pressure source and the wheel-brake cylinder. Also provided is a control unit, which is configured to selectively control the first and second control valves when building-up wheel-cylinder pressure, and further configured to build-up the wheel-cylinder pressure by operating the fluid-pressure source when at least the second control valve is controlled to a valve-open position.

### TECHNICAL FIELD

The present invention relates to an apparatus for and a method of controlling each wheel-brake cylinder pressure of an automotive vehicle, based on a driver's braking operation and/or a vehicle traveling state.

### BACKGROUND ART

In recent years, there have been proposed and developed various automatic braking devices. One such braking device has been disclosed in Japanese Patent Provisional Publication No. 2004-9914 (hereinafter is referred to as “JP2004-009914”). FIG. 25 is a hydraulic circuit diagram showing a hydraulic system configuration of the braking device as disclosed in JP2004-009914 (a comparative example). The braking device shown in FIG. 25 is configured to build up each wheel-brake cylinder pressure, directly, by using a brake-fluid pressure produced by a driver's braking operation at a normal brake mode, and also to perform automatic wheel-cylinder pressure control (simply, automatic brake control) by using a pump discharge pressure. Such automatic brake control can be applied to various vehicle controls, such as anti-skid control (hereinafter is referred to as “ABS control”), vehicle dynamics control (hereinafter is referred to as “VDC control”), brake-assist control (hereinafter is referred to as “BA control”), and the like. Here, the “ABS” control means automatic brake control according to which pressure-buildup, pressure-hold, and pressure-reduction for wheel-cylinder pressure are repeatedly executed to prevent a wheel lock-up condition and thus provide maximum effective braking, if the brakes are applied so hard, that the road wheels tend to stop turning, and thus a skid starts to develop. The “VDC” control means automatic brake control according to which wheel-cylinder pressures of road wheels, subjected to vehicle dynamics control, are controlled to stabilize the vehicle attitude (or vehicle dynamic behavior), when the vehicle experiences excessive oversteer/understeer tendencies during turns. The “BA” control means automatic brake control that enables a higher buildup of wheel-cylinder pressure in the wheel-brake cylinder in comparison with an actual brake fluid pressure produced in a master cylinder during a driver's braking operation (a driver's brake-pedal depression).

FIG. 24 shows the force flow (especially, the flow of an operating force created by the driver's braking operation and the flow of working fluid pressure produced by a fluid-pressure source such as a pump) and brake-fluid flow during a wheel-cylinder pressure buildup in the hydraulic system configuration shown in FIG. 25. As clearly seen in FIG. 24, in the case of the braking device as disclosed in JP2004-009914, during a wheel-cylinder pressure buildup achieved by the driver's braking operation, the driver's operating force is transmitted from the brake pedal through a brake booster, a master cylinder, a master-cylinder pressure cutoff valve (simply, a master-cut valve), and a pressure-buildup control valve to a wheel-brake cylinder, in that order. In contrast, during a wheel-cylinder pressure buildup achieved by operating the fluid-pressure source (the pump), working fluid (brake fluid) flows from a brake-fluid reservoir through the master cylinder, the pump, and the pressure-buildup control valve to the wheel-brake cylinder, in that order.

### SUMMARY OF THE INVENTION

However, in the braking device as disclosed in JP2004-009914, during either (i) a wheel-cylinder pressure buildup achieved by the driver's braking operation or (ii) a wheel-cylinder pressure buildup achieved by operating the fluid-pressure source (e.g., the pump), the hydraulic brake system is configured to supply brake fluid via both the master cylinder and the pressure-buildup control valve to the wheel-brake cylinder. Thus, there is a problem of undesired interference between (i) the wheel-cylinder pressure buildup achieved by the driver's braking operation and (ii) the wheel-cylinder pressure buildup achieved by operating the fluid-pressure source, which interference may occur in both the master cylinder and the pressure-buildup control valve. This leads to the reduced controllability for wheel-cylinder pressure control and the lowered operability for the brakes, in other words, a poor feel of the brake pedal on the automatic-braking-device equipped vehicle. More concretely, the braking device as disclosed in JP2004-009914 has the following drawbacks.

First, for instance during VDC control, suppose that the brake pedal is further depressed by the driver. In such a case, the master-cut valve is kept closed, and thus brake fluid cannot be supplied from the master cylinder to the wheel-brake cylinder without passing through the pump. It is difficult to directly reflect a driver's intention of increasing a vehicle deceleration rate (a negative longitudinal acceleration G), thereby lowering the controllability for wheel-cylinder pressure control. Additionally, at this time, the wheel-cylinder pressure (=the upstream pressure of the pressure-buildup control valve=the pump pressure) becomes higher than the master-cylinder pressure, thus causing a reduction in the pump inlet flow rate. This leads to the difficulty of providing a brake-pedal stroke, thereby resulting in a poor or uncushioned feel of the brake pedal on the automatic-braking-device equipped vehicle.

Secondly, suppose that BA control is initiated by operating the pump, simultaneously with a wheel-cylinder pressure buildup achieved by the master cylinder with the master-cut valve kept open. At this time, owing to a stroke of the master-cylinder piston, fluid-communication between the reservoir and the master cylinder is blocked, and thus there is no brake-fluid supply from the reservoir to the pump. As a result, the amount of brake fluid introduced through the pump inlet port is limited to the amount of brake fluid discharged from the master cylinder. Therefore, during BA control, it is difficult to rapidly build up the wheel-cylinder pressure at a speed exceeding the traveling speed of the master-cylinder piston, and thus it is impossible to enhance the controllability of the brake control system.

Thirdly, suppose that the valve seat, on which the valve element of the pressure-buildup control valve is seated, is designed to have a large valve-seat diameter. Because of the large-diameter valve seat, it is possible to enhance the brake system's responsiveness during a normal brake mode at which the wheel-cylinder pressure is built up by a driver's braking operation. However, the use of the large-diameter valve seat leads to the lowered fluid-pressure control accuracy during automatic brake control (in other words, during a control brake mode) that a buildup of the wheel-cylinder pressure is achieved by means of the pump. Thus, it is difficult to reconcile the enhanced brake system's responsiveness during the normal brake mode and the enhanced fluid-pressure control accuracy during automatic brake control, by the use of the large-diameter valve seat.

It is, therefore, in view of the previously-described disadvantages of the prior art, an object of the invention to provide an apparatus for and a method of controlling brakes, which is configured to improve and enhance a total controllability for a brake control system and an operability for the brakes (especially, a feel of a brake pedal).

In order to accomplish the aforementioned and other objects of the present invention, an apparatus for controlling brakes, comprises a master cylinder, a wheel-brake cylinder, a brake booster configured to actuate the master cylinder for a pressure increase of brake fluid in the master cylinder, a first brake circuit configured to supply brake fluid, which is pressure-increased by the brake booster, to the wheel-brake cylinder, a first control valve disposed in the first brake circuit for establishing and blocking fluid communication between the master cylinder and the wheel-brake cylinder, a fluid-pressure source provided for a pressure increase of brake fluid, separately from the brake booster, a second brake circuit arranged in parallel with the first brake circuit and configured to supply brake fluid, which is pressure-increased by the fluid-pressure source, to the wheel-brake cylinder, a second control valve disposed in the second brake circuit for establishing and blocking fluid communication between the fluid-pressure source and the wheel-brake cylinder, and a control unit provided to control operations of the first control valve, the second control valve, and the fluid-pressure source, the control unit configured to selectively control the first control valve and the second control valve when building up wheel-cylinder pressure in the wheel-brake cylinder, and further configured to build up the wheel-cylinder pressure by operating the fluid-pressure source when at least the second control valve is controlled to a valve-open position.

According to another aspect of the invention, an apparatus for controlling brakes, comprises a master cylinder, a wheel-brake cylinder, a brake booster configured to actuate the master cylinder for a pressure increase of brake fluid in the master cylinder, a first brake circuit configured to supply brake fluid, which is pressure-increased by the brake booster, to the wheel-brake cylinder, a fluid-pressure source provided for a pressure increase of brake fluid, separately from the brake booster, a second brake circuit arranged in parallel with the first brake circuit and configured to supply brake fluid, which is pressure-increased by the fluid-pressure source, to the wheel-brake cylinder, a manipulated variable detector configured to detect a manipulated variable of the brake pedal, and a control unit configured to select either one of a pressure buildup achieved by the first brake circuit and a pressure buildup achieved by the second brake circuit, wherein, during the pressure buildup achieved by the second brake circuit, the control unit executes brake-by-wire control that automatically pressurizes brake fluid in the wheel-brake cylinder responsively to the detected manipulated variable.

According to a further aspect of the invention, a method of controlling brakes, using a brake control system having a master cylinder, a wheel-brake cylinder, a brake booster configured to actuate the master cylinder for a pressure increase of brake fluid in the master cylinder, a first brake circuit configured to supply brake fluid, which is pressure-increased by the brake booster, to the wheel-brake cylinder, a fluid-pressure source provided for a pressure increase of brake fluid, separately from the brake booster, and a second brake circuit arranged in parallel with the first brake circuit and configured to supply brake fluid, which is pressure-increased by the fluid-pressure source, to the wheel-brake cylinder, comprises controlling, responsively to a manipulated variable of a brake pedal, switching among a pressure buildup achieved by only the first brake circuit, a pressure buildup achieved by only the second brake circuit, and a pressure buildup achieved by both the first brake circuit and the second brake circuit.

The other objects and features of this invention will become understood from the following description with reference to the accompanying drawings.

### BRIEF DESCRIPTION OF THE DRAWINGS

FIG. 1 is a hydraulic circuit diagram illustrating a first embodiment of a brake control system.

FIG. 2 is an axial cross-sectional view illustrating a first pressure-buildup control valve of the front-wheel side, employed in the brake control system of the first embodiment.

FIG. 3 is an axial cross-sectional view illustrating a first pressure-buildup control valve of the rear-wheel side, employed in the brake control system of the first embodiment.

FIG. 4 is a characteristic diagram illustrating the relationship among an electric current value of the current flowing through a coil, valve opening Xv, and differential pressure Δp between master-cylinder pressure Pm and wheel-cylinder pressure Pw, in the first pressure-buildup control valve of the front-wheel side.

FIG. 5 is a characteristic diagram illustrating the relationship among an electric current value of the current flowing through a coil, valve opening Xv, and differential pressure Δp′ between wheel-cylinder pressure Pw and master-cylinder pressure Pm, in the first pressure-buildup control valve of the rear-wheel side.

FIG. 6 is a general block diagram illustrating a control unit incorporated in the brake control system of the embodiment.

FIG. 7 is a flowchart illustrating the normal brake mode and automatic wheel-cylinder pressure control (VDC control) achieved by the control unit of the system of the first embodiment.

FIG. 8 is a flowchart illustrating an ABS control routine executed by the system of the first embodiment with a large brake-pedal stroke.

FIG. 9 is a flowchart illustrating an ABS control routine executed by the system of the first embodiment with a small brake-pedal stroke.

FIG. 10 is a flowchart illustrating a wheel-cylinder pressure control termination procedure, executed by the system of the first embodiment.

FIG. 11 is a flowchart illustrating a BA control routine executed by the system of the first embodiment.

FIG. 12 is a flowchart illustrating a BA control routine executed by the system of the third embodiment.

FIG. 13 is a schematic diagram illustrating brake-fluid flow during a wheel-cylinder pressure reduction in the system of the fourth embodiment.

FIG. 14 is a flowchart illustrating a pressure-reduction control routine executed by the system of the fourth embodiment.

FIG. 15 is a hydraulic circuit diagram illustrating a fifth embodiment of a brake control system.

FIG. 16 is a flowchart illustrating a pressure-accumulation control routine executed by the system of the fifth embodiment.

FIG. 17 is a hydraulic circuit diagram illustrating a sixth embodiment of a brake control system.

FIG. 18 is a flowchart illustrating a rear-wheel-side wheel-cylinder pressure control routine executed by the system of the sixth embodiment.

FIG. 19 is a hydraulic circuit diagram illustrating a seventh embodiment of a brake control system.

FIG. 20 is a hydraulic circuit diagram illustrating an eighth embodiment of a brake control system.

FIG. 21 is a hydraulic circuit diagram illustrating a ninth embodiment of a brake control system.

FIG. 22 is an axial cross-sectional view illustrating a third pressure-buildup control valve, employed in the brake control system of the ninth embodiment.

FIG. 23 is a schematic diagram illustrating brake-fluid flow during a wheel-cylinder pressure buildup in the brake control systems of the shown embodiments.

FIG. 24 is a schematic diagram illustrating brake-fluid flow during a wheel-cylinder pressure buildup in the brake control system of the comparative example shown in FIG. 25.

FIG. 25 is a hydraulic circuit diagram illustrating a hydraulic system configuration of the automatic braking device of the comparative example.

### DESCRIPTION OF THE PREFERRED EMBODIMENTS

### First Embodiment

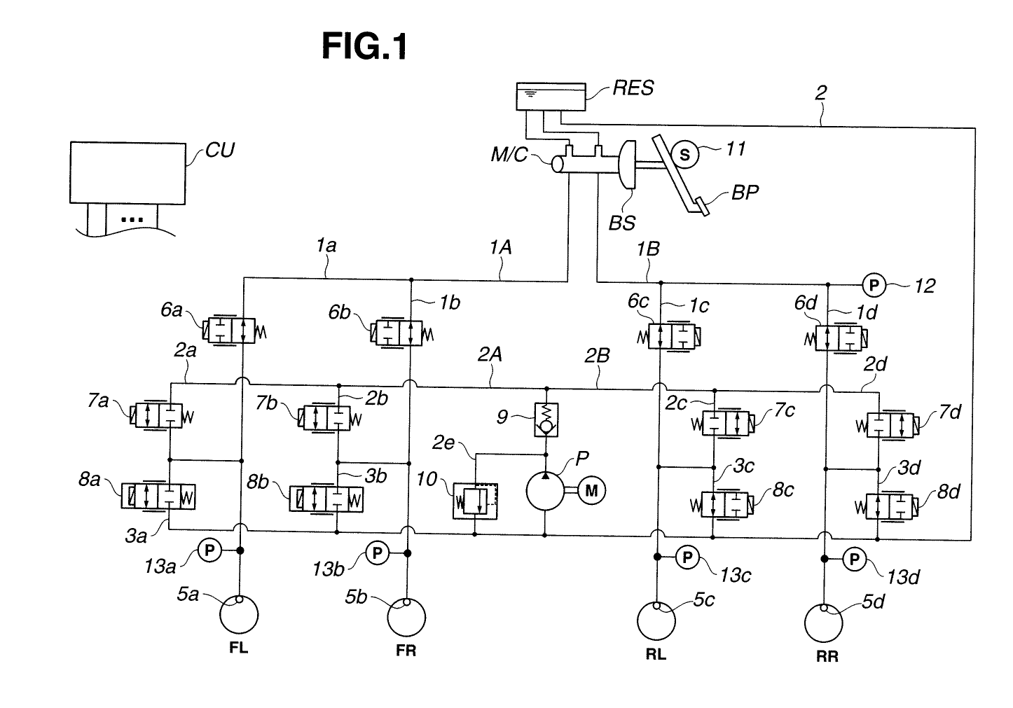

Referring now to the drawings, particularly to FIG. 1, the brake control system of the first embodiment is exemplified in a four-wheeled automotive vehicle.

[Hydraulic Circuit of Brake Control System]

As seen in FIG. 1, the brake control system of the first embodiment includes a master cylinder MC whose piston rod is linked through a brake booster BS to a brake pedal BP, a fluid-pressure control unit (or a hydraulic control unit) HCU configured to supply a master-cylinder pressure to each of wheel-brake cylinders 5a-5d of front-left, front-right, rear-left, and rear-right road wheels FL, FR, RL, and RR, and an electronic control unit CU. Hydraulic control unit HCU includes a pump P, and a plurality of electromagnetic valves comprised of a plurality of first pressure-buildup control valves 6a-6d, which are collectively referred to as “first pressure-buildup control valve 6”, a plurality of second pressure-buildup control valves 7a-7d, which are collectively referred to as “second pressure-buildup control valve 7”, a plurality of pressure-reduction control valves 8a-8d, which are collectively referred to as “pressure-reduction control valve 8”, and the like. Hydraulic control unit HCU is configured to perform automatic brake control, for example, ABS control, VDC control, BA control, and the like, responsively to a control command from electronic control unit CU. In explaining the shown embodiments, in case of necessity for discrimination among hydraulic system components corresponding to respective road wheels FL, FR, RL, and RR, a suffix letter “a” is added to indicate components associated with front-left road wheel FL, a suffix letter “b” is added to indicate components associated with front-right road wheel FR, a suffix letter “c” is added to indicate components associated with rear-left road wheel RL, and a suffix letter “d” is added to indicate components associated with rear-right road wheel RR.

As can be seen from the hydraulic system configuration of FIG. 1, the hydraulic brake system is split into two independent hydraulic circuits, namely, a first brake circuit 1 and a second brake circuit 2. First brake circuit 1 corresponds to a normal brake circuit via which master cylinder MC, first pressure-buildup control valve 6, and each of wheel-brake cylinders 5a-5d, which are collectively referred to as “wheel-brake cylinder 5”, are connected to each other. Second brake circuit 2 corresponds to a control brake circuit via which a brake fluid reservoir RES, pump P, second pressure-buildup control valve 7, and wheel-brake cylinder 5 are connected to each other. Also provided is a return circuit via which wheel-brake cylinder 5, pressure-reduction control valve 8, and reservoir RES are connected to each other. A part of brake-fluid lines included in the return circuit is shared with second brake circuit 2.

Brake pedal BP serves to transmit a driver's braking operation to brake booster BS. A stroke sensor 11 is attached to brake pedal BP, for detecting a stroke of brake pedal BP and generating a sensor signal indicative of the detected brake-pedal stroke to control unit CU.

Brake booster BS is mechanically linked to a pushrod of brake pedal BP, for amplifying or multiplying a force transmitted through brake pedal BP, utilizing a vacuum from a source of vacuum such as an engine intake manifold, and configured to transmit the amplified force via a master-cylinder pushrod to a piston of master cylinder MC, thus assisting the driver's braking effort (i.e., a depressing force applied to brake pedal BP by the driver). Instead of using the previously-discussed assist-type brake booster, an electric-motor-driven booster may be used to assist in applying the brakes.

In the shown embodiment, a tandem brake fluid reservoir, comprised of a primary brake-fluid reservoir section and a secondary brake-fluid reservoir section, is used as the reservoir RES, so as to store brake fluid. Reservoir RES is connected to second brake circuit 2 as well as master cylinder MC. Instead of using the tandem brake-fluid reservoir, a typical reservoir (a single brake-fluid reservoir) may be used.

Master cylinder MC is configured to convert a force, transmitted from brake booster BS to the master-cylinder pistons, into hydraulic pressure, for producing a master-cylinder pressure, which is in direct proportion to the transmitted force from brake booster BS. As seen in FIG. 1, master cylinder MC is constructed by a tandem master cylinder with two master-cylinder pistons, set in tandem. Thus, the tandem-master cylinder MC has two separate fluid-pressure chambers (in other words, apply pressure chambers) partitioned from each other by the two master-cylinder pistons. The two fluid-pressure chambers derive the supply of brake fluid from the reservoir separately from each other. A first one of the two fluid-pressure chambers of master cylinder MC is connected to one branched circuit 1A of first brake circuit 1, whereas the second fluid-pressure chamber of master cylinder MC is connected to the other branched circuit 1B of first brake circuit 1. As appreciated from the hydraulic circuit diagram of FIG. 1, the one branched circuit 1A of first brake circuit 1 is included in a front section (exactly, a front-wheel hydraulic brake system associated with front-left and front-right road wheels FL-FR), whereas the other branched circuit 1B of first brake circuit 1 is included in a rear section (exactly, a rear-wheel hydraulic brake system associated with rear-left and rear-right road wheels RL-RR).

Additionally, master cylinder MC has two back-pressure chambers partitioned from each other by the two master-cylinder pistons. Each of these back-pressure chambers is connected to reservoir RES.

When brake pedal BP is depressed by the driver, a stroke of each of the master-cylinder pistons occurs. As a result, master-cylinder pressures are produced in the respective fluid-pressure chambers. The two master-cylinder pressures have the same magnitude. The master-cylinder pressures are supplied to respective branched circuits 1A-1B of first brake circuit 1. A seal is provided on the outer periphery of each of the master-cylinder pistons, to enable pressure application to the brake fluid in each of the fluid-pressure chambers by blocking fluid-communication between each of the fluid-pressure chambers (the apply pressure chambers) and reservoir RES during the master-cylinder piston stroke. At this time, there is no supply of brake fluid from reservoir RES to each of branched circuits 1A-1B of first brake circuit 1. Thus, there is a supply of only the brake fluid stored in the first fluid-pressure chamber of master cylinder MC to branched circuit 1A, whereas there is a supply of only the brake fluid stored in the second fluid-pressure chamber of master cylinder MC to branched circuit 1B.

On the assumption that the reservoir side is an upstream side and the wheel-brake cylinder side is a downstream side, the downstream side of branched circuit 1A of first brake circuit 1 is branched into two fluid lines 1a-1b. The downstream end of fluid line 1a is connected to front-left wheel-brake cylinder 5a, while the downstream end of fluid line 1b is connected to front-right wheel-brake cylinder 5b. First pressure-buildup control valves 6a-6b are disposed in respective fluid lines 1a-1b. In a similar manner to the branched circuit 1A, the downstream side of branched circuit 1B of first brake circuit 1 is also branched into two fluid lines 1c-1d. The downstream end of fluid line 1c is connected to rear-left wheel-brake cylinder 5c, while the downstream end of fluid line 1d is connected to rear-right wheel-brake cylinder 5d. First pressure-buildup control valves 6c-6d are disposed in respective fluid lines 1c-1d.

A master-cylinder pressure sensor 12 is installed in first brake circuit 1 and attached to fluid line 1d upstream of first pressure-buildup control valve 6d, for detecting the master-cylinder pressure and generating a sensor signal indicative of the detected master-cylinder pressure to control unit CU.

First pressure-buildup control valve 6 is a normally-open, spring-offset two-port electromagnetic valve. More concretely, first pressure-buildup control valve 6 serves as a so-called proportional valve, which is configured to proportionally change its valve opening depending on a current value of the current flowing through a coil of the electromagnetic valve. The opening and closing operations of first pressure-buildup control valves 6a-6d are controlled responsively to respective control commands from control unit CU, to establish (permit) or block (cut off) the flow of brake fluid flowing through respective fluid lines 1a-1d. When the master-cylinder pressure becomes higher than the wheel-cylinder pressure in wheel-brake cylinder 5, the master-cylinder pressure is supplied to wheel-brake cylinder 5 with first pressure-buildup control valve 6 kept open. With first pressure-buildup control valve 6 kept closed, the supply of the master-cylinder pressure to wheel-brake cylinder 5 is cut off. Conversely when the wheel-cylinder pressure becomes higher than the master-cylinder pressure, the wheel-cylinder pressure is supplied to master cylinder MC with first pressure-buildup control valve 6 kept open. With first pressure-buildup control valve 6 closed, the supply of the wheel-cylinder pressure to master cylinder MC is cut off.

A wheel-cylinder pressure sensor 13a is installed in the downstream portion of fluid line 1a and located between first pressure-buildup control valve 6a and front-left wheel-brake cylinder 5a, for detecting the fluid pressure in wheel-brake cylinder 5a (i.e., the front-left wheel-cylinder pressure) and generating a sensor signal indicative of the detected front-left wheel-cylinder pressure to control unit CU. In a similar manner to the front-left wheel-cylinder pressure sensor 13a, front-right, rear-left, and rear-right wheel-cylinder pressure sensors 13b, 13c, and 13d are installed in the respective downstream portions of fluid lines 1b-1d, for detecting the fluid pressures in wheel-brake cylinders 5b-5d and generating sensor signals indicative of the detected front-right, rear-left, and rear-right wheel-cylinder pressures to control unit CU.

As discussed previously, the sensor signals from four wheel-cylinder pressure sensors 13a-13d are used to detect respective wheel-cylinder pressures PWFL-PWRR. Also, the processor of control unit CU can specify or determine, based on the four wheel-cylinder pressure sensor signals, which of wheel-brake cylinders becomes failed. Thus, when a failure in a certain wheel-brake cylinder of four wheel-brake cylinders 5a-5d occurs, control unit CU generates a control command to first pressure-buildup control valve 6 associated with the failed wheel-brake cylinder, for cutting off (fully closing) the associated first pressure-buildup control valve. Wheel-cylinder pressure sensors 13a-13d are collectively referred to as “wheel-cylinder pressure sensor 13”.

On the other hand, regarding second brake circuit 2, the upstream end of second brake circuit 2 is connected to reservoir RES. Pump P (exactly, the pump inlet port) is connected to the downstream side of second brake circuit 2. Pump P sucks brake fluid from reservoir RES, and thus the brake fluid introduced into the pump inlet port is pressurized. The pressurized high-pressure brake fluid is supplied into the more downstream side of second brake circuit 2 (i.e., toward second pressure-buildup control valves 7a-7d). In the shown embodiment, a pump motor M is an electric motor. The speed of motor M is controlled responsively to a control command from control unit CU, and thus the driving state of pump P can be controlled by way of pump-motor speed control. As a source for driving power, another type of drive source except an electric motor may be used to drive pump P.

A check valve (a one-way directional control valve) 9 is provided in the portion of second brake circuit 2 downstream of the pump outlet port, to permit free flow in one direction and to prevent any backflow in the opposite direction (any backflow from the downstream side back to the upstream side).

Second brake circuit 2 is branched into two branched circuits 2A and 2B, downstream of check valve 9. The downstream side of branched circuit 2A of second brake circuit 2 is further branched into two fluid lines 2a-2b. In a similar manner, the downstream side of branched circuit 2B of second brake circuit 2 is further branched into two fluid lines 2c-2d. Fluid lines 2a-2d are connected to respective fluid lines 1a-1d downstream of first pressure-buildup control valves 6a-6d, and thus fluid lines 2a-2d are connected via fluid lines 1a-1d to respective wheel-brake cylinders 5a-5d. Second pressure-buildup control valves 7a-7d are disposed in respective fluid lines 2a-2d.

Second pressure-buildup control valve 7 is a normally-closed, spring-offset two-port electromagnetic valve. More concretely, second pressure-buildup control valve 7 serves as a so-called proportional valve, which is configured to proportionally change its valve opening depending on a current value of the current flowing through a coil of the electromagnetic valve. The opening and closing operations of second pressure-buildup control valves 7a-7d are controlled responsively to respective control commands from control unit CU, to establish (permit) or block (cut off) the flow of brake fluid flowing through respective fluid lines 2a-2d. With second pressure-buildup control valve 7 kept open, pump pressure, produced by pump P, is supplied to wheel-brake cylinder 5. Conversely, with second pressure-buildup control valve 7 closed, the pump-pressure supply to wheel-brake cylinder 5 is cut off.

Fluid lines 3a-3d are connected to the respective downstream sides of fluid lines 2a-2d of second pressure-buildup control valves 7a-7d. Fluid lines 3a-3d are connected to second brake circuit 2 upstream of pump P, and thus fluid lines 3a-3d are connected via second brake circuit 2 to reservoir RES. Pressure-reduction control valves 8a-8d are disposed in respective fluid lines 3a-3d. The previously-described return circuit, provided for return flow from wheel-brake cylinder 5 to reservoir RES, is designed or configured to provide a return flow path, which is defined as a path of wheel-brake cylinders 5a-5d (→fluid lines 1a-1d→fluid lines 2a-2d→fluid lines 3a-3d)→pressure-reduction control valves 8a-8d (→fluid lines 3a-3d→second brake circuit 2)→reservoir RES.

Each of pressure-reduction control valves 8a-8d is constructed by a spring-offset two-port electromagnetic valve. More concretely, pressure-reduction control valve 8 serves as a so-called proportional valve, which is configured to proportionally change its valve opening depending on a current value of the current flowing through a coil of the electromagnetic valve. The opening and closing operations of pressure-reduction control valves 8a-8d are controlled responsively to respective control commands from control unit CU, to establish (permit) or block (cut off) the flow of brake fluid flowing through respective fluid lines 3a-3d. With pressure-reduction control valve 8 kept open, brake fluid returns from wheel-brake cylinder 5 to reservoir RES, and thus the wheel-cylinder pressure is relieved and reduced. Conversely, with pressure-reduction control valve 8 closed, a pressure relief (a pressure reduction) of the wheel-cylinder pressure is prevented. Pressure-reduction control valves 8a-8b of the front-wheel side are normally-closed valves, whereas pressure-reduction control valves 8c-8d of the rear-wheel side are normally-open valves.

One end of a relief fluid line 2e is connected to the portion of second brake circuit 2 between pump P (exactly, the pump outlet port) and check valve 9. The other end of relief fluid line 2e is connected to either one of the portions of fluid lines 3a-3d communicating the respective upstream sides of pressure-reduction control valves 8a-8d. Thus, relief fluid line 2e is connected through fluid lines 3a-3d and second brake circuit 2 to reservoir RES. In lieu thereof, relief fluid line 2e may be connected directly to second brake circuit 2 upstream of pump P. A pressure relief valve 10 is disposed in relief fluid line 2e. Relief valve 10 is configured to open, when the pump pressure (a pressure of brake fluid discharged from pump P) becomes greater than or equal to a specified pressure value (e.g., a withstand pressure of the hydraulic brake circuit shown in FIG. 1). With relief valve 10 kept open, the discharge side of pump P (i.e., the pump outlet port) is communicated with reservoir RES, and thus the pump pressure is relieved or escaped to reservoir RES, to prevent the pump pressure (the internal pressure of the hydraulic brake system) from increasing beyond the specified pressure value.

(First Pressure-Buildup Control Valves)

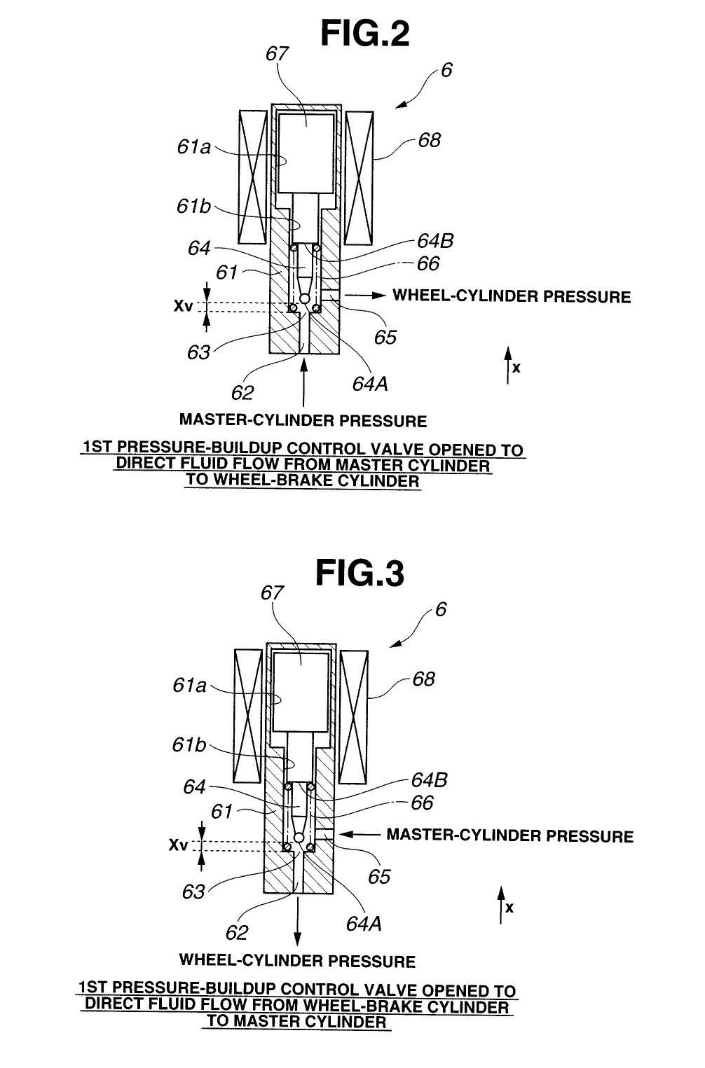

The detailed structure of first pressure-buildup control valve 6 is hereunder described in detail in reference to FIGS. 2-3. FIG. 2 shows the axial cross section of each of front-wheel side first pressure-buildup control valves 6a-6b. In explaining the detailed structure of each of front-wheel side first pressure-buildup control valves 6a-6b, suppose that the axial direction of first pressure-buildup control valve 6 is shown by the arrow x indicative of an x-axis direction, and the x-axis direction oriented from a plunger 64 to an armature 67 is a positive x-axis direction. As seen in FIG. 2, first pressure-buildup control valve 6 is comprised of a housing 61, a first port 62, a valve seat 63, plunger 64, a second port 65, a return spring 66, armature 67, and a coil 68.

Coil 68 is installed on the outer periphery of the side of the positive x-axis direction of housing 61. A large-diameter, first cylinder chamber 61a is defined in the side of the positive x-axis direction of housing 61. A small-diameter, second cylinder chamber 61b is defined in the intermediate portion of housing 61 in such a manner as to extend from first cylinder chamber 61a in the negative x-axis direction.

Additionally, first port 62 is configured as a very small-diameter elongated axial bore (an axial through hole), which axial bore is formed in the side of the negative x-axis direction of housing 61 in such a manner as to further extend downwards (viewing FIG. 2) from second cylinder chamber 61b in the negative x-axis direction. The innermost opening end of first port (axial bore) 62 opens into or communicates with the lower end of second cylinder chamber 61b. First ports 62, 62 of first pressure-buildup control valves 6a-6b of the front-wheel side are connected to the respective upstream sides of fluid lines 1a-1b, and thus connected via fluid lines 1a-1b to master cylinder MC. That is, first port 62 of each of front-wheel side first pressure-buildup control valves 6a-6b serves as a master-cylinder pressure port.

Furthermore, housing 61 has second port 65 formed therein. Second port 65 is configured as a radial bore (a radial through hole), which radial bore is formed in the intermediate portion of housing 61 near the opposite axial end of housing 61 in such a manner as to radially extend outwards (viewing FIG. 2) from the lower end of second cylinder chamber 61b. The innermost opening end of second port (radial bore) 65 opens into or communicates with the lower end of second cylinder chamber 61b. Second ports 65, 65 of first pressure-buildup control valves 6a-6b of the front-wheel side are connected to the respective downstream sides of fluid lines 1a-1b, and thus connected via fluid lines 1a-1b to respective front-wheel side wheel-brake cylinders 5a-5b. That is, second port 65 of each of front-wheel side first pressure-buildup control valves 6a-6b serves as a wheel-cylinder pressure port.

Armature 67 is accommodated in first cylinder chamber 61a in such a manner as to be slidable in the x-axis directions. Plunger 64 is accommodated in second cylinder chamber 61b in such a manner as to be slidable in the x-axis directions. Return spring 66 is disposed between a stepped portion 64B of plunger 64 and the end face (the lowermost end face) of the side of the negative x-axis direction of second cylinder chamber 61b, such that return spring 66 permanently forces plunger 64 in the positive x-axis direction. That is, the spring force of return spring 66 forces the end face (the uppermost end face) of the side of the positive x-axis direction of plunger 64 into contact with the end face (the lowermost end face) of the side of the negative x-axis direction of armature 67.

A valve seat 63 is formed integral with the stepped portion of housing 61 at the lower end face of second cylinder chamber 61b (in other words, at the innermost opening end of first port 62, which opening end opens into the lower end of second cylinder chamber 61b). The tip 64A of the side of the negative x-axis direction of plunger 64 is arranged to oppose valve seat 63. Axial movement of plunger 64 in the negative x-axis direction brings the tip 64A of plunger 64 into abutted-engagement with valve seat 63, and then the tip 64A of plunger 64, serving as a valve element, seats on valve seat 63. With the tip 64A held on valve seat 63, the innermost opening end of first port 62 is fully closed, and thus fluid communication between first port 62 and second cylinder chamber 61b is blocked (cut off). On the other hand, second port 65 and second cylinder chamber 65 are always communicated with each other.

Next, the detailed structure of first pressure-buildup control valves 6c-6d of the rear-wheel side is hereunder described in reference to FIG. 3, showing the axial cross section of each of rear-wheel side first pressure-buildup control valves 6c-6d. Notice that, as can be appreciated from comparison between the cross sections of FIGS. 2-3, the location of the master-cylinder pressure port of each of front-wheel side first pressure-buildup control valves 6a-6b is replaced with the location of the wheel-cylinder pressure port of each of rear-wheel side first pressure-buildup control valves 6c-6d, whereas the location of the wheel-cylinder pressure port of each of front-wheel side first pressure-buildup control valves 6a-6b is replaced with the location of the master-cylinder pressure port of each of rear-wheel side first pressure-buildup control valves 6c-6d.

That is, first ports 62, 62 of first pressure-buildup control valves 6c-6d of the rear-wheel side are connected to the respective downstream sides of fluid lines 1c-1d, and thus connected via fluid lines 1c-1d to respective rear-wheel side wheel-brake cylinders 5c-5d. That is, first port 62 of each of rear-wheel side first pressure-buildup control valves 6c-6d serves as a wheel-cylinder pressure port. On the other hand, second ports 65, 65 of rear-wheel side first pressure-buildup control valves 6c-6d are connected to the respective upstream sides of fluid lines 1c-1d, and thus connected via fluid lines 1c-1d to master cylinder MC. That is, second port 65 of each of rear-wheel side first pressure-buildup control valves 6c-6d serves as a master-cylinder pressure port. The other configuration of rear-wheel side first pressure-buildup control valves 6c-6d shown in FIG. 3 is identical to front-wheel side first pressure-buildup control valves 6a-6b shown in FIG. 2.

The function and operation of front-wheel side first pressure-buildup control valves 6a-6b (see FIG. 2) are hereunder described in detail. Armature 67, together with plunger 64, slides or displaces in the x-axis direction by way of the previously-discussed spring force of return spring 66, an electromagnetic force (described later), and a hydraulic pressure (described later). Owing to an axial displacement of armature 67, together with plunger 64, a change in the distance Xv between the tip 64A of plunger 64 and valve seat 63 occurs. The distance Xv corresponds to the valve opening of each of front-wheel side first pressure-buildup control valves 6a-6b.

When the distance Xv is greater than “0” and thus the tip 64A of plunger 64 lifts off its valve seat 63, fluid communication between first port 62 and second cylinder chamber 61b is established, thus enabling brake-fluid flow between first port 62 (the master-cylinder pressure port in each of front-wheel side first pressure-buildup control valves 6a-6b) and second port 65 (the wheel-cylinder pressure port in each of front-wheel side first pressure-buildup control valves 6a-6b). That is, first pressure-buildup control valves 6a-6b are kept open. With front-wheel side first pressure-buildup control valves 6a-6b kept open, the flow of brake fluid flowing through first brake circuit 1 (fluid lines 1a-1b) is permitted. Thus, master cylinder MC and each of front wheel-brake cylinders 5a-5b are communicated with each other via first brake circuit 1 (via respective fluid lines 1a-1b). When the distance Xv between the tip 64A of plunger 64 and valve seat 63 becomes a maximum value Xvo and thus the valve opening of each of front-wheel side first pressure-buildup control valves 6a-6b becomes maximum, these first pressure-buildup control valves 6a-6b operate at their full open states.

Conversely when the distance Xv becomes “0” and thus the tip 64A of plunger 64 becomes kept in abutted-engagement with valve seat 63, fluid communication between first port 62 and second cylinder chamber 61b (that is, second port 65) is blocked, thus disabling brake-fluid flow between first port 62 (the master-cylinder pressure port in each of front-wheel side first pressure-buildup control valves 6a-6b) and second port 65 (the wheel-cylinder pressure port in each of front-wheel side first pressure-buildup control valves 6a-6b). That is, first pressure-buildup control valves 6a-6b are kept closed. With first pressure-buildup control valves 6a-6b closed, first brake circuit 1 (fluid lines 1a-1b) is blocked or cut off, and thus fluid communication between master cylinder MC and each of front wheel-brake cylinders 5a-5b is blocked.

As discussed previously, the spring force of return spring 66, permanently forcing plunger 64 in the positive x-axis direction, acts in a direction for opening of front-wheel side first pressure-buildup control valve (6a; 6b). In other words, the spring force of return spring 66 acts in a direction for permitting of the flow of brake fluid flowing through first brake circuit 1 (fluid lines 1a-1b).

When electric current is applied from control unit CU to coil 68, current flow through coil 68 produces an electromagnetic force. The electromagnetic force varies depending on an electric current value I of the current flowing through coil 68. The greater the current value I, the greater the electromagnetic force produced by coil 68. The electromagnetic force attracts armature 67 in the negative x-axis direction, such that armature 67, together with plunger 64, displaces in the negative x-axis direction. That is, the electromagnetic force acts in a direction for closing of front-wheel side first pressure-buildup control valve (6a; 6b). In other words, the electromagnetic force acts in a direction for blocking (cutting off) of first brake circuit 1 (fluid lines 1a-1b).

Additionally, an axial force, resulting from hydraulic pressure applied to plunger 64, acts on plunger 64. More concretely, a force (=Δp×S), obtained by multiplying the pressure difference Δp (=Pm−Pw) between master-cylinder pressure Pm and wheel-cylinder pressure Pw with the plunger cross section S (a pressure-receiving area of plunger 64 in a direction perpendicular to the axial direction), acts on plunger 64. When master-cylinder pressure Pm is higher than wheel-cylinder pressure Pw (i.e., Pm>Pw), the pressure difference Δp (=Pm−Pw) becomes greater than “0” (i.e., Δp>0). In the case of Δp>0, the hydraulic pressure acts on plunger 64 in the positive x-axis direction. That is, the hydraulic pressure acts in a direction for opening of front-wheel side first pressure-buildup control valve (6a; 6b). In other words, the hydraulic pressure acts in a direction for permitting of the flow of brake fluid flowing through first brake circuit 1 (fluid lines 1a-1b). Conversely when master-cylinder pressure Pm is lower than wheel-cylinder pressure Pw (i.e., Pm<Pw), the pressure difference Δp (=Pm−Pw) becomes less than “0” (i.e., Δp<0). In the case of Δp<0, the hydraulic pressure acts on plunger 64 in the negative x-axis direction. That is, the hydraulic pressure acts in a direction for closing of front-wheel side first pressure-buildup control valve (6a; 6b). In other words, the hydraulic pressure acts in a direction for blocking (cutting off) of first brake circuit 1 (fluid lines 1a-1b).

An axial displacement of armature 67, together with plunger 64, that is, the distance Xv (hereinafter is referred to as “valve opening Xv”) is determined depending on a balance of the previously-noted spring force, the electromagnetic force, and the hydraulic pressure (exactly, the force Δp×S).

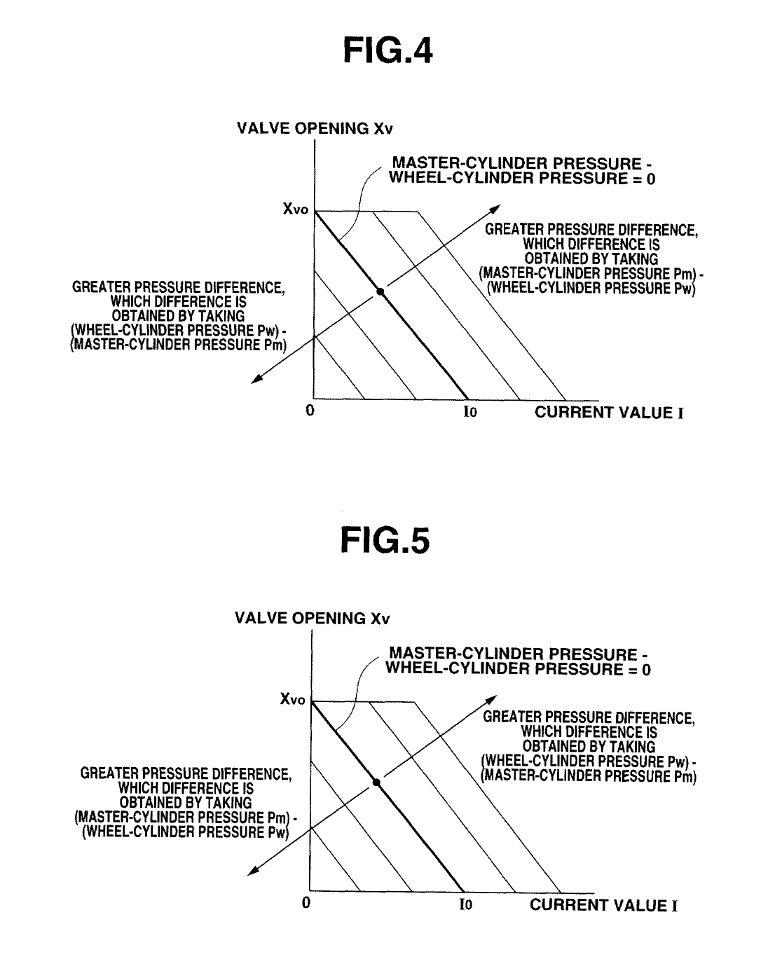

Referring now to FIG. 4, there is shown the I−Xv characteristic diagram illustrating the relationship among current value I of the current flowing through coil 68, valve opening Xv, and pressure difference Δp between master-cylinder pressure Pm and wheel-cylinder pressure Pw, in front-wheel side first pressure-buildup control valve (6a; 6b), serving as a proportional valve. Assuming that master-cylinder pressure Pm is identical to wheel-cylinder pressure Pw (i.e., Δp=Pm−Pw=0), the hydraulic pressure acting on plunger 64 becomes “0”. At the same time, assuming that current value I of the current flowing through coil 68 is “0” (i.e., I=0), the electromagnetic force acting on armature 67 becomes “0”. Under these conditions (when Δp=0 and I=0), armature 67, together with plunger 64, is forced in the positive x-axis direction by the spring force of return spring 66, and thus valve opening Xv becomes the maximum value Xvo. Hence, front-wheel side first pressure-buildup control valve (6a; 6b) operates at its full open state. Spring forces of return springs 66, 66 of front-wheel side first pressure-buildup control valves 6a-6b are properly individually set, adequately taking into account individual differences of pressure-buildup control valves manufactured.

Armature 67, together with plunger 64, is attracted in the negative x-axis direction by the electromagnetic force whose magnitude increases, as current value I increases. Armature 67, together with plunger 64, moves or displaces against the spring force in the negative x-axis direction, and therefore valve opening Xv decreases, as current value I increases. When current value I reaches a current value I0 (i.e., I=I0), valve opening Xv becomes “0” (see the neutral I-Xv characteristic indicated by the heavy solid straight line segment between and including two coordinates (I0, 0) and (0, Xvo) in FIG. 4). Hence, front-wheel side first pressure-buildup control valve (6a; 6b) becomes kept fully closed.

Next, suppose that master-cylinder pressure Pm exceeds wheel-cylinder pressure Pw, (i.e., Δp=(Pm−Pw)>0). In this case, armature 67, together with plunger 64, is forced in the positive x-axis direction by the hydraulic pressure (i.e., the force Δp×S), and thus front-wheel side first pressure-buildup control valve (6a; 6b) is kept fully open by the hydraulic pressure as well as the spring force. Therefore, in order to decrease valve opening Xv from the maximum valve opening Xvo (the full open state) with an axial displacement of armature 67, together with plunger 64, in the negative x-axis direction (i.e., in the direction for closing of front-wheel side first pressure-buildup control valve), the electromagnetic force (in other words, current value I) must be increased additionally by an increment corresponding to the hydraulic pressure (i.e., the force Δp×S). For this reason, as the pressure difference Δp increases from “0”, the I-Xv characteristic, showing the relationship between current value I and valve opening Xv, tends to translate rightwards (viewing FIG. 4).

In contrast, suppose that master-cylinder pressure Pm becomes lower than wheel-cylinder pressure Pw, (i.e., Δp=(Pm−Pw)<0). In this case, armature 67, together with plunger 64, is forced in the negative x-axis direction by the hydraulic pressure (i.e., the force Δp×S). Therefore, in order to decrease valve opening Xv from the maximum valve opening Xvo (the full open state) with an axial displacement of armature 67, together with plunger 64, in the negative x-axis direction (i.e., in the direction for closing of front-wheel side first pressure-buildup control valve), the electromagnetic force (in other words, current value I) can be decreased by a decrement corresponding to the hydraulic pressure (i.e., the force Δp×S). For this reason, as the pressure difference Δp decreases from “0”, the I−Xv characteristic tends to translate leftwards (viewing FIG. 4). Hence, if the pressure difference Δp is less than “0” even under a condition of I=0, armature 67, together with plunger 64, tends to displace against the spring force in the negative x-axis direction by the hydraulic pressure (i.e., the force Δp×S resulting from the pressure difference Δp<0). This results in a decrease in valve opening Xv from its maximum value Xvo.

The function and operation of rear-wheel side first pressure-buildup control valves 6c-6d (see FIG. 3) are hereunder described in detail. With rear-wheel side first pressure-buildup control valves 6c-6d kept open (i.e., Xv>0), the flow of brake fluid flowing through first brake circuit 1 (fluid lines 1c-1d) is permitted. Thus, master cylinder MC and each of rear wheel-brake cylinders 5c-5d are communicated with each other via first brake circuit 1 (via respective fluid lines 1c-1d). Conversely, with rear-wheel side first pressure-buildup control valves 6c-6d closed (i.e., Xv=0), first brake circuit 1 (fluid lines 1c-1d) is blocked or cut off, and thus fluid communication between master cylinder MC and each of rear wheel-brake cylinders 5c-5d is blocked. The sense of action of the spring force of return spring 66 and the sense of action of the electromagnetic force produced by coil 68 for rear-wheel side first pressure-buildup control valves 6c-6d (see FIG. 3) are the same as those described for front-wheel side first pressure-buildup control valves 6a-6b (see FIG. 2).

Additionally, an axial force, resulting from hydraulic pressure applied to plunger 64, acts on plunger 64. More concretely, a force (=Δp′×S), obtained by multiplying the pressure difference Δp′(=Pw−Pm) between wheel-cylinder pressure Pw and master-cylinder pressure Pm with the plunger cross section S, acts on plunger 64. When master-cylinder pressure Pm is lower than wheel-cylinder pressure Pw (i.e., Pm<Pw), the pressure difference Δp′(=Pw−Pm) becomes greater than “0” (i.e., Δp′>0). In the case of Δp′>0, the hydraulic pressure acts on plunger 64 in the positive x-axis direction, so as to open rear-wheel side first pressure-buildup control valve (6c; 6d), thus permitting the flow of brake fluid flowing through first brake circuit 1 (fluid lines 1c-1d). Conversely when master-cylinder pressure Pm is higher than wheel-cylinder pressure Pw (i.e., Pm>Pw), the pressure difference Δp′(=Pw−Pm) becomes less than “0” (i.e., Δp′<0). In the case of Δp′<0, the hydraulic pressure acts on plunger 64 in the negative x-axis direction, so as to close rear-wheel side first pressure-buildup control valve (6c; 6d), thus blocking (cutting off) first brake circuit 1 (fluid lines 1c-1d).

Referring now to FIG. 5, there is shown the I−Xv characteristic diagram illustrating the relationship among current value I, valve opening Xv, and pressure difference Δp′ between wheel-cylinder pressure Pw and master-cylinder pressure Pm, in rear-wheel side first pressure-buildup control valve (6c; 6d), serving as a proportional valve. When master-cylinder pressure Pm is lower than wheel-cylinder pressure Pw, (i.e., Δp′=(Pw−Pm)>0), armature 67, together with plunger 64, is pushed in the positive x-axis direction by the hydraulic pressure (i.e., the force Δp′×S), and thus rear-wheel side first pressure-buildup control valve (6c; 6d) is kept fully open by the hydraulic pressure as well as the spring force. Therefore, in order to decrease valve opening Xv from the maximum valve opening Xvo with an axial displacement of armature 67, together with plunger 64, in the negative x-axis direction, the electromagnetic force (in other words, current value I) must be increased additionally by an increment corresponding to the hydraulic pressure (i.e., the force Δp′×S). For this reason, as the pressure difference Δp′ increases from “0”, the I-Xv characteristic, showing the relationship between current value I and valve opening Xv, tends to translate rightwards (viewing FIG. 5). In contrast, when master-cylinder pressure Pm is higher than wheel-cylinder pressure Pw, (i.e., Δp′=(Pw-Pm)<0), armature 67, together with plunger 64, is pushed in the negative x-axis direction by the hydraulic pressure (i.e., the force Δp′×S). Therefore, in order to decrease valve opening Xv from the maximum valve opening Xvo with an axial displacement of armature 67, together with plunger 64, in the negative x-axis direction, the electromagnetic force (in other words, current value I) can be decreased by a decrement corresponding to the hydraulic pressure (i.e., the force Δp′×S). For this reason, as the pressure difference Δp′ decreases from “0”, the I−Xv characteristic tends to translate leftwards (viewing FIG. 5).

(Second Pressure-Buildup Control Valves)

Second pressure-buildup control valve 7 is similar to first pressure-buildup control valve 6 in basic structure. However, second pressure-buildup control valve 7 slightly differs from first pressure-buildup control valve 6, in that first pressure-buildup control valve 6 is a normally-open electromagnetic valve, whereas second pressure-buildup control valve 7 is a normally-closed electromagnetic valve. Additionally, the diameter of a valve seat, on which the valve element of second pressure-buildup control valve 7 is seated, is dimensioned to be less than that of valve seat 63 of first pressure-buildup control valve 6.

(Control Unit)

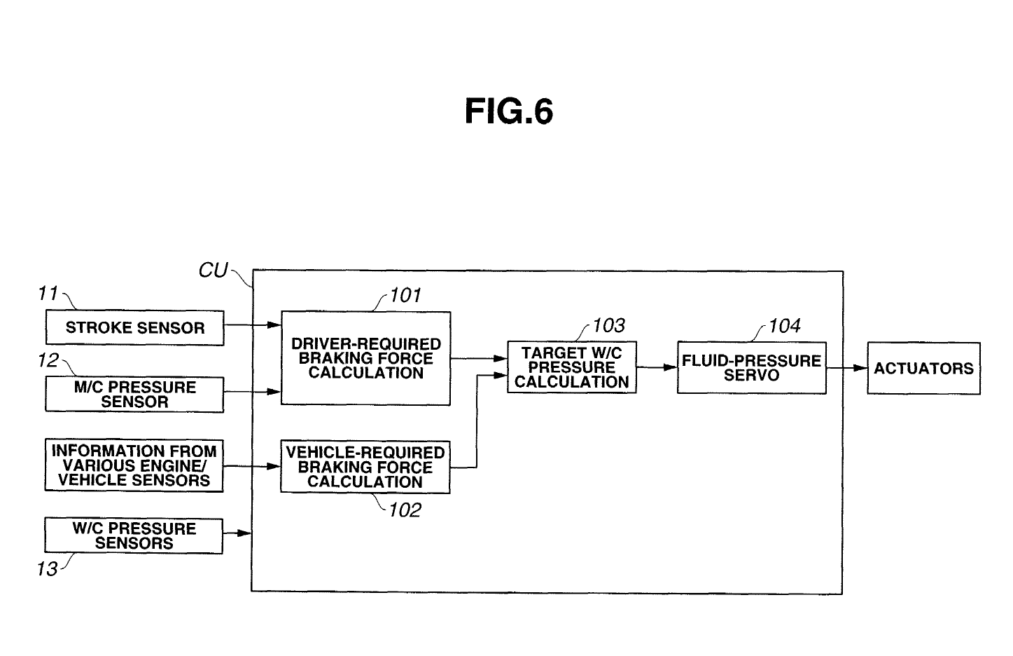

Referring now to FIG. 6, there is shown the general block diagram of control unit CU incorporated in the brake control system of the shown embodiment. Control unit CU generally comprises a microcomputer. Control unit CU includes an input/output interface (I/O), memories (RAM, ROM), and a microprocessor or a central processing unit (CPU). The input/output interface (I/O) of control unit CU receives input information from various sensors, namely, stroke sensor 11, master-cylinder pressure sensor 12, and wheel-cylinder pressure sensors 13a-13d, and also receives input information about a vehicle traveling state from engine/vehicle switches and sensors, for example, wheel speed sensors provided to detect wheel speeds VWFL-VWRR of four road wheels FL, FR, RL, and RR on the vehicle, a brake switch, a lateral-G sensor, a yaw rate sensor, and the like. Within control unit CU, the central processing unit (CPU) allows the access by the I/O interface of input informational data signals from the previously-discussed sensors. The CPU of control unit CU is responsible for carrying the control program stored in memories and is capable of performing necessary arithmetic and logic operations. Computational results (arithmetic calculation results), that is, calculated output signals are relayed through the output interface circuitry of control unit CU to output stages, namely, various actuators included in the fluid-pressure control system, more concretely, first pressure-buildup control valve 6, second pressure-buildup control valve 7, pressure-reduction control valve 8, and pump motor M.

A driver-required braking force calculation section 101 is configured to calculate, based on input information (e.g., a detected driver's braking operation, concretely, a manipulated variable of brake pedal BP depressed or inputted by the driver) from stroke sensor 11 and master-cylinder pressure sensor 12, a braking force, which is required by the driver (hereinafter is referred to as “driver-required braking force”).

A vehicle-control-system-required braking force calculation section (simply, a vehicle-required braking force calculation section) 102 is configured to integratedly calculate, based on input information about a vehicle traveling state from engine/vehicle switches and sensors (e.g., wheel speed sensors, a brake switch, a lateral-G sensor, a yaw rate sensor, and the like), a braking force, which is required for vehicle controls, for example, ABS control, VDC control, vehicle-to-vehicle distance control, collision avoidance control, and the like. The vehicle-to-vehicle distance control means automatic brake control according to which an automotive vehicle, often called “host vehicle” or “adaptive cruise control vehicle”, can automatically follow a preceding vehicle, while maintaining the host vehicle's distance from the preceding vehicle at a desired inter-vehicle distance. The collision avoidance control system means an active safety system that interacts with the automatic braking system to avoid frontal collisions. The braking force, which is required for each of automatic vehicle controls as previously discussed, is hereinafter referred to as “vehicle-required braking force”. For instance, vehicle-required braking force calculation section 102 is configured to calculate, based on input information about vehicle dynamic behavior such as a yaw rate and/or a lateral acceleration, vehicle-dynamics-control (VDC) braking forces of the individual road wheels, required for yaw moment control achieved by the vehicle dynamics control system. Vehicle-required braking force calculation section 102 is also configured to calculate assist braking forces, required for the collision avoidance control system.

A target wheel-cylinder pressure calculation section 103 is configured to calculate, based on the calculated driver-required braking force and the calculated vehicle-required braking force (e.g., VDC braking forces or assist braking forces), target wheel-cylinder pressures PWFL*-PWRR*, for the individual wheel-brake cylinders 5a-5d. Then, target wheel-cylinder pressure calculation section 103 outputs the calculated target wheel-cylinder pressures PWFL*-PWRR* to a fluid-pressure servo section (or an automatic brake-fluid-pressure control section) 104.

Target wheel-cylinder pressure calculation section 103 is also configured for estimating a road-surface friction coefficient μ, based on the detected wheel-cylinder pressures PWFL-PWRR, during ABS control, and for calculating target wheel-cylinder pressures PWFL*-PWRR*, which provide maximum effective braking, while preventing a wheel lock-up condition, utilizing a tire model. In lieu thereof, a so-called pseudo vehicle speed Vc may be estimated based on the highest one of the four wheel-speed data VWFL-VWRR. Then, four slip ratios Si (i=FL, FR, RL, RR) are calculated based on pseudo vehicle speed Vc and the respective wheel-speed data Vwi (i=FL, FR, RL, RR), from the expression Si={(Vc−Vwi)/Vc}×100. That is to say, in a conventional manner, in order to realize an appropriate slip ratio for the individual road wheels, target wheel-cylinder pressures PWFL*-PWRR* (desired values of pressure-buildup/pressure-reduction for wheel-cylinder pressures) may be calculated based on the estimated pseudo vehicle speed, the detected wheel speeds VWFL-VWRR, and wheel accelerations dVWFL/dt−dVWRR/dt.

Fluid-pressure servo section 104 generates control command signals, whose signal values are determined based on the calculated target wheel-cylinder pressures PWFL*-PWRR* and the actual wheel-cylinder pressures PWFL-PWRR detected by wheel-cylinder pressure sensors 13a-13d, to the respective actuators (concretely, first pressure-buildup control valve 6, second pressure-buildup control valve 7, pressure-reduction control valve 8, and pump motor M), to bring the actual wheel-cylinder pressures PWFL-PWRR closer to respective target wheel-cylinder pressures PWFL*-PWRR*.

(Operation of Brake Control System)

Hereunder described is the fluid-pressure control flow executed within the processor of control unit CU (fluid-pressure servo section 104).

(During Normal Brake Mode, During VDC Control)

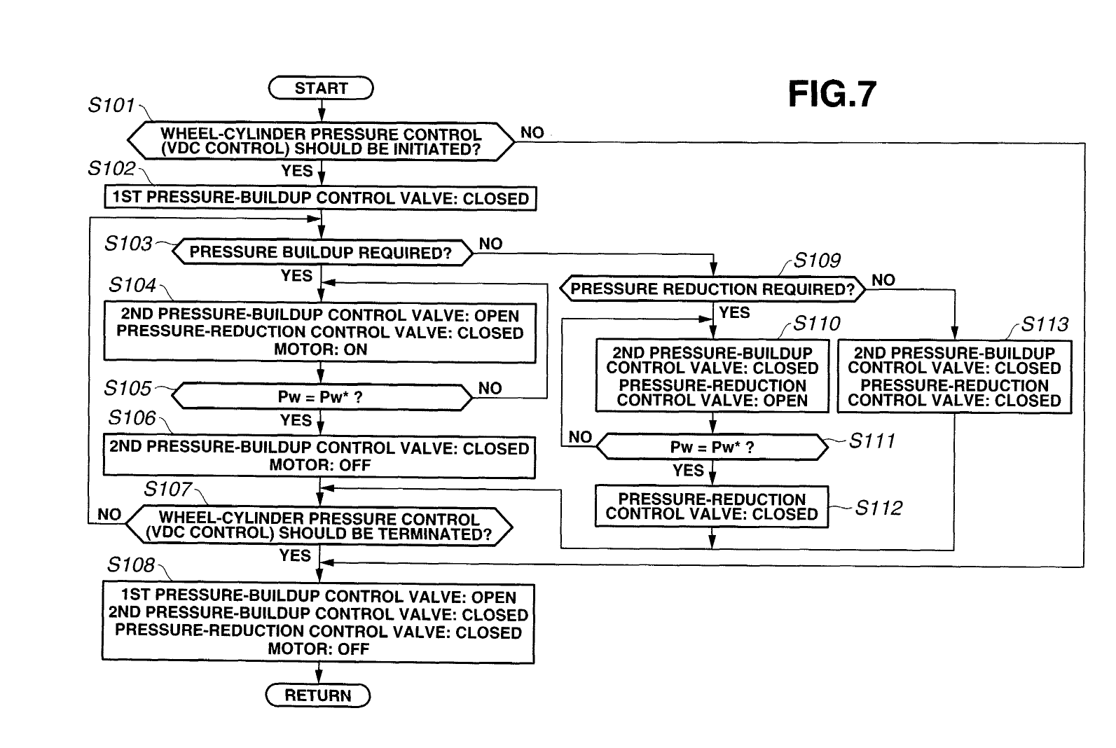

Referring now to FIG. 7, there is shown the flowchart concerning the wheel-cylinder pressure control routine executed with control unit CU, during VDC control (see steps S101-S113), and containing the procedure at the normal brake mode (see the flow jumped from step S101 to step S108). The control routine of FIG. 7 is executed as time-triggered interrupt routines to be triggered every predetermined sampling time intervals such as 10 milliseconds.

At step S101, a check for execution (initiation) of wheel-cylinder pressure control is made, based on the result of calculation of vehicle-required braking force calculation section 102, for every wheel-brake cylinder 5a-5d. In other words, a check is made to determine, based on the result of calculation of vehicle-required braking force calculation section 102, whether VDC control should be initiated. When it is determined that at least one of wheel-cylinder pressures PWFL-PWRR of the four road wheels should be controlled, target wheel-cylinder pressures PWFL*-PWRR* are inputted and then automatic fluid-pressure control (wheel-cylinder pressure control), based on the inputted target wheel-cylinder pressures, is initiated. Thereafter, the routine proceeds from step S101 to step S102. Conversely when it is determined that none of wheel-cylinder pressures PWFL-PWRR should be controlled, the routine proceeds from step S101 to step S108, so as to execute a normal brake mode (described later). At least one of road wheels FL-RR, subjected to VDC control, is hereinafter referred to as “VDC controlled wheel”. Other road wheels, unsubjected to VDC control, are hereinafter referred to as “VDC noncontrolled wheels”.

At step S102, first pressure-buildup control valve 6 associated with the VDC controlled wheel, is energized or activated (ON) and kept closed, so as to cut off first brake circuit 1 (i.e., either one of fluid lines 1a-1d, associated with the VDC controlled wheel). Thereafter, step S103 occurs.

At step S103, a check is made to determine, based on a deviation between the calculated target wheel-cylinder pressure Pw* (a VDC command wheel-cylinder pressure) and the detected wheel-cylinder pressure Pw (the actual wheel-cylinder pressure), whether wheel-cylinder pressure Pw of the VDC controlled wheel should be built up. When the answer to step S103 is affirmative (YES), that is, when a buildup of wheel-cylinder pressure Pw of the VDC controlled wheel is required, the routine proceeds from step S103 to step S104. Conversely when the answer to step S103 is negative (NO), that is, when a buildup of wheel-cylinder pressure Pw of the VDC controlled wheel is not required, the routine proceeds from step S103 to step S109.

At step S104, second pressure-buildup control valve 7, associated with the VDC controlled wheel, is activated (ON) and kept open, so as to permit brake-fluid flow through second brake circuit 2 (i.e., either one of fluid lines 2a-2d, associated with the VDC controlled wheel). On the other hand, pressure-reduction control valve 8, associated with the VDC controlled wheel, is kept closed. Additionally, motor M is energized to drive pump P. As a result, the pump pressure (a discharge pressure generated from pump P) is supplied through second pressure-buildup control valve 7, associated with the VDC controlled wheel, that is, via second brake circuit 2 to wheel-brake cylinder 5 of the VDC controlled wheel. In this manner, a buildup of wheel-cylinder pressure Pw of the VDC controlled wheel is achieved by the pump pressure. Thereafter, the routine proceeds from step S104 to step S105.

As discussed previously, during the VDC control, first pressure-buildup control valve 6, associated with the VDC controlled wheel, is kept closed (see step S102). Thus, there is no supply of master-cylinder pressure Pm to wheel-brake cylinder 5 of the VDC controlled wheel, even when brake pedal BP is depressed by the driver. On the other hand, the first pressure-buildup control valves, associated with the VDC noncontrolled wheels, are de-energized or deactivated (OFF) and kept open (see the flow from step S101 to step S108 concerned with the normal brake mode). There is a less possibility that the four road wheels are all subjected to wheel-cylinder pressure control, and thus it is possible to ensure an appropriate brake-pedal stroke in the presence of a driver's brake-pedal depression, even during automatic fluid-pressure control (even during VDC control).

At step S105, a check is made to determine, based on the actual wheel-cylinder pressure detected by wheel-cylinder pressure sensor 13 associated with the VDC controlled wheel, whether wheel-cylinder pressure Pw of the VDC controlled wheel reaches its target wheel-cylinder pressure Pw*. When target wheel-cylinder pressure Pw* has been reached, the routine proceeds from step S105 to step S106. Conversely when target wheel-cylinder pressure Pw* has not been reached, the routine returns from step S105 to step S104, so as to repeatedly execute a buildup of wheel-cylinder pressure Pw of the VDC controlled wheel.

At step S106, second pressure-buildup control valve 7, associated with the VDC controlled wheel, is deactivated (OFF) and kept closed, so as to cut off second brake circuit 2 (i.e., either one of fluid lines 2a-2d, associated with the VDC controlled wheel). Additionally, motor M is de-energized (OFF) to stop operation of pump P, thereby terminating a wheel-cylinder pressure buildup mode based on the pump pressure. Thereafter, step S107 occurs.

At step S107, a check is made to determine, based on the result of calculation of vehicle-required braking force calculation section 102, whether wheel-cylinder pressure Pw of the VDC controlled wheel should be repeatedly controlled or regulated. When it is determined that wheel-cylinder pressure control of the VDC controlled wheel should be repeatedly executed, target wheel-cylinder pressures PWFL*-PWRR* are inputted and then the routine returns to step S103 so as to repeatedly execute automatic fluid-pressure control (wheel-cylinder pressure control) for the VDC controlled wheel. Conversely when it is determined that wheel-cylinder pressure control of the VDC controlled wheel should not be repeatedly executed and thus the VDC control should be terminated, the routine proceeds from step S107 to step S108.

At step S108, regarding the VDC controlled wheel, proceeding to a termination of VDC control, or regarding the VDC noncontrolled wheels, which are not operated at the VDC control brake mode, first pressure-buildup control valve 6 is deactivated (OFF) and kept open, second pressure-buildup control valve 7 is deactivated (OFF) and kept closed, and pressure-reduction control valve 8 is kept closed. At the same time, motor M is de-energized (OFF) to stop operation of pump P. Thus, brake-fluid flow through first brake circuit 1 (i.e., either one of fluid lines 1a-1d, associated with the VDC controlled wheel, proceeding to a termination of VDC control or other fluid lines associated with the VDC noncontrolled wheels, which are not operated at the VDC control brake mode) is permitted, thus enabling the supply of master-cylinder pressure Pm via first pressure-buildup control valve 6 to wheel-brake cylinder 5. When four road wheels FL-RR are all operating at the normal brake mode at which first pressure-buildup control valve 6 is kept open, second pressure-buildup control valve 7 is kept closed, and pressure-reduction control valve 8 is kept closed, master-cylinder pressure Pm can be supplied via first pressure-buildup control valves 6a-6d to respective wheel-brake cylinders 5a-5d. That is, wheel-cylinder pressures PWFL-PWRR can be built up by the driver's braking operation (or the driver's braking effort). In this manner, the VDC control flow terminates.

Instead of shifting first pressure-buildup control valve 6 to its full open state by simply deactivating first pressure-buildup control valve 6 at step S108, the valve opening of first pressure-buildup control valve 6 may be controlled to a given value for the purpose of enhancing a brake-pedal feel during a VDC control termination procedure.

At step S109, a check is made to determine, based on a deviation between the calculated target wheel-cylinder pressure Pw* (a VDC command wheel-cylinder pressure) and the detected wheel-cylinder pressure Pw (the actual wheel-cylinder pressure), whether wheel-cylinder pressure Pw of the VDC controlled wheel should be reduced. When the answer to step S109 is affirmative (YES), that is, when a reduction of wheel-cylinder pressure Pw of the VDC controlled wheel is required, the routine proceeds from step S109 to step S110. Conversely when the answer to step S109 is negative (NO), that is, when a reduction of wheel-cylinder pressure Pw of the VDC controlled wheel is not required, the routine proceeds from step S109 to step S113.

At step S110, second pressure-buildup control valve 7, associated with the VDC controlled wheel, is deactivated (OFF) and kept closed, so as to block (cut off) second brake circuit 2 (i.e., either one of fluid lines 2a-2d, associated with the VDC controlled wheel). On the other hand, pressure-reduction control valve 8, associated with the VDC controlled wheel, is kept open, so as to establish fluid communication between reservoir RES and either one of wheel-brake cylinders 5a-5d, associated with the VDC controlled wheel, thereby permitting the wheel-cylinder pressure to be relieved or escaped to reservoir RES. In this manner, a reduction of wheel-cylinder pressure Pw of the VDC controlled wheel is achieved. Thereafter, the routine proceeds from step S110 to step S111.

At step S111, a check is made to determine, based on the actual wheel-cylinder pressure detected by wheel-cylinder pressure sensor 13 associated with the VDC controlled wheel, whether wheel-cylinder pressure Pw of the VDC controlled wheel reaches its target wheel-cylinder pressure Pw*. When target wheel-cylinder pressure Pw* has been reached, the routine proceeds from step S111 to step S112. Conversely when target wheel-cylinder pressure Pw* has not been reached, the routine returns from step S111 to step S110, so as to repeatedly execute a reduction of wheel-cylinder pressure Pw of the VDC controlled wheel.

At step S112, pressure-reduction control valve 8, associated with the VDC controlled wheel, is kept closed, so as to block fluid communication between reservoir RES and either one of wheel-brake cylinders 5a-5d, associated with the VDC controlled wheel, thereby terminating a wheel-cylinder pressure reduction mode. Thereafter, the routine proceeds from step S112 to step S107.

At step S113, a pressure hold mode for the VDC controlled wheel is executed. Concretely, second pressure-buildup control valve 7, associated with the VDC controlled wheel, is deactivated (OFF) and kept closed, so as to cut off second brake circuit 2 (i.e., either one of fluid lines 2a-2d, associated with the VDC controlled wheel). Additionally, pressure-reduction control valve 8, associated with the VDC controlled wheel, is kept closed, so as to block fluid communication between reservoir RES and either one of wheel-brake cylinders 5a-5d, associated with the VDC controlled wheel. On the other hand, first pressure-buildup control valve 6, associated with the VDC controlled wheel, has already been activated (ON) and kept closed through step S102. Under these conditions, brake fluid in wheel-brake cylinder 5 of the VDC controlled wheel, is sealed in by means of first and second pressure-buildup control valves 6-7 and pressure-reduction control valve 8, all associated with the VDC controlled wheel and fully closed, and thus wheel-cylinder pressure Pw of the VDC controlled wheel remains unchanged. Thereafter, the routine proceeds from step S113 to step S107.

(During ABS Control)

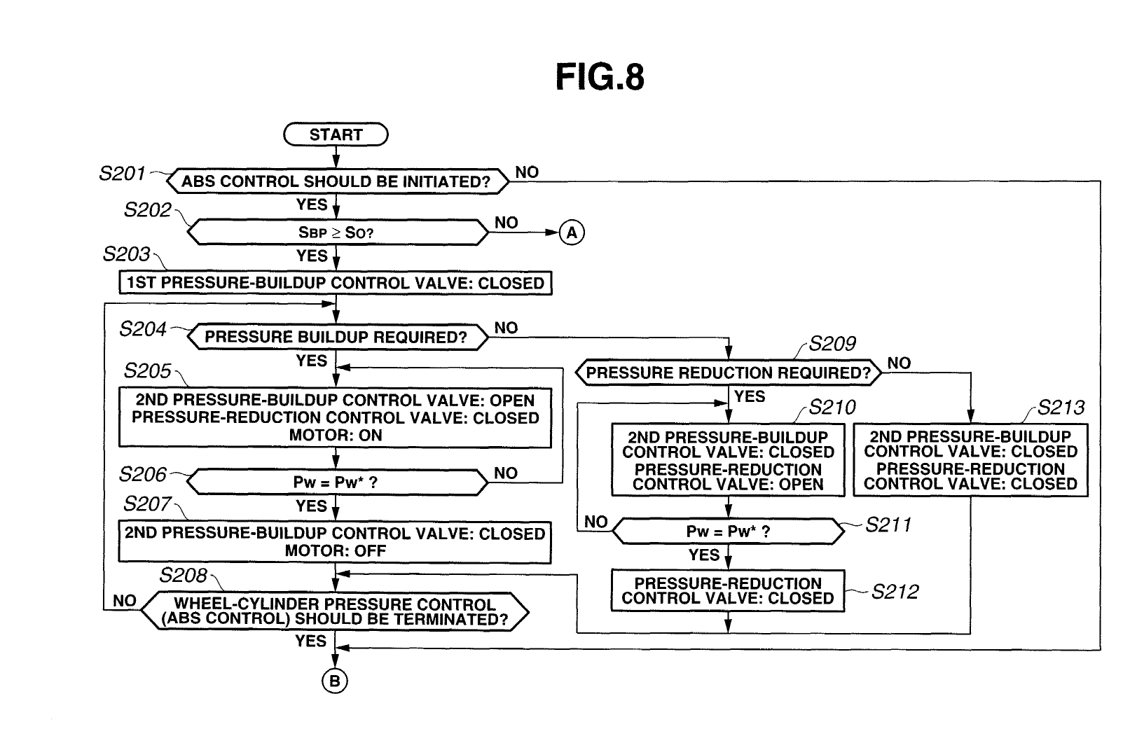

Referring now to FIGS. 8-10, there are shown the flowcharts concerning the wheel-cylinder pressure control routine executed by control unit CU during ABS control. The control routine of FIGS. 8-10 is also executed as time-triggered interrupt routines.

At step S201, a check is made to determine, based on the result of calculation of vehicle-required braking force calculation section 102, whether ABS control should be initiated. When it is determined that ABS control should be initiated, target wheel-cylinder pressures PWFL*-PWRR* are inputted and then the routine proceeds from step S201 to step S202. Conversely when it is determined that ABS control should not be initiated, the routine proceeds from step S201 to step S225 (see FIG. 10), so as to execute the normal brake mode.

At step S202, a check is made to determine whether a stroke SBP of brake pedal BP is greater than or equal to a predetermined threshold value So (i.e., SBP∝So). When SBP≧So, the routine proceeds from step S202 to step S203.

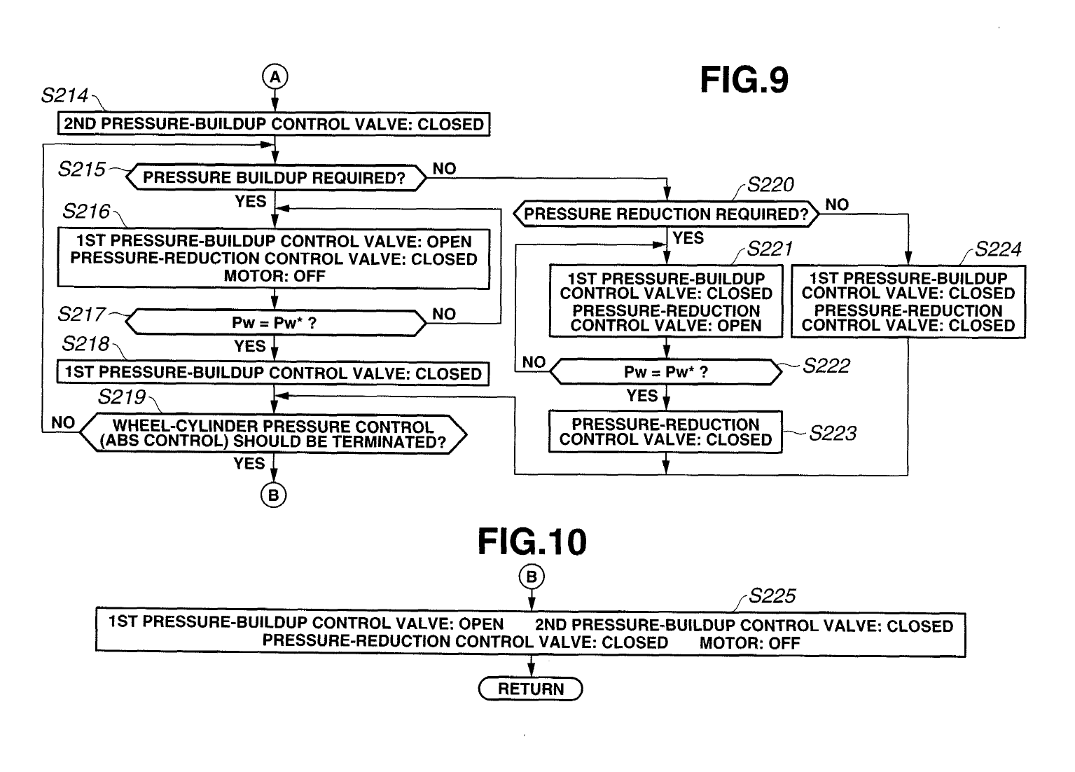

Conversely when SBP<So, the routine proceeds from step S202 to step S214 (see FIG. 9). Brake-pedal stroke SBP is determined based on the sensor signal from stroke sensor 11. In the first embodiment, predetermined threshold value So is set to a proper stroke, ranging from 30 mm to 40 mm or more, at which stroke the driver never experiences a poor or uncushioned feel of brake pedal BP.

At step S203, first pressure-buildup control valves 6a-6d of all road wheels FL-RR are activated (ON) and kept closed, so as to block (cut off) first brake circuit 1 (i.e., all fluid lines 1a-1d), thereby preventing master-cylinder pressure Pm, produced by the driver's brake-pedal depression, from being supplied to each of wheel-brake cylinders 5a-5d. Thereafter, step S204 occurs.

At step S204, a check for execution (initiation) of a pressure buildup mode of ABS control is made, based on a deviation between the calculated target wheel-cylinder pressure Pw* (an ABS command wheel-cylinder pressure) and the detected wheel-cylinder pressure Pw (the actual wheel-cylinder pressure), for every wheel-brake cylinder 5a-5d. When the answer to step S204 is affirmative (YES), that is, when a buildup of wheel-cylinder pressure Pw is required, the routine proceeds from step S204 to step S205. Conversely when the answer to step S204 is negative (NO), that is, when a buildup of wheel-cylinder pressure Pw is not required, the routine proceeds from step S204 to step S209. At least one of road wheels FL-RR, subjected to the pressure buildup mode of ABS control, is hereinafter referred to as “pressure-buildup-mode ABS controlled wheel”.

At step S205, second pressure-buildup control valve 7, associated with the pressure-buildup-mode ABS controlled wheel, is activated (ON) and kept open, so as to permit brake-fluid flow through second brake circuit 2 (i.e., either one of fluid lines 2a-2d, associated with the pressure-buildup-mode ABS controlled wheel). On the other hand, pressure-reduction control valve 8, associated with the pressure-buildup-mode ABS controlled wheel, is kept closed. Additionally, motor M is energized to drive pump P. As a result, the pump pressure is supplied through second pressure-buildup control valve 7, associated with the pressure-buildup-mode ABS controlled wheel, that is, via second brake circuit 2 to wheel-brake cylinder 5 of the pressure-buildup-mode ABS controlled wheel. In this manner, a buildup of wheel-cylinder pressure Pw of the pressure-buildup-mode ABS controlled wheel is achieved by the pump pressure. Thereafter, the routine proceeds from step S205 to step S206.

At step S206, a check is made to determine, based on the actual wheel-cylinder pressure detected by wheel-cylinder pressure sensor 13 associated with the pressure-buildup-mode ABS controlled wheel, whether wheel-cylinder pressure Pw of the pressure-buildup-mode ABS controlled wheel reaches its target wheel-cylinder pressure Pw*. When target wheel-cylinder pressure Pw* has been reached, the routine proceeds from step S206 to step S207. Conversely when target wheel-cylinder pressure Pw* has not been reached, the routine returns from step S206 to step S205, so as to repeatedly execute a buildup of wheel-cylinder pressure Pw of the pressure-buildup-mode ABS controlled wheel.

At step S207, second pressure-buildup control valve 7, associated with the pressure-buildup-mode ABS controlled wheel, is deactivated (OFF) and kept closed, so as to cut off second brake circuit 2 (i.e., either one of fluid lines 2a-2d, associated with the pressure-buildup-mode ABS controlled wheel). Additionally, motor M is de-energized (OFF) to stop operation of pump P, thereby terminating a wheel-cylinder pressure buildup mode based on the pump pressure. Thereafter, step S208 occurs.

At step S208, a check is made to determine, based on the result of calculation of vehicle-required braking force calculation section 102, whether wheel-cylinder pressure Pw of the ABS controlled wheel should be repeatedly controlled or regulated. When it is determined that wheel-cylinder pressure control of the ABS controlled wheel should be repeatedly executed, target wheel-cylinder pressures PWFL*-PWRR* are inputted and then the routine returns to step S204 so as to repeatedly execute automatic fluid-pressure control (wheel-cylinder pressure control) for the ABS controlled wheel. Conversely when it is determined that wheel-cylinder pressure control of the ABS controlled wheel should not be repeatedly executed and thus the ABS control should be terminated, the routine proceeds from step S208 to step S225 (see FIG. 10).

At step S209, a check for execution (initiation) of a pressure reduction mode of ABS control is made, based on a deviation between the calculated target wheel-cylinder pressure Pw* (an ABS command wheel-cylinder pressure) and the detected wheel-cylinder pressure Pw (the actual wheel-cylinder pressure), for every wheel-brake cylinder 5a-5d. When the answer to step S209 is affirmative (YES), that is, when a reduction of wheel-cylinder pressure Pw is required, the routine proceeds from step S209 to step S210. Conversely when the answer to step S209 is negative (NO), that is, when a reduction of wheel-cylinder pressure Pw is not required, the routine proceeds from step S209 to step S213. At least one of road wheels FL-RR, subjected to the pressure reduction mode of ABS control, is hereinafter referred to as “pressure-reduction-mode ABS controlled wheel”.

At step S210, second pressure-buildup control valve 7, associated with the pressure-reduction-mode ABS controlled wheel, is deactivated (OFF) and kept closed, so as to block (cut off) second brake circuit 2 (i.e., either one of fluid lines 2a-2d, associated with the pressure-reduction-mode ABS controlled wheel). On the other hand, pressure-reduction control valve 8, associated with the pressure-reduction-mode ABS controlled wheel, is kept open, so as to establish fluid communication between reservoir RES and either one of wheel-brake cylinders 5a-5d, associated with the pressure-reduction-mode ABS controlled wheel, thereby permitting the wheel-cylinder pressure to be relieved or escaped to reservoir RES. In this manner, a reduction of wheel-cylinder pressure Pw of the pressure-reduction-mode ABS controlled wheel is achieved. Thereafter, the routine proceeds from step S210 to step S211.

At step S211, a check is made to determine, based on the actual wheel-cylinder pressure detected by wheel-cylinder pressure sensor 13 associated with the pressure-reduction-mode ABS controlled wheel, whether wheel-cylinder pressure Pw of the pressure-reduction-mode ABS controlled wheel reaches its target wheel-cylinder pressure Pw*. When target wheel-cylinder pressure Pw* has been reached, the routine proceeds from step S211 to step S212. Conversely when target wheel-cylinder pressure Pw* has not been reached, the routine returns from step S211 to step S210, so as to repeatedly execute a reduction of wheel-cylinder pressure Pw of the pressure-reduction-mode ABS controlled wheel.

At step S212, pressure-reduction control valve 8, associated with the pressure-reduction-mode ABS controlled wheel, is kept closed, so as to block fluid communication between reservoir RES and either one of wheel-brake cylinders 5a-5d, associated with the pressure-reduction-mode ABS controlled wheel, thereby terminating a wheel-cylinder pressure reduction mode. Thereafter, the routine proceeds from step S212 to step S208.

At step S213, a pressure hold mode for the ABS controlled wheel is executed. At least one of road wheels FL-RR, subjected to the pressure hold mode of ABS control, is hereinafter referred to as “pressure-hold-mode ABS controlled wheel”. Concretely, second pressure-buildup control valve 7, associated with the pressure-hold-mode ABS controlled wheel, is deactivated (OFF) and kept closed, so as to cut off second brake circuit 2 (i.e., either one of fluid lines 2a-2d, associated with the pressure-hold-mode ABS controlled wheel). Additionally, pressure-reduction control valve 8, associated with the pressure-hold-mode ABS controlled wheel, is kept closed, so as to block fluid communication between reservoir RES and either one of wheel-brake cylinders 5a-5d, associated with the pressure-hold-mode ABS controlled wheel. On the other hand, first pressure-buildup control valve 6, associated with the ABS controlled wheel, has already been activated (ON) and kept closed through step S203. Under these conditions, brake fluid in wheel-brake cylinder 5 of the pressure-hold-mode ABS controlled wheel, is sealed in by means of first and second pressure-buildup control valves 6-7 and pressure-reduction control valve 8, all associated with the pressure-hold-mode ABS controlled wheel and fully closed, and thus wheel-cylinder pressure Pw of the pressure-hold-mode ABS controlled wheel remains unchanged. Thereafter, the routine proceeds from step S213 to step S208.

As discussed previously, when brake-pedal stroke SBP is less than predetermined threshold value So (i.e., SBP<So), the routine jumps from step S202 to step S214 (see FIG. 9).

At step S214, second pressure-buildup control valves 7a-7d of all road wheels FL-RR are deactivated (OFF) and kept closed, so as to block (cut off) second brake circuit 2 (i.e., all fluid lines 2a-2d). Thereafter, step S215 occurs.

In a similar manner to step S204, at step S215, a check for execution (initiation) of a pressure buildup mode of ABS control is made, based on a deviation between the calculated target wheel-cylinder pressure Pw* (an ABS command wheel-cylinder pressure) and the detected wheel-cylinder pressure Pw (the actual wheel-cylinder pressure), for every wheel-brake cylinder 5a-5d. When the answer to step S215 is affirmative (YES), that is, when a buildup of wheel-cylinder pressure Pw is required, the routine proceeds from step S215 to step S216. Conversely when the answer to step S215 is negative (NO), that is, when a buildup of wheel-cylinder pressure Pw is not required, the routine proceeds from step S215 to step S220.

At step S216, first pressure-buildup control valve 6, associated with the pressure-buildup-mode ABS controlled wheel, is deactivated (OFF) and kept open, so as to permit brake-fluid flow through first brake circuit 1 (i.e., either one of fluid lines 1a-1d, associated with the pressure-buildup-mode ABS controlled wheel). On the other hand, pressure-reduction control valve 8, associated with the pressure-buildup-mode ABS controlled wheel, is kept closed. Additionally, motor M is de-energized to stop operation of pump P. As a result, master-cylinder pressure Pm is supplied through first pressure-buildup control valve 6, associated with the pressure-buildup-mode ABS controlled wheel, that is, via first brake circuit 1 to wheel-brake cylinder 5 of the pressure-buildup-mode ABS controlled wheel. In this manner, a buildup of wheel-cylinder pressure Pw of the pressure-buildup-mode ABS controlled wheel is achieved. Furthermore, supplying master-cylinder pressure Pm to the wheel-brake cylinder 5 of the pressure-buildup-mode ABS controlled wheel, allows or enables a stroke of brake pedal BP in the presence of a driver's brake-pedal depression, even during automatic fluid-pressure control (even during ABS control). Thereafter, the routine proceeds from step S216 to step S217.

In a similar manner to step S206, at step S217, a check is made to determine, based on the actual wheel-cylinder pressure detected by wheel-cylinder pressure sensor 13 associated with the pressure-buildup-mode ABS controlled wheel, whether wheel-cylinder pressure Pw of the pressure-buildup-mode ABS controlled wheel reaches its target wheel-cylinder pressure Pw*. When target wheel-cylinder pressure Pw* has been reached, the routine proceeds from step S217 to step S218. Conversely when target wheel-cylinder pressure Pw* has not been reached, the routine returns from step S217 to step S216, so as to repeatedly execute a buildup of wheel-cylinder pressure Pw of the pressure-buildup-mode ABS controlled wheel.

At step S218, first pressure-buildup control valve 6, associated with the pressure-buildup-mode ABS controlled wheel, is activated (ON) and kept closed, so as to cut off first brake circuit 1 (i.e., either one of fluid lines 1a-1d, associated with the pressure-buildup-mode ABS controlled wheel), thereby terminating a wheel-cylinder pressure buildup mode based on master-cylinder pressure Pm. Thereafter, step S219 occurs.

In a similar manner to step S208, at step S219, a check is made to determine, based on the result of calculation of vehicle-required braking force calculation section 102, whether wheel-cylinder pressure Pw of the ABS controlled wheel should be repeatedly controlled or regulated. When it is determined that wheel-cylinder pressure control of the ABS controlled wheel should be repeatedly executed, target wheel-cylinder pressures PWFL*-PWRR* are inputted and then the routine returns to step S215 so as to repeatedly execute automatic fluid-pressure control (wheel-cylinder pressure control) for the ABS controlled wheel. Conversely when it is determined that wheel-cylinder pressure control of the ABS controlled wheel should not be repeatedly executed and thus the ABS control should be terminated, the routine proceeds from step S219 to step S225 (see FIG. 10).

In a similar manner to step S209, at step S220, a check for execution (initiation) of a pressure reduction mode of ABS control is made, based on a deviation between the calculated target wheel-cylinder pressure Pw* (an ABS command wheel-cylinder pressure) and the detected wheel-cylinder pressure Pw (the actual wheel-cylinder pressure), for every wheel-brake cylinder 5a-5d. When the answer to step S220 is affirmative (YES), that is, when a reduction of wheel-cylinder pressure Pw is required, the routine proceeds from step S220 to step S221. Conversely when the answer to step S220 is negative (NO), that is, when a reduction of wheel-cylinder pressure Pw is not required, the routine proceeds from step S220 to step S224. At step S221, first pressure-buildup control valve 6, associated with the pressure-reduction-mode ABS controlled wheel, is activated (ON) and kept closed, so as to block (cut off) first brake circuit 1 (i.e., either one of fluid lines 1a-1d, associated with the pressure-reduction-mode ABS controlled wheel). On the other hand, pressure-reduction control valve 8, associated with the pressure-reduction-mode ABS controlled wheel, is kept open, so as to establish fluid communication between reservoir RES and either one of wheel-brake cylinders 5a-5d, associated with the pressure-reduction-mode ABS controlled wheel, thereby permitting the wheel-cylinder pressure to be relieved or escaped to reservoir RES. In this manner, a reduction of wheel-cylinder pressure Pw of the pressure-reduction-mode ABS controlled wheel is achieved. Thereafter, the routine proceeds from step S221 to step S222.

In a similar manner to step S211, at step S222, a check is made to determine, based on the actual wheel-cylinder pressure detected by wheel-cylinder pressure sensor 13 associated with the pressure-reduction-mode ABS controlled wheel, whether wheel-cylinder pressure Pw of the pressure-reduction-mode ABS controlled wheel reaches its target wheel-cylinder pressure Pw*. When target wheel-cylinder pressure Pw* has been reached, the routine proceeds from step S222 to step S223. Conversely when target wheel-cylinder pressure Pw* has not been reached, the routine returns from step S222 to step S221, so as to repeatedly execute a reduction of wheel-cylinder pressure Pw of the pressure-reduction-mode ABS controlled wheel.

At step S223, pressure-reduction control valve 8, associated with the pressure-reduction-mode ABS controlled wheel, is kept closed, so as to block fluid communication between reservoir RES and either one of wheel-brake cylinders 5a-5d, associated with the pressure-reduction-mode ABS controlled wheel, thereby terminating a wheel-cylinder pressure reduction mode. Thereafter, the routine proceeds from step S223 to step S219.

At step S224, a pressure hold mode for the ABS controlled wheel is executed. Concretely, first pressure-buildup control valve 6, associated with the pressure-hold-mode ABS controlled wheel, is activated (ON) and kept closed, so as to cut off first brake circuit 1 (i.e., either one of fluid lines 1a-1d, associated with the pressure-hold-mode ABS controlled wheel). Additionally, pressure-reduction control valve 8, associated with the pressure-hold-mode ABS controlled wheel, is kept closed, so as to block fluid communication between reservoir RES and either one of wheel-brake cylinders 5a-5d, associated with the pressure-hold-mode ABS controlled wheel. On the other hand, second pressure-buildup control valve 7, associated with the ABS controlled wheel, has already been deactivated (OFF) and kept closed through step S214. Under these conditions, brake fluid in wheel-brake cylinder 5 of the pressure-hold-mode ABS controlled wheel, is sealed in by means of first and second pressure-buildup control valves 6-7 and pressure-reduction control valve 8, all associated with the pressure-hold-mode ABS controlled wheel and fully closed, and thus wheel-cylinder pressure Pw of the pressure-hold-mode ABS controlled wheel remains unchanged. Thereafter, the routine proceeds from step S224 to step S219.

When either step S208 or step S219 determines that wheel-cylinder pressure control of the ABS controlled wheel should not be repeatedly executed and thus the ABS control should be terminated, the routine advances to step S225.

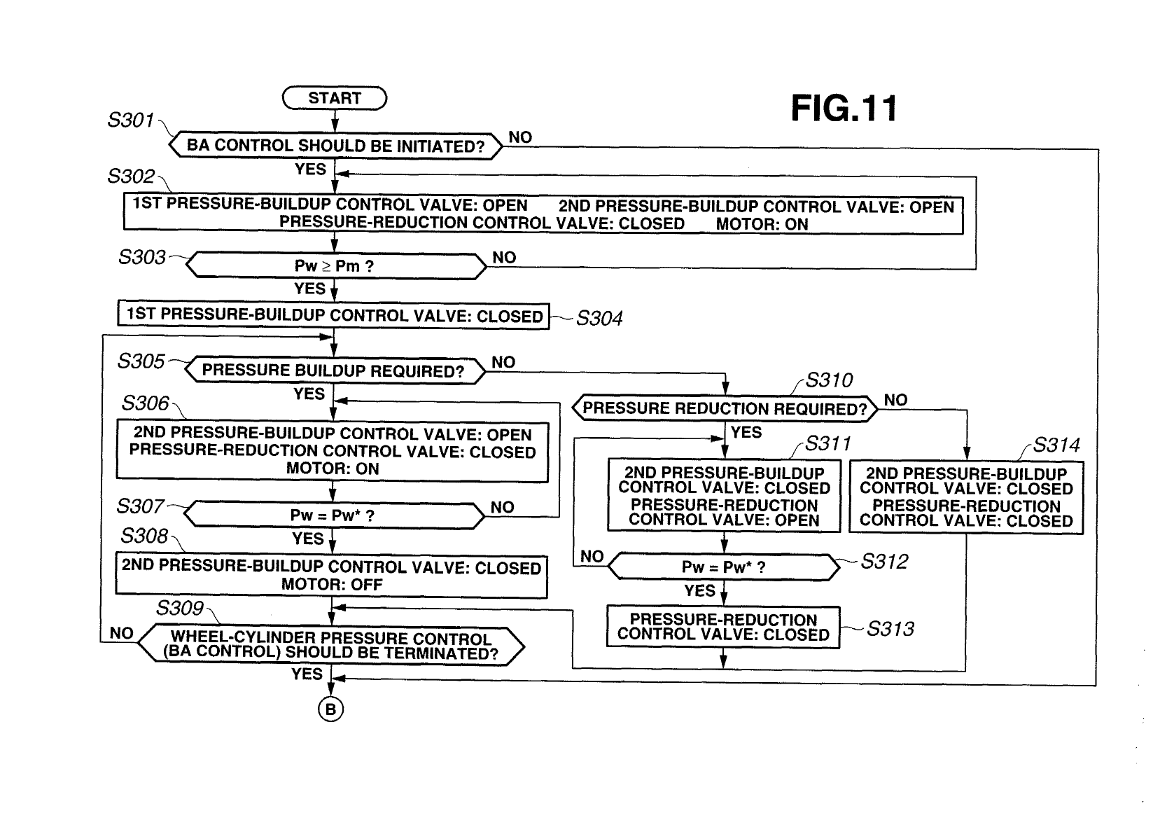

In the wheel-cylinder pressure control termination procedure executed at step S225, the ABS controlled wheel proceeding to a termination of ABS control and a BA controlled wheel (described later in reference to the flowchart shown in FIG. 11) proceeding to a termination of BA control are collectively referred to as “controlled wheel”.

At step S225, regarding the controlled wheel, proceeding to a termination of ABS control (or BA control), first pressure-buildup control valve 6 is deactivated (OFF) and kept open, second pressure-buildup control valve 7 is deactivated (OFF) and kept closed, and pressure-reduction control valve 8 is kept closed. At the same time, motor M is de-energized (OFF) to stop operation of pump P. Thus, brake-fluid flow through first brake circuit 1 (i.e., either one of fluid lines 1a-1d, associated with the controlled wheel, proceeding to a termination of wheel-cylinder pressure control) is permitted, thereby enabling a buildup of wheel-cylinder pressure Pw by the driver's braking operation (or the driver's braking effort). In this manner, after the operating modes of four road wheels FL-RR have been all switched to their normal brake modes, master-cylinder pressure Pm can be supplied via first pressure-buildup control valves 6a-6d to respective wheel-brake cylinders 5a-5d, thus enabling a normal braking action by the driver. In this manner, the ABS control flow (or the BA control flow) terminates.

Instead of shifting first pressure-buildup control valve 6 to its full open state by simply deactivating first pressure-buildup control valve 6 at step S225, the valve opening of first pressure-buildup control valve 6 may be controlled to a given value for the purpose of enhancing a brake-pedal feel during an ABS control termination procedure (or during a BA control termination procedure).

(DURING BA Control)

Referring now to FIG. 11, there is shown the flowchart concerning the wheel-cylinder pressure control routine executed by control unit CU, incorporated in the brake control apparatus of the first embodiment, during BA control. The control routine of FIG. 11 is also executed as time-triggered interrupt routines.

At step S301, a check is made to determine, based on the result of calculation of vehicle-required braking force calculation section 102, whether BA control should be initiated. For instance, in order to avoid a potential collision, when step S301 determines that BA control should be initiated, target wheel-cylinder pressures PWFL*-PWRR* are inputted and then the routine proceeds from step S301 to step S302. Conversely when it is determined that BA control should not be initiated, the routine proceeds from step S301 to step S225 (see FIG. 10), so as to execute the normal brake mode discussed previously.

At step S302, first pressure-buildup control valves 6a-6d of all road wheels FL-RR are deactivated (OFF) and kept open, and pressure-reduction control valves 8a-8d of all road wheels FL-RR are kept closed. As a result, brake-fluid flow through first brake circuit 1 (fluid lines 1a-1d) is permitted, and thus master-cylinder pressure Pm can be supplied via first pressure-buildup control valves 6a-6d to respective wheel-brake cylinders 5a-5d. Thus, on the one hand, by the driver's braking operation (or the driver's braking effort), wheel-cylinder pressures PWFL-PWRR can be built up. At the same time, second pressure-buildup control valves 7a-7d are activated (ON) and kept open, so as to permit brake-fluid flow through second brake circuit 2 (fluid lines 2a-2d), and additionally motor M is energized to drive pump P. As a result, the pump pressure (a discharge pressure generated from pump P) can be supplied through second pressure-buildup control valves 7a-7d to respective wheel-brake cylinders 5a-5d. Thus, on the other hand, by the pump pressure, a buildup of wheel-cylinder pressure Pw in wheel-brake cylinder 5 can be achieved.

As discussed previously, regarding second brake circuit 2, pump P sucks brake fluid directly from reservoir RES for supplying pump pressure via fluid lines 2a-2d to respective wheel-brake cylinders 5a-5d. Regardless of the presence or absence of the driver's braking operation (a driver's brake-pedal depression) concerned with first brake circuit 1, that is, regardless of the presence or absence of fluid communication between master cylinder MC and reservoir RES, brake fluid can be supplied to each of wheel-brake cylinders 5a-5d via second brake circuit 2. Therefore, under the specified condition where first and second pressure-buildup control valves 6a-6d and 7a-7d are all kept open, pressure-reduction control valves 8a-8d are all kept closed, and motor M is energized, it is possible to build up wheel-cylinder pressure Pw at a higher speed exceeding the traveling speed of the master-cylinder piston (i.e., an operation speed for the driver's braking operation), by supplying the pump pressure via second brake circuit 2 to wheel-brake cylinders 5a-5d, while supplying master-cylinder pressure Pm, produced by the driver's brake-pedal depression, via first brake circuit 1 to the respective wheel-brake cylinders.

At step S303, a check for wheel-cylinder pressure Pm not less than master-cylinder pressure Pm is made, based on sensor signals from master-cylinder pressure sensor 12 and wheel-cylinder pressure sensor 13, for every wheel-brake cylinder 5a-5d. In other words, at step S303, a check is made to determine, based on sensor signals from master-cylinder pressure sensor 12 and wheel-cylinder pressure sensor 13, whether there is a risk of backflow of brake fluid from wheel-brake cylinder 5 through first brake circuit 1 (through first pressure-buildup control valve 6) back to master cylinder MC. When Pw≧Pm, the routine proceeds from step S303 to step S304. Conversely when Pw<Pm, the routine returns from step S303 to step S302, so as to repeatedly execute a buildup of wheel-cylinder pressure Pw.

Here, a specific condition (Pw≧Pm) where wheel-cylinder pressure Pw is higher than or equal to master-cylinder pressure Pm means that a buildup of wheel-cylinder pressure Pw, achieved by pump pressure via second brake circuit 2, becomes more dominant than master-cylinder pressure Pm produced by the driver's brake-pedal depression via first brake circuit 1.

At step S304, first pressure-buildup control valve 6, associated with the BA controlled wheel having wheel-cylinder pressure Pw not less than master-cylinder pressure Pm, is activated (ON) and kept closed, so as to block (cut off) first brake circuit 1, thus preventing backflow of brake fluid from wheel-brake cylinder 5 through first brake circuit 1 back to master cylinder MC, even under the specific condition of Pw≧Pm. This effectively suppresses a fall in the pressure-buildup speed of wheel-cylinder pressure Pw. Additionally, by the prevention of undesirable backflow, it is possible to prevent brake pedal BP from being kicked back owing to an increase in master-cylinder pressure Pm. Thereafter, step S305 occurs.

At step S305, a check for execution (initiation) of a pressure buildup mode of BA control is made, based on a deviation between the calculated target wheel-cylinder pressure Pw* (a BA command wheel-cylinder pressure) and the detected wheel-cylinder pressure Pw (the actual wheel-cylinder pressure), for every wheel-brake cylinder 5a-5d. When the answer to step S305 is affirmative (YES), that is, when a buildup of wheel-cylinder pressure Pw is required, the routine proceeds from step S305 to step S306. Conversely when the answer to step S305 is negative (NO), that is, when a buildup of wheel-cylinder pressure Pw is not required, the routine proceeds from step S305 to step S310. At least one of road wheels FL-RR, subjected to the pressure buildup mode of BA control, is hereinafter referred to as “pressure-buildup-mode BA controlled wheel”.

At step S306, second pressure-buildup control valve 7, associated with the pressure-buildup-mode BA controlled wheel, is activated (ON) and kept open, so as to permit brake-fluid flow through second brake circuit 2 (i.e., either one of fluid lines 2a-2d, associated with the pressure-buildup-mode BA controlled wheel). On the other hand, pressure-reduction control valve 8, associated with the pressure-buildup-mode BA controlled wheel, is kept closed. Additionally, motor M is energized to drive pump P. As a result, the pump pressure is supplied through second pressure-buildup control valve 7, associated with the pressure-buildup-mode BA controlled wheel, that is, via second brake circuit 2 to wheel-brake cylinder 5 of the pressure-buildup-mode BA controlled wheel. In this manner, a buildup of wheel-cylinder pressure Pw of the pressure-buildup-mode BA controlled wheel is achieved by the pump pressure. Thereafter, the routine proceeds from step S306 to step S307.

At step S307, a check is made to determine, based on the actual wheel-cylinder pressure detected by wheel-cylinder pressure sensor 13 associated with the pressure-buildup-mode BA controlled wheel, whether wheel-cylinder pressure Pw of the pressure-buildup-mode BA controlled wheel reaches its target wheel-cylinder pressure Pw*. When target wheel-cylinder pressure Pw* has been reached, the routine proceeds from step S307 to step S308. Conversely when target wheel-cylinder pressure Pw* has not been reached, the routine returns from step S307 to step S306, so as to repeatedly execute a buildup of wheel-cylinder pressure Pw of the pressure-buildup-mode BA controlled wheel.

At step S308, second pressure-buildup control valve 7, associated with the pressure-buildup-mode BA controlled wheel, is deactivated (OFF) and kept closed, so as to cut off second brake circuit 2. Additionally, motor M is de-energized (OFF) to stop operation of pump P, thereby terminating a wheel-cylinder pressure buildup mode based on the pump pressure. Thereafter, step S309 occurs.

At step S309, a check is made to determine, based on the result of calculation of vehicle-required braking force calculation section 102, whether wheel-cylinder pressure Pw of the BA controlled wheel should be repeatedly controlled or regulated. When it is determined that wheel-cylinder pressure control of the BA controlled wheel should be repeatedly executed, target wheel-cylinder pressures PWFL*-PWRR* are inputted and then the routine returns to step S305 so as to repeatedly execute automatic fluid-pressure control (wheel-cylinder pressure control) for the BA controlled wheel. Conversely when it is determined that wheel-cylinder pressure control of the BA controlled wheel should not be repeatedly executed and thus the BA control should be terminated, the routine proceeds from step S309 to step S225 (see FIG. 10).

At step S310, a check for execution (initiation) of a pressure reduction mode of BA control is made, based on a deviation between the calculated target wheel-cylinder pressure Pw* (a BA command wheel-cylinder pressure) and the detected wheel-cylinder pressure Pw (the actual wheel-cylinder pressure), for every wheel-brake cylinder 5a-5d. When the answer to step S310 is affirmative (YES), that is, when a reduction of wheel-cylinder pressure Pw is required, the routine proceeds from step S310 to step S311. Conversely when the answer to step S310 is negative (NO), that is, when a reduction of wheel-cylinder pressure Pw is not required, the routine proceeds from step S310 to step S314. At least one of road wheels FL-RR, subjected to the pressure reduction mode of BA control, is hereinafter referred to as “pressure-reduction-mode BA controlled wheel”.

At step S311, second pressure-buildup control valve 7, associated with the pressure-reduction-mode BA controlled wheel, is deactivated (OFF) and kept closed, so as to block (cut off) second brake circuit 2 (i.e., either one of fluid lines 2a-2d, associated with the pressure-reduction-mode BA controlled wheel). On the other hand, pressure-reduction control valve 8, associated with the pressure-reduction-mode BA controlled wheel, is kept open, so as to establish fluid communication between reservoir RES and either one of wheel-brake cylinders 5a-5d, associated with the pressure-reduction-mode BA controlled wheel, thereby permitting the wheel-cylinder pressure to be relieved or escaped to reservoir RES. In this manner, a reduction of wheel-cylinder pressure Pw of the pressure-reduction-mode BA controlled wheel is achieved. Thereafter, the routine proceeds from step S311 to step S312.

At step S312, a check is made to determine, based on the actual wheel-cylinder pressure detected by wheel-cylinder pressure sensor 13 associated with the pressure-reduction-mode BA controlled wheel, whether wheel-cylinder pressure Pw of the pressure-reduction-mode BA controlled wheel reaches its target wheel-cylinder pressure Pw*. When target wheel-cylinder pressure Pw* has been reached, the routine proceeds from step S312 to step S313. Conversely when target wheel-cylinder pressure Pw* has not been reached, the routine returns from step S312 to step S311, so as to repeatedly execute a reduction of wheel-cylinder pressure Pw of the pressure-reduction-mode BA controlled wheel.

At step S313, pressure-reduction control valve 8, associated with the pressure-reduction-mode BA controlled wheel, is kept closed, so as to block fluid communication between reservoir RES and either one of wheel-brake cylinders 5a-5d, associated with the pressure-reduction-mode BA controlled wheel, thereby terminating a wheel-cylinder pressure reduction mode. Thereafter, the routine proceeds from step S313 to step S309.

At step S314, a pressure hold mode for the BA controlled wheel is executed. At least one of road wheels FL-RR, subjected to the pressure hold mode of BA control, is hereinafter referred to as “pressure-hold-mode BA controlled wheel”. Concretely, second pressure-buildup control valve 7, associated with the pressure-hold-mode BA controlled wheel, is deactivated (OFF) and kept closed, so as to cut off second brake circuit 2 (i.e., either one of fluid lines 2a-2d, associated with the pressure-hold-mode BA controlled wheel). Additionally, pressure-reduction control valve 8, associated with the pressure-hold-mode BA controlled wheel, is kept closed, so as to block fluid communication between reservoir RES and either one of wheel-brake cylinders 5a-5d, associated with the pressure-hold-mode BA controlled wheel. On the other hand, first pressure-buildup control valve 6, associated with the BA controlled wheel, has already been activated (ON) and kept closed through step S304. Under these conditions, brake fluid in wheel-brake cylinder 5 of the pressure-hold-mode BA controlled wheel, is sealed in by means of first and second pressure-buildup control valves 6-7 and pressure-reduction control valve 8, all associated with the pressure-hold-mode BA controlled wheel and fully closed, and thus wheel-cylinder pressure Pw of the pressure-hold-mode BA controlled wheel remains unchanged. Thereafter, the routine proceeds from step S314 to step S309.

### Effects of First Embodiment

An apparatus for and method of controlling brakes, made according to the first embodiment, can provide the following operation and effects.

(1) An apparatus for controlling brakes (a brake control system), made according to the first embodiment, includes master cylinder MC, wheel-brake cylinder 5, brake booster BS configured to actuate master cylinder MC for a pressure increase of brake fluid in master cylinder MC, first brake circuit 1 configured to supply brake fluid, which is pressure-increased by brake booster BS, to wheel-brake cylinder 5, a first control valve (i.e., first pressure-buildup control valve 6) disposed in first brake circuit 1 for establishing and blocking fluid communication between master cylinder MC and wheel-brake cylinder 5, a fluid-pressure source (i.e., pump P) provided for a pressure increase of brake fluid, separately from brake booster BS, second brake circuit 2 arranged in parallel with first brake circuit 1 and configured to supply brake fluid, which is pressure-increased by the fluid-pressure source (i.e., pump P), to wheel-brake cylinder 5, a second control valve (i.e., second pressure-buildup control valve 7) disposed in second brake circuit 2 for establishing and blocking fluid communication between the fluid-pressure source (i.e., pump P) and wheel-brake cylinder 5, and control unit CU provided to control operations of the first control valve (i.e., first pressure-buildup control valve 6), the second control valve (i.e., second pressure-buildup control valve 7), and the fluid-pressure source (i.e., pump P). Control unit CU is configured to selectively control the first and second control valves (first and second pressure-buildup control valves 6-7) when building up wheel-cylinder pressure Pw in wheel-brake cylinder 5, and further configured to build up wheel-cylinder pressure Pw by operating the fluid-pressure source (i.e., pump P) when at least the second control valve (at least second pressure-buildup control valve 7) is controlled to a valve-open position.

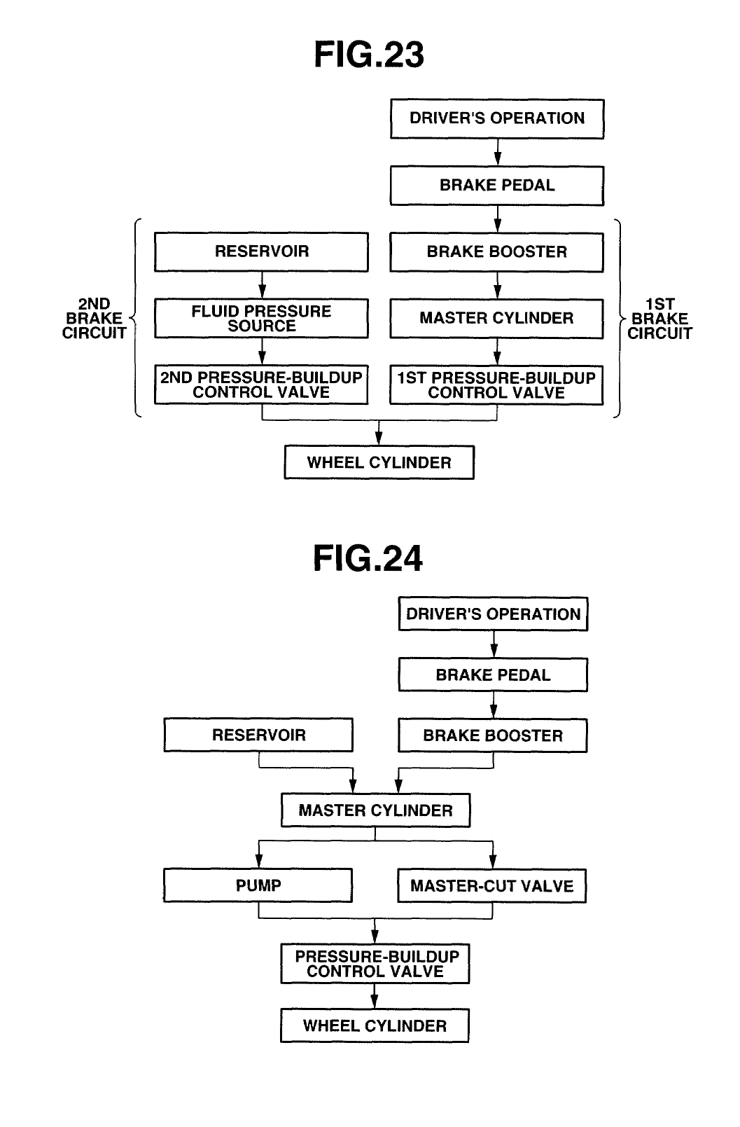

That is to say, as can be seen from the schematic diagram of FIG. 23, in the case of the brake control apparatus of the shown embodiment, as a fluid-flow path of the brake-fluid supply to wheel-brake cylinder 5, first brake circuit 1 concerned with a driver's braking operation or a driver's brake-pedal depression (in other words, master cylinder MC) and second brake circuit 2 concerned with the fluid-pressure source (i.e., pump P) are provided separately from each other. Additionally, a buildup of wheel-cylinder pressure Pw is achieved by properly selecting either first brake circuit 1 or second brake circuit 2. Therefore, it is possible to improve a controllability for wheel-cylinder pressure control and an operability for the brakes (especially, a brake-pedal feel), by preventing undesired interference between (i) a buildup of wheel-cylinder pressure Pw, produced by the driver's braking operation, and (ii) a buildup of wheel-cylinder pressure Pw, produced by the fluid-pressure source. More concretely, the brake control apparatus of the shown embodiment can provide the following effects.

First, for instance, during VDC control, second brake circuit 2 is selected for wheel-cylinder pressure control of wheel-brake cylinder 5 of the VDC controlled wheel (see steps S102-S104 in FIG. 7). On the other hand, first brake circuit 1 is selected for wheel-cylinder pressure control of wheel-brake cylinder 5 of the VDC noncontrolled wheel (see the flow from step S101 to step S108 in FIG. 7). Hence, in the presence of a further driver's brake-pedal depression during VDC control, first brake circuit 1 permits brake fluid to be supplied from master cylinder MC directly to wheel-brake cylinder 5 associated with the VDC noncontrolled wheel. Therefore, it is possible to directly reflect a driver's intention of increasing a vehicle deceleration rate (a negative longitudinal acceleration G), thereby enhancing a controllability for wheel-cylinder pressure control. Furthermore, by virtue of first brake circuit 1 permitting brake fluid to be supplied from master cylinder MC directly to wheel-brake cylinder 5 associated with the VDC noncontrolled wheel, it is possible to ensure an appropriate brake-pedal stroke in the presence of a further driver's brake-pedal depression, even during VDC control, thus effectively suppressing a poor or uncushioned feel of brake pedal BP, and consequently improving a brake-pedal feel.

Secondly, during a normal brake mode at which a buildup of wheel-cylinder pressure Pw is achieved by a driver's braking operation (a driver's brake-pedal depression), first brake circuit 1 is selected, such that the buildup of wheel-cylinder pressure Pw is created by master-cylinder pressure Pm supplied through first pressure-buildup control valve 6. In contrast, during a control brake mode (for example, during a VDC control brake mode) at which a buildup of wheel-cylinder pressure Pw of the controlled wheel is achieved by a fluid-pressure source (i.e., pump P), second brake circuit 2 is selected, such that the buildup of wheel-cylinder pressure Pw of the controlled wheel is created by fluid pressure produced by the fluid-pressure source (i.e., pump pressure produced by pump P) and supplied through second pressure-buildup control valve 7. A wheel-cylinder pressure control characteristic, attained by first brake circuit 1, and a wheel-cylinder pressure control characteristic, attained by second brake circuit 2, can be set independently of each other. For instance, the valve-seat diameter of first pressure-buildup control valve 6 can be set to a diameter suited to the normal brake mode, whereas the valve-seat diameter of second pressure-buildup control valve 7 can be set to a diameter suited to the control brake mode (wheel-cylinder pressure control). Therefore, it is possible to reconcile the enhanced brake system's responsiveness during the normal brake mode and the enhanced fluid-pressure control accuracy during the control brake mode (during wheel-cylinder pressure control).

Thirdly, during BA control, it is possible to supply pump pressure via second brake circuit 2, which circuit is capable of supplying brake fluid regardless of a driver's braking operation, to wheel-brake cylinder 5, while simultaneously supplying master-cylinder pressure Pm, produced by the driver's braking operation, via first brake circuit 1 to wheel-brake cylinder 5. Regarding second brake circuit 2, the fluid-pressure source (i.e., pump P) is configured to suck brake fluid directly from reservoir RES not though master cylinder MC. Thus, it is possible to quickly build up wheel-cylinder pressure Pw regardless of the traveling speed of the master-cylinder piston. Therefore, during BA control, it is possible to quickly build up wheel-cylinder pressure Pw at a higher speed exceeding an operation speed for the driver's braking operation by operating the fluid-pressure source (i.e., pump P), while building up wheel-cylinder pressure Pw by means of master cylinder MC (see step S302 of FIG. 11). Accordingly, it is possible to enhance the brake system's responsiveness for a buildup of wheel-cylinder pressure Pw during BA control.

Even when a failure in an electric system, which is provided to operate the fluid-pressure source (i.e., pump P), occurs and thus a buildup of wheel-cylinder pressure Pw, achieved by second brake circuit 2, becomes disabled, a driver's leg power can be assisted by brake booster BS configured to actuate master cylinder MC. That is, even in the presence of an electric-system failure, it is possible to achieve a buildup of wheel-cylinder pressure Pw by first brake circuit 1, and thus there is a less risk of a fall in braking force. This also eliminates the necessity of having a dual electric system (a dual controller system, comprised of a primary CPU and a secondary CPU, a dual sensor system, comprised of a primary sensor and a secondary sensor), thus enabling lower system installation time and costs and smaller space requirements of overall system.

(2) The valve-seat diameter of the first control valve (first pressure-buildup control valve 6) is dimensioned to be greater than that of the second control valve (second pressure-buildup control valve 7).

As can be appreciated from the cross sections of FIGS. 2-3, the flow rate of brake fluid flowing through first pressure-buildup control valve 6 or second pressure-buildup control valve 7 (especially, a fluid-flow passage between first port 62 and second port 65) is determined based on (i) the distance Xv (that is, the valve opening) between the tip 64A of plunger 64 and valve seat 63, and (ii) the valve-seat diameter. For the same valve opening, the larger the valve-seat diameter, the greater the flow rate of brake fluid that can flow through first pressure-buildup control valve 6 (or second pressure-buildup control valve 7). That is, such a large valve-seat diameter contributes to the enhanced brake system's responsiveness for a buildup of wheel-cylinder pressure Pw. In contrast, for the same valve opening, the smaller the valve-seat diameter, the less the flow rate of brake fluid that can flow through first pressure-buildup control valve 6 (or second pressure-buildup control valve 7). That is, such a small valve-seat diameter contributes to the reduced change in the flow rate with respect to valve opening Xv (in other words, current value I of the current flowing through coil 68), thus ensuring the enhanced fluid-flow control accuracy during wheel-cylinder pressure control.

For the reasons discussed above, by setting the valve-seat diameter of first pressure-buildup control valve 6 to a value larger than that of second pressure-buildup control valve 7, it is possible to enhance the brake system's responsiveness for a buildup of wheel-cylinder pressure Pw during the normal brake mode at which the wheel-cylinder pressure buildup is created by master-cylinder pressure Pm supplied through first pressure-buildup control valve 6. In other words, by setting the valve-seat diameter of second pressure-buildup control valve 7 to a value smaller than that of first pressure-buildup control valve 6, it is possible to enhance the fluid-pressure control accuracy (or the fluid-flow control accuracy) during the control brake mode at which the wheel-cylinder pressure buildup of the controlled wheel is created by pump pressure supplied through second pressure-buildup control valve 7.

(3) The apparatus for controlling brakes, made according to the first embodiment, includes reservoir RES communicating with a back-pressure chamber of master cylinder MC, a third brake circuit (a return circuit) via which wheel-brake cylinder 5 and reservoir RES are connected to each other, and a third control valve (pressure-reduction control valve 8) disposed in the third brake circuit (the return circuit) for establishing and blocking fluid communication between wheel-brake cylinder 5 and reservoir RES.

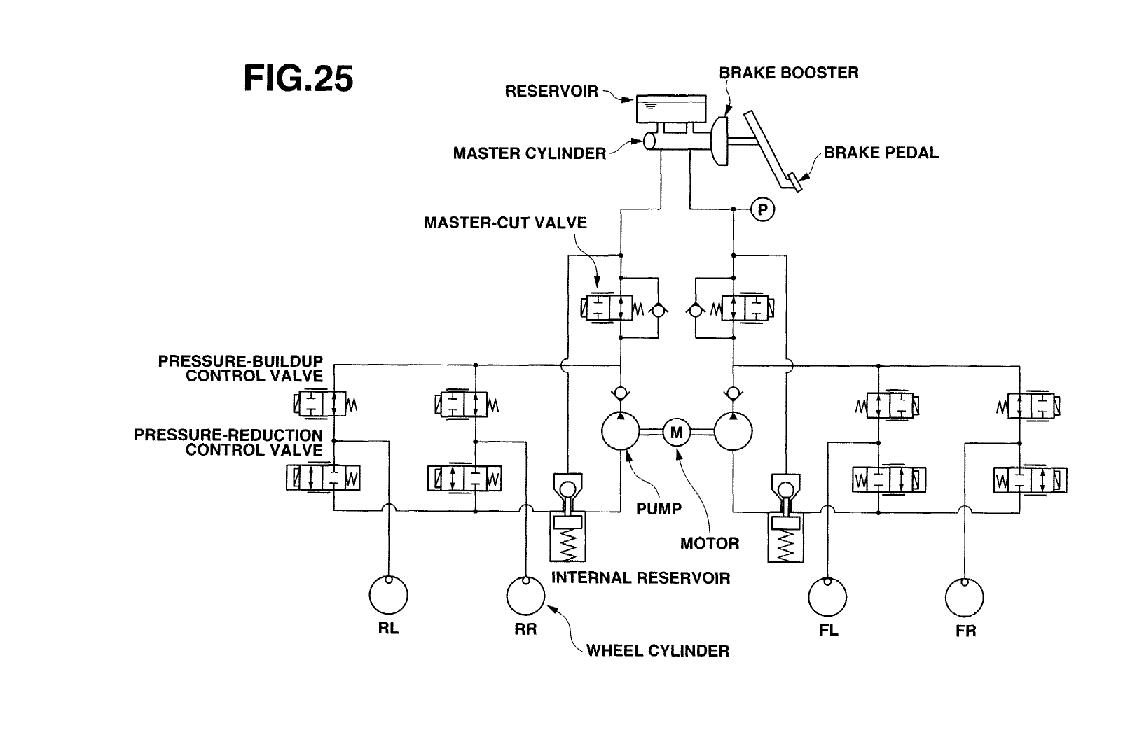

That is, in the case of the braking device of the comparative example shown in FIG. 25, during the pressure reduction mode of ABS control, brake fluid is returned to the apply pressure chamber of master cylinder MC and therefore the brake pedal is kicked back. Such a kick-back force would likely cause the driver to feel considerable discomfort. In contrast, in the case of the brake control apparatus of the first embodiment, when reducing wheel-cylinder pressure Pw via the return circuit (the third brake circuit) with pressure-reduction control valve 8 kept open during the pressure reduction mode of ABS control, brake fluid in wheel-brake cylinder 5 is returned through pressure-reduction control valve 8 via the return circuit to reservoir RES (that is, the back-pressure chamber of master cylinder MC). This eliminates an undesirable kicked-back feel of brake pedal BP, thus improving a brake-pedal feel during the pressure reduction mode of ABS control.

(4) The first control valve (first pressure-buildup control valve 6) is constructed as a normally-open valve, whereas the second control valve (second pressure-buildup control valve 7) is constructed as a normally-closed valve.

That is, during the normal brake mode, with first pressure-buildup control valve 6 kept open and second pressure-buildup control valve 7 kept closed, a buildup of wheel-cylinder pressure Pw is created or achieved by master-cylinder pressure Pm supplied through first pressure-buildup control valve 6, utilizing first brake circuit 1. Conversely, during the automatic brake control (during the control brake mode), such as during VDC control, with second pressure-buildup control valve 7 kept open and first pressure-buildup control valve 6 kept closed, a buildup of wheel-cylinder pressure Pw, associated with the controlled wheel, is created or achieved by pump pressure supplied through second pressure-buildup control valve 7, utilizing second brake circuit 2. Hence, by constructing first pressure-buildup control valve 6 as a normally-open valve and by constructing second pressure-buildup control valve 7 as a normally-closed valve, it is possible to realize a buildup of wheel-cylinder pressure Pw, with first and second pressure-buildup control valves 6-7 both de-energized (deactivated), during the normal brake mode (during normal braking action) of a comparatively long operating time. Conversely, during the automatic brake control (during the control brake mode) of a comparatively short operating time, a buildup of wheel-cylinder pressure Pw is realized with first and second pressure-buildup control valves 6-7 both energized (activated). Therefore, it is possible to effectively reduce or shorten the total energization time for the control valves. This contributes to the reduced electric power consumption.

(5) The previously-noted normally-open valve (i.e., first pressure-buildup control valve 6) is arranged or configured to permit fluid pressure (master-cylinder pressure Pm) from master cylinder MC to act in a direction for opening the valve (see FIG. 2).

Regarding the function and operation of the normally-open valve (especially, first pressure-buildup control valves 6a-6b), as shown in FIG. 2, when master-cylinder pressure Pm is higher than wheel-cylinder pressure Pw (i.e., Pm>Pw), the hydraulic pressure acts on plunger 64 in the positive x-axis direction (i.e., in the direction for opening of first pressure-buildup control valve 6). Thus, it is possible to easily balance the hydraulic pressure with the electromagnetic force acting in the opposite direction (the negative x-axis direction). Therefore, it is possible to enhance a controllability of first pressure-buildup control valve 6, when building up wheel-cylinder pressure Pw by establishing first brake circuit 1 by opening first pressure-buildup control valve 6 and by supplying master-cylinder pressure Pm via first pressure-buildup control valve 6 (via first brake circuit 1) to wheel-brake cylinder 5.

Conversely when master-cylinder pressure Pm is lower than wheel-cylinder pressure Pw (i.e., Pm<Pw), the hydraulic pressure acts on plunger 64 in the negative x-axis direction (i.e., in the direction for blocking (cutting off) of first brake circuit 1). Thus, when closing first pressure-buildup control valve 6 in accordance with an increase in the electromagnetic force, that is, when cutting off first brake circuit 1 (first pressure-buildup control valve 6) in accordance with an increase in current value I of the current applied to coil 68, the hydraulic pressure can be applied to armature 67, together with plunger 64, as an assist force, combined with the electromagnetic force. By way of application of the hydraulic pressure, serving as an assist force and acting in the same sense of action of the electromagnetic force, it is possible to rapidly cut off first pressure-buildup control valve 6. Hence, the following effects can be provided.

During ABS control, it is possible to enhance a controllability for wheel-cylinder pressure control, when building up wheel-cylinder pressure Pw by establishing first brake circuit 1 by opening first pressure-buildup control valve 6 and by supplying master-cylinder pressure Pm via first pressure-buildup control valve 6 (via first brake circuit 1) to wheel-brake cylinder 5 (see step S216 of FIG. 9). At this time (see step S216), a stroke of brake pedal BP, depressed by the driver, is permitted, thus ensuring a smooth movement of brake pedal BP when supplying master-cylinder pressure Pm to wheel-brake cylinder 5, that is, a good brake-pedal feel.

During BA control, when blocking (cutting off) first brake circuit 1 by closing first pressure-buildup control valve 6 after wheel-cylinder pressure Pw has exceeded master-cylinder pressure Pm (see step S304 of FIG. 11), first pressure-buildup control valve 6 can be rapidly closed, thus enhancing a controllability of the brake control system.

(6) The previously-noted normally-open valve (i.e., first pressure-buildup control valve 6) may be arranged or configured to permit fluid pressure (wheel-cylinder pressure Pw) from wheel-brake cylinder 5 to act in a direction for opening the valve (see FIG. 3).

Regarding the function and operation of the normally-open valve (especially, first pressure-buildup control valves 6c-6d), as shown in FIG. 3, when master-cylinder pressure Pm is lower than wheel-cylinder pressure Pw (i.e., Pm<Pw), the hydraulic pressure acts on plunger 64 in the positive x-axis direction (i.e., in the direction for opening of first pressure-buildup control valve 6). Thus, it is possible to easily balance the hydraulic pressure with the electromagnetic force acting in the opposite direction (the negative x-axis direction). Therefore, it is possible to enhance a controllability of first pressure-buildup control valve 6, when reducing wheel-cylinder pressure Pw by establishing first brake circuit 1 by opening first pressure-buildup control valve 6 and by supplying wheel-cylinder pressure Pw via first pressure-buildup control valve 6 (via first brake circuit 1) to master cylinder MC.

Conversely when master-cylinder pressure Pm is higher than wheel-cylinder pressure Pw (i.e., Pm>Pw), the hydraulic pressure acts on plunger 64 in the negative x-axis direction (i.e., in the direction for blocking (cutting off) of first brake circuit 1). Thus, when closing first pressure-buildup control valve 6 in accordance with an increase in the electromagnetic force, that is, when cutting off first brake circuit 1 (first pressure-buildup control valve 6) in accordance with an increase in current value I of the current applied to coil 68, the hydraulic pressure can be applied to armature 67, together with plunger 64, as an assist force, combined with the electromagnetic force. By way of application of the hydraulic pressure, serving as an assist force and acting in the same sense of action of the electromagnetic force, it is possible to rapidly cut off first pressure-buildup control valve 6. Hence, the following effects can be provided.

When brake pedal BP is released by the driver during ABS control and then master-cylinder pressure Pm becomes lower than wheel-cylinder pressure Pw, wheel-cylinder pressure control terminates. At this time, wheel-cylinder pressure Pw can be reduced by establishing first brake circuit 1 by opening first pressure-buildup control valve 6 and by supplying wheel-cylinder pressure Pw via first pressure-buildup control valve 6 (via first brake circuit 1) to master cylinder MC (see step S225 of FIG. 10). Because of the hydraulic pressure easily balanced with the electromagnetic force acting in the opposite direction, it is possible to enhance a controllability of first pressure-buildup control valve 6 when reducing wheel-cylinder pressure Pw, and also to ensure a smooth change in wheel-cylinder pressure Pw. This improves a brake-pedal feel.

When cutting off first brake circuit 1 by closing first pressure-buildup control valve 6 at the beginning of ABS control, at which brake-pedal stroke SBP is greater than or equal to predetermined threshold value So, i.e., SBP≧So(see step S203 of FIG. 8), master-cylinder pressure Pm becomes higher than wheel-cylinder pressure Pw (i.e., Pm>Pw). At this time, by virtue of the valve configuration, first pressure-buildup control valve 6 can be rapidly closed, thus enhancing a controllability of wheel-cylinder pressure control.

(7) First brake circuit 1 (fluid lines 1a-1d) and second brake circuit 2 (fluid lines 2a-2d) are provided for each individual road wheel FL-RR. The first control valve (first pressure-buildup control valve 6) is constructed as a normally-open valve. Of these normally-open valves (first pressure-buildup control valves 6a-6d) of road wheels FL-RR, each of the normally-open valves (first pressure-buildup control valves 6a-6b), associated with respective front road wheels FL-FR, is arranged or configured to permit fluid pressure (master-cylinder pressure Pm) from master cylinder MC to act in a direction for opening the valve (see FIG. 2). On the other hand, each of the normally-open valves (first pressure-buildup control valves 6c-6d), associated with respective rear road wheels RL-RR, is arranged or configured to permit fluid pressure (wheel-cylinder pressure Pw) from wheel-brake cylinder 5 to act in a direction for opening the valve (see FIG. 3).

By virtue of the previously-noted valve arrangement of front-wheel side first pressure-buildup control valves 6a-6b, when building up wheel-cylinder pressure Pw by establishing first brake circuit 1 (by permitting brake-fluid flow through fluid lines 1a-1b) by opening first pressure-buildup control valves 6a-6b and by supplying master-cylinder pressure Pm via first pressure-buildup control valves 6a-6b (via first brake circuit 1) to wheel-brake cylinders 5a-5b, during ABS control (see step S216 of FIG. 9), it is possible to efficiently supply brake fluid to front-wheel side wheel-brake cylinders 5a-5b (having a higher flow rate of brake fluid consumed as compared to rear-wheel side wheel-brake cylinders 5c-5d) with a high controllability. Additionally, a flow rate of brake fluid supplied from master cylinder MC to wheel-brake cylinders 5a-5b increases by the flow rate of brake fluid consumed by front-wheel side wheel-brake cylinders 5a-5b, thus ensuring or permitting a stroke of brake pedal BP, and consequently enabling a good brake-pedal feel.

On the other hand, by virtue of the previously-noted valve arrangement of rear-wheel side first pressure-buildup control valves 6c-6d, it is possible to enhance a controllability of rear-wheel side wheel-cylinder pressures at the beginning of ABS control (see step S203 of FIG. 8). Furthermore, when reducing wheel-cylinder pressure Pw through first brake circuit 1 (i.e., fluid lines 1c-1d) by opening rear-wheel side first pressure-buildup control valves 6c-6d (see step S225 of FIG. 10) in proceeding to a termination of ABS control owing to a driver's brake-pedal release, it is possible to enhance a controllability of rear-wheel side wheel-cylinder pressures. That is, at the beginning of ABS control as well as at the end of ABS control, it is possible to enhance or improve the controllability of rear-wheel side wheel-cylinder pressures. This contributes to the enhanced driving stability (both the enhanced vehicle driveability and the enhanced vehicle stability).

(8) The apparatus for controlling brakes, made according to the first embodiment, includes brake pedal BP to which a driver's braking operation is made, and a manipulated variable detector (i.e., stroke sensor 11) configured to detect a manipulated variable (i.e., a brake-pedal stroke SBP) of brake pedal BP. Control unit CU is configured to selectively control, based on the detected manipulated variable of brake pedal BP, the first and second control valves (first and second pressure-buildup control valves 6-7), and further configured to control the second control valve (second pressure-buildup control valve 7) to a valve-open state, when the detected manipulated variable (brake-pedal stroke SBP) of brake pedal BP is greater than or equal to predetermined threshold value So (i.e., SBP≧So).

That is, during ABS control, control unit CU executes, based on the manipulated variable (brake-pedal stroke SBP) of brake pedal BP, switching between first and second brake circuits 1-2. When the manipulated variable (brake-pedal stroke SBP) of brake pedal BP is less than predetermined threshold value So (i.e., SBP<So), control unit CU selects first brake circuit 1 for wheel-cylinder pressure control (see the flow from step S202 of FIG. 8 to steps S214-S224 of FIG. 9). Conversely when the manipulated variable (brake-pedal stroke SBP) of brake pedal BP is greater than or equal to predetermined threshold value So (i.e., SBP≧So), control unit CU selects second brake circuit 2 for wheel-cylinder pressure control (see the flow from step S202 of FIG. 8 to steps S203-S213 of FIG. 8). Predetermined threshold value So is set to a proper stroke, ranging from 30 mm to 40 mm or more, at which stroke the driver never experiences a poor or uncushioned feel of brake pedal BP. Thus, within a small stroke range (SBP<So) less than predetermined threshold value So, in which the driver may experience a poor or uncushioned brake-pedal feel, it is possible to permit a brake-pedal stroke to a certain degree by supplying master-cylinder pressure Pm directly to wheel-brake cylinder 5, thereby preventing a poor or uncushioned feel of brake pedal BP.

(9) In a method of controlling brakes, made according to the first embodiment, using a brake control system having master cylinder MC, wheel-brake cylinder 5, brake booster BS configured to actuate master cylinder MC for a pressure increase of brake fluid in master cylinder MC, first brake circuit 1 configured to supply brake fluid, which is pressure-increased by brake booster BS, to wheel-brake cylinder 5, a fluid-pressure source (i.e., pump P) provided for a pressure increase of brake fluid, separately from brake booster BS, and second brake circuit 2 arranged in parallel with first brake circuit 1 and configured to supply brake fluid, which is pressure-increased by the fluid-pressure source (i.e., pump P), to wheel-brake cylinder 5, switching among (i) a pressure buildup achieved by only the first brake circuit 1, (ii) a pressure buildup achieved by only the second brake circuit 2, and (iii) a pressure buildup achieved by both the first brake circuit 1 and the second brake circuit 2 is controlled responsively to a manipulated variable (brake-pedal stroke SBP) of brake pedal BP.

Accordingly, the brake control method of the shown embodiment can provide the same effect (1) as previously explained. For instance, during the pressure buildup of wheel-cylinder pressure Pw, achieved by first and second brake circuits 1-2, it is possible to execute BA control that assists the driver's braking operation (that is, the driver's braking effort).

### Second Embodiment

### Valve Arrangement of Second Embodiment

An apparatus for controlling brakes, made according to the second embodiment, has almost the same configuration of first pressure-buildup control valve 6 as the brake control apparatus of the first embodiment, but a direction of arrangement of each individual front-wheel side first pressure-buildup control valve 6a-6b and a direction of arrangement of each individual rear-wheel side first pressure-buildup control valve 6c-6d are reversed for the brake control apparatuses of the first and second embodiments. Concretely, in the second embodiment, first ports 62, 62 of first pressure-buildup control valves 6a-6b of the front-wheel side are connected to the respective downstream sides of fluid lines 1a-1b, and thus connected via fluid lines 1a-1b to respective front-wheel side wheel-brake cylinders 5a-5b. That is, first port 62 of each of front-wheel side first pressure-buildup control valves 6a-6b serves as a wheel-cylinder pressure port. On the other hand, second ports 65, 65 of front-wheel side first pressure-buildup control valves 6a-6b are connected to the respective upstream sides of fluid lines 1a-1b, and thus connected via fluid lines 1a-1b to master cylinder MC. That is, second port 65 of each of front-wheel side first pressure-buildup control valves 6a-6b serves as a master-cylinder pressure port. On the other hand, first ports 62, 62 of first pressure-buildup control valves 6c-6d of the rear-wheel side are connected to the respective upstream sides of fluid lines 1c-1d, and thus connected via fluid lines 1c-1d to master cylinder MC. That is, first port 62 of each of rear-wheel side first pressure-buildup control valves 6c-6d serves as a master-cylinder pressure port. Second ports 65, 65 of first pressure-buildup control valves 6a-6b of the rear-wheel side are connected to the respective downstream sides of fluid lines 1c-1d, and thus connected via fluid lines 1c-1d to respective rear-wheel side wheel-brake cylinders 5c-5d. That is, second port 65 of each of rear-wheel side first pressure-buildup control valves 6c-6d serves as a wheel-cylinder pressure port.

### Effects of Second Embodiment

(10) First brake circuit 1 (fluid lines 1a-1d) and second brake circuit 2 (fluid lines 2a-2d) are provided for each individual road wheel FL-RR of the automotive vehicle. The first control valve (first pressure-buildup control valve 6) is constructed as a normally-open valve. Of these normally-open valves (first pressure-buildup control valves 6a-6d) of road wheels FL-RR, each of the normally-open valves (first pressure-buildup control valves 6a-6b), associated with respective front road wheels FL-FR, is arranged or configured to permit fluid pressure (wheel-cylinder pressure Pw) from wheel-brake cylinder 5 to act in a direction for opening the valve (see FIG. 3). On the other hand, each of the normally-open valves (first pressure-buildup control valves 6c-6d), associated with respective rear road wheels RL-RR, is arranged or configured to permit fluid pressure (master-cylinder pressure Pm) from master cylinder MC to act in a direction for opening the valve (see FIG. 2).

In the brake control apparatus of the second embodiment, by virtue of the previously-noted valve arrangement of front-wheel side first pressure-buildup control valves 6a-6b, when reducing wheel-cylinder pressure Pw through first brake circuit 1 (i.e., fluid lines 1a-1b) by opening front-wheel side first pressure-buildup control valves 6a-6b (see step S225 of FIG. 10) in proceeding to a termination of ABS control owing to a driver's brake-pedal release, it is possible to efficiently exhaust brake fluid from front-wheel side wheel-brake cylinders 5a-5b (having a higher flow rate of brake fluid consumed, as compared to rear-wheel side wheel-brake cylinders 5c-5d) with a high controllability. Therefore, it is possible to enhance a controllability of wheel-cylinder pressure Pm of the front wheel side (FL-FR), having a higher braking force distribution, as compared to the rear wheel side (RL-RR), thus ensuring a smooth change in a vehicle deceleration rate (deceleration G). Additionally, a flow rate of brake fluid supplied from wheel-brake cylinders 5a-5b to master cylinder MC increases by the flow rate of brake fluid consumed by front-wheel side wheel-brake cylinders 5a-5b, thus enhancing a brake-pedal feel.

### Third Embodiment

### BA Control of Third Embodiment

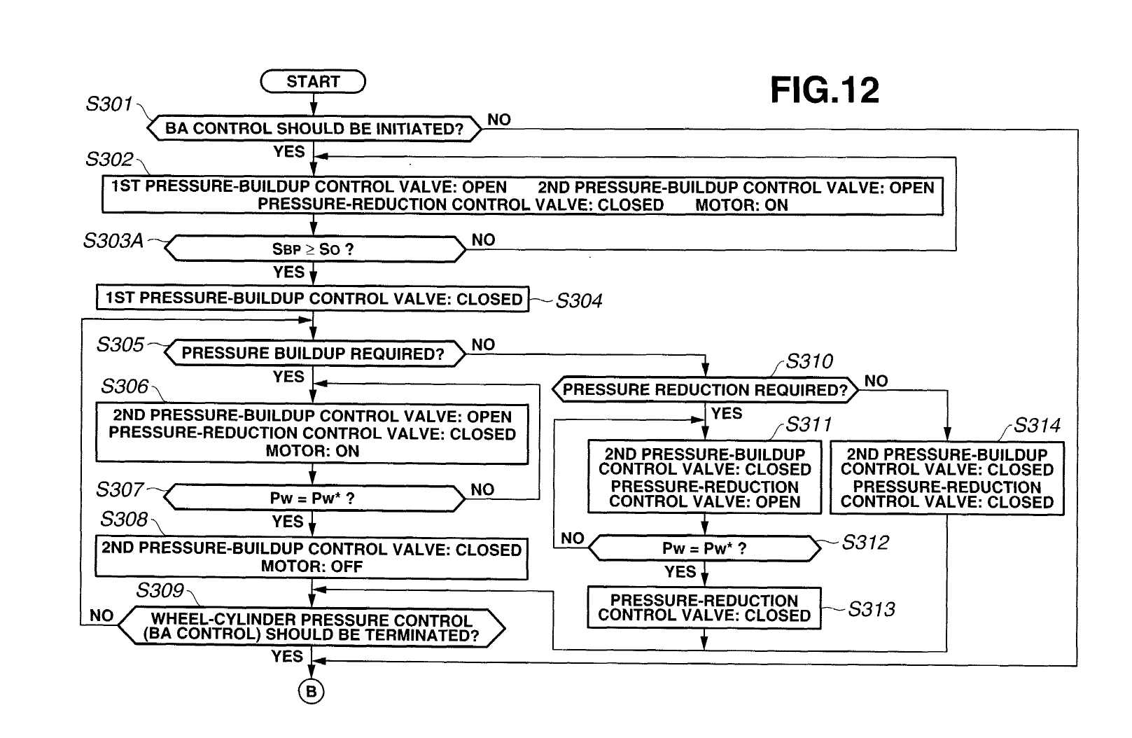

Referring now to FIG. 12, there is shown the flowchart concerning the wheel-cylinder pressure control routine executed by control unit CU, incorporated in the brake control apparatus of the third embodiment, during BA control. The control routine of FIG. 12 is also executed as time-triggered interrupt routines. The BA control routine of the third embodiment shown in FIG. 12 is similar to that of the first embodiment shown in FIG. 11, except that step S303 of FIG. 11 is replaced with step S303A of FIG. 12. Thus, the same step numbers used to designate steps in the routine shown in FIG. 10 will be applied to the corresponding step numbers used in the BA control routine shown in FIG. 11, for the purpose of comparison of the first and third embodiments. Step S303A will be hereinafter described in detail with reference to the accompanying drawings, while detailed description of steps S301, S302, and S304-S314 will be omitted because the above description thereon seems to be self-explanatory.

At step S303A, a check is made to determine whether a stroke SBP of brake pedal BP is greater than or equal to a predetermined threshold value So (i.e., SBP≧So). When SBP≧So, the routine proceeds from step S303A to step S304. Conversely when SBP<So, the routine proceeds from step S303A to step S302, so as to repeatedly execute a buildup of wheel-cylinder pressure Pw. The previously-noted brake-pedal stroke SBP is determined based on the sensor signal from stroke sensor 11. In the third embodiment, predetermined threshold value So is set to a proper stroke, ranging from 30 mm to 40 mm or more, at which stroke the driver never experiences a poor or uncushioned feel of brake pedal BP.

### Effects of Third Embodiment

(11) The apparatus for controlling brakes, made according to the third embodiment, includes brake pedal BP to which a driver's braking operation is made, and a manipulated variable detector (i.e., stroke sensor 11) configured to detect a manipulated variable (i.e., a brake-pedal stroke SBP) of brake pedal BP. Control unit CU is configured to selectively control, based on the manipulated variable of brake pedal BP, the first and second control valves (first and second pressure-buildup control valves 6-7), and further configured to control the second control valve (second pressure-buildup control valve 7) to a valve-open state, when the manipulated variable (brake-pedal stroke SBP) of brake pedal BP is greater than or equal to predetermined threshold value So (i.e., SBP≧So).

Therefore, in addition to the effect as previously discussed in the item (8), obtained by the apparatus of the first embodiment, the apparatus of the third embodiment can provide the following effect.

That is, during BA control, control unit CU executes, based on the manipulated variable (brake-pedal stroke SBP) of brake pedal BP, switching between first and second brake circuits 1-2. When the manipulated variable (brake-pedal stroke SBP) of brake pedal BP is less than predetermined threshold value So (i.e., SBP<So), control unit CU selects both brake circuits 1-2 for wheel-cylinder pressure control (see the flow from step S303A to step S302 of FIG. 12). Conversely when the manipulated variable (brake-pedal stroke SBP) of brake pedal BP is greater than or equal to predetermined threshold value So (i.e., SBP≧So), control unit CU selects only the second brake circuit 2 for wheel-cylinder pressure control (see the flow from step S303A to steps S304-S314 of FIG. 12). Thus, within a small stroke range (SBP<So) less than predetermined threshold value So, in which the driver may experience a poor or uncushioned brake-pedal feel, it is possible to permit a brake-pedal stroke to a certain degree by supplying master-cylinder pressure Pm directly to wheel-brake cylinder 5, thereby preventing a poor or uncushioned feel of brake pedal BP.

### Fourth Embodiment

### Pressure-Reducing Method of Fourth Embodiment

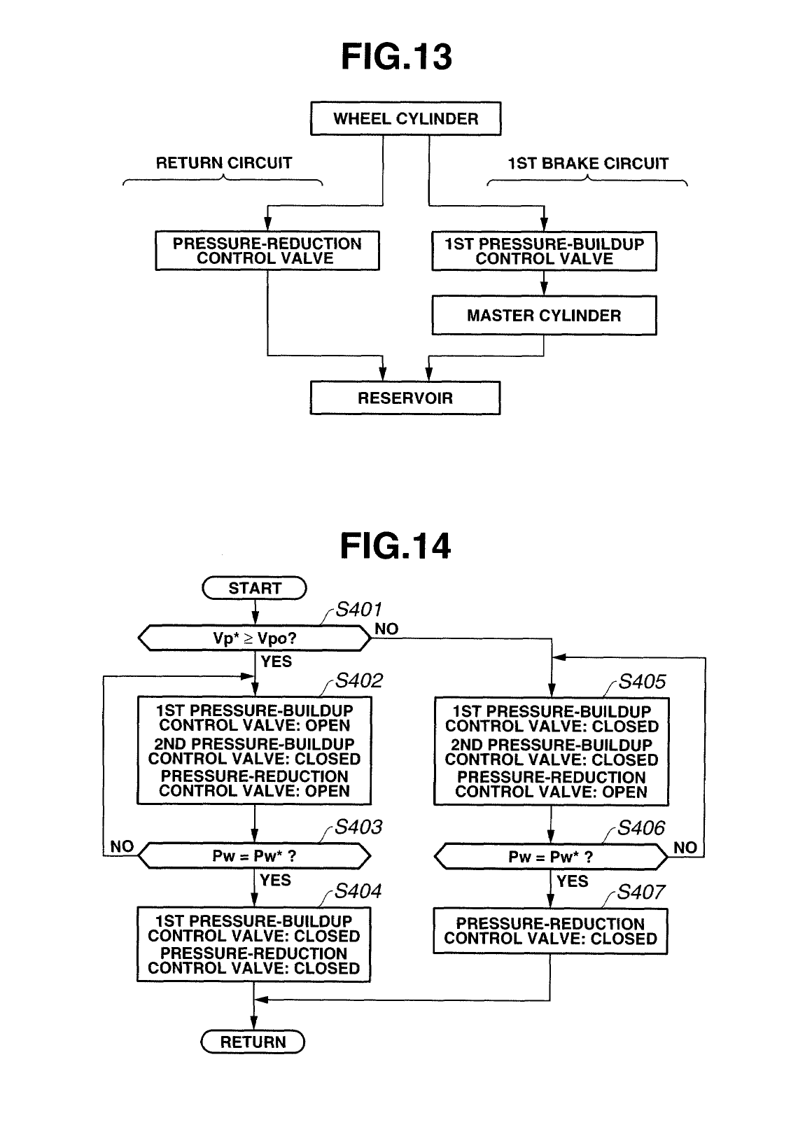

Referring now to FIG. 13, there is shown the brake-fluid flow during a reduction of wheel-cylinder pressure Pw in the apparatus (the brake control system) of the fourth embodiment. As set forth above, the return circuit (the third brake circuit), via which wheel-brake cylinder 5, pressure-reduction control valve 8, and reservoir RES are connected to each other, is arranged in parallel with first brake circuit 1, such that a part of fluid lines included in the return circuit is shared with second brake circuit 2. In the brake control system of the fourth embodiment, a reduction of wheel-cylinder pressure Pw is attained by only the return circuit during the normal bake mode (see the left-hand side brake-fluid flow in FIG. 13 from wheel-brake cylinder 5 through the return circuit and pressure-reduction control valve 8 to reservoir RES). In contrast, under a specified state where a desired pressure-reduction speed Vp* of wheel-cylinder pressure Pw is high, a reduction of wheel-cylinder pressure Pw is attained by the first brake circuit 1 as well as the return circuit (see both the left-hand side brake-fluid flow in FIG. 13 from wheel-brake cylinder 5 through the return circuit and pressure-reduction control valve 8 to reservoir RES and the right-hand side brake-fluid flow in FIG. 13 from wheel-brake cylinder 5 through first brake circuit 1, first pressure-buildup control valve 6 and master cylinder MC to reservoir RES). Thus, it is possible to realize a higher pressure-reduction speed of wheel-cylinder pressure Pw.

Referring now to FIG. 14, there is shown the pressure-reduction control routine executed within control unit CU incorporated in the brake control apparatus of the fourth embodiment (see the schematic diagram of FIG. 13). The pressure-reduction control flow of FIG. 14 is provided to enable the selection of either a higher pressure-reduction speed or a normal pressure-reduction speed. For instance, when wheel-cylinder pressure Pw is higher than master-cylinder pressure Pm, the pressure-reduction control flow of FIG. 14 is executed instead of steps S110-S112 of FIG. 7 during VDC control, or instead of steps S210-S212 of FIG. 8 during ABS control, or instead of steps S221-S223 of FIG. 9, or instead of steps S311-S313 of FIG. 11 during BA control.

At step S401, a check is made to determine whether a desired pressure-reduction speed Vp* of wheel-cylinder pressure Pw is greater than or equal to a predetermined speed value Vpo (i.e., Vp*≧Vpo), and thus a rapid reduction of wheel-cylinder pressure Pw is required. When Vp*≧Vpo, in other words, in the presence of a rapid pressure-reducing requirement, the routine proceeds from step S401 to step S402. Conversely when Vp*<Vpo, in other words, in the absence of a rapid pressure-reducing requirement, the routine proceeds from step S401 to step S405. In the fourth embodiment, predetermined speed value Vpo is set to a proper speed value substantially equal to a maximum pressure-reduction speed, obtained when a reduction of wheel-cylinder pressure Pw is attained by only the return circuit (pressure-reduction control valve 8). Desired pressure-reduction speed Vp* is calculated or determined based on a deviation between the calculated target wheel-cylinder pressure Pw* (a control command wheel-cylinder pressure) and the detected wheel-cylinder pressure Pw (the actual wheel-cylinder pressure).

At step S402, second pressure-buildup control valve 7, associated with the controlled wheel, is deactivated (OFF) and kept closed, so as to block (cut off) second brake circuit 2 (i.e., either one of fluid lines 2a-2d, associated with the controlled wheel). On the other hand, pressure-reduction control valve 8, associated with the controlled wheel, is kept open, so as to establish fluid communication between reservoir RES and either one of wheel-brake cylinders 5a-5d, associated with the controlled wheel, thereby permitting the wheel-cylinder pressure to be relieved or escaped to reservoir RES. At the same time, first pressure-buildup control valve 6, associated with the controlled wheel, is deactivated (OFF) and kept open, so as to permit brake-fluid flow through first brake circuit 1 (i.e., either one of fluid lines 1a-1d, associated with the controlled wheel). Thus, a simultaneous reduction of wheel-cylinder pressure Pw can be realized by supplying wheel-cylinder pressure Pw via first pressure-buildup control valve 6 (first brake circuit 1), associated with the controlled wheel, to master cylinder MC. Accordingly, a reduction of wheel-cylinder pressure Pw can be achieved by means of pressure-reduction control valve 8 (the return circuit) as well as first pressure-buildup control valve 6 (first brake circuit 1). As a result, it is possible to efficiently increase an actual pressure-reduction speed Vp of wheel-cylinder pressure Pw, as compared to a reduction of wheel-cylinder pressure Pw achieved by only the pressure-reduction control valve 8 (the return circuit). Thereafter, the routine proceeds from step S402 to step S403.

At step S403, a check is made to determine, based on the actual wheel-cylinder pressure detected by wheel-cylinder pressure sensor 13 associated with the controlled wheel, whether wheel-cylinder pressure Pw of the controlled wheel reaches its target wheel-cylinder pressure Pw*. When target wheel-cylinder pressure Pw* has been reached, the routine proceeds from step S403 to step S404. Conversely when target wheel-cylinder pressure Pw* has not been reached, the routine returns from step S403 to step S402, so as to repeatedly execute a reduction of wheel-cylinder pressure Pw of the controlled wheel.

At step S404, first pressure-buildup control valve 6, associated with the controlled wheel, is activated (ON) and kept closed, so as to block (cut off) first brake circuit 1, and at the same time pressure-reduction control valve 8, associated with the controlled wheel, is kept closed, so as to block fluid communication between reservoir RES and either one of wheel-brake cylinders 5a-5d, associated with the controlled wheel. In this manner, a rapid wheel-cylinder pressure reduction mode (at a higher pressure-reduction speed) terminates.

At step S405, executed under a specified condition defined by an inequality Vp*<Vpo, in order to initiate a normal wheel-cylinder pressure reduction mode (at a normal pressure-reduction speed), first pressure-buildup control valve 6, associated with the controlled wheel, is activated (ON) and kept closed, so as to block (cut off) first brake circuit 1 (i.e., either one of fluid lines 1a-1d, associated with the controlled wheel). On the other hand, second pressure-buildup control valve 7, associated with the controlled wheel, is deactivated (OFF) and kept closed, so as to block (cut off) second brake circuit 2 (i.e., either one of fluid lines 2a-2d, associated with the controlled wheel). Furthermore, pressure-reduction control valve 8, associated with the controlled wheel, is kept open, so as to establish fluid communication between reservoir RES and either one of wheel-brake cylinders 5a-5d, associated with the controlled wheel, thereby permitting the wheel-cylinder pressure to be relieved or escaped to reservoir RES. Thereafter, the routine proceeds from step S405 to step S406.

At step S406, a check is made to determine, based on the actual wheel-cylinder pressure detected by wheel-cylinder pressure sensor 13 associated with the controlled wheel, whether wheel-cylinder pressure Pw of the controlled wheel reaches its target wheel-cylinder pressure Pw*. When target wheel-cylinder pressure Pw* has been reached, the routine proceeds from step S406 to step S407. Conversely when target wheel-cylinder pressure Pw* has not been reached, the routine returns from step S406 to step S405, so as to repeatedly execute a reduction of wheel-cylinder pressure Pw of the controlled wheel.

At step S407, pressure-reduction control valve 8, associated with the controlled wheel, is kept closed, so as to block fluid communication between reservoir RES and either one of wheel-brake cylinders 5a-5d, associated with the controlled wheel. In this manner, a normal wheel-cylinder pressure reduction mode (at a normal pressure-reduction speed) terminates.

### Effects of Fourth Embodiment

(12) The apparatus for controlling brakes, made according to the third embodiment, includes reservoir RES communicating with a back-pressure chamber of master cylinder MC, a third brake circuit (a return circuit) via which wheel-brake cylinder 5 and reservoir RES are connected to each other, and a third control valve (pressure-reduction control valve 8) disposed in the third brake circuit (the return circuit) for establishing and blocking fluid communication between wheel-brake cylinder 5 and reservoir RES. When a desired pressure-reduction speed Vp* of wheel-cylinder pressure Pw in wheel-brake cylinder 5 is greater than or equal to a predetermined speed value Vpo (i.e., Vp*≧Vpo), control unit CU is configured to control the first control valve (first pressure-buildup control valve 6) and the third control valve (pressure-reduction control valve 8) to their valve-open positions.

That is, when desired pressure-reduction speed Vp* is set to a high speed value (i.e., Vp*≧Vpo), a reduction of wheel-cylinder pressure Pw is achieved by first brake circuit 1 as well as the return circuit. Thus, it is possible to realize a higher pressure-reduction speed.

### Fifth Embodiment

### Hydraulic Circuit of Fifth Embodiment

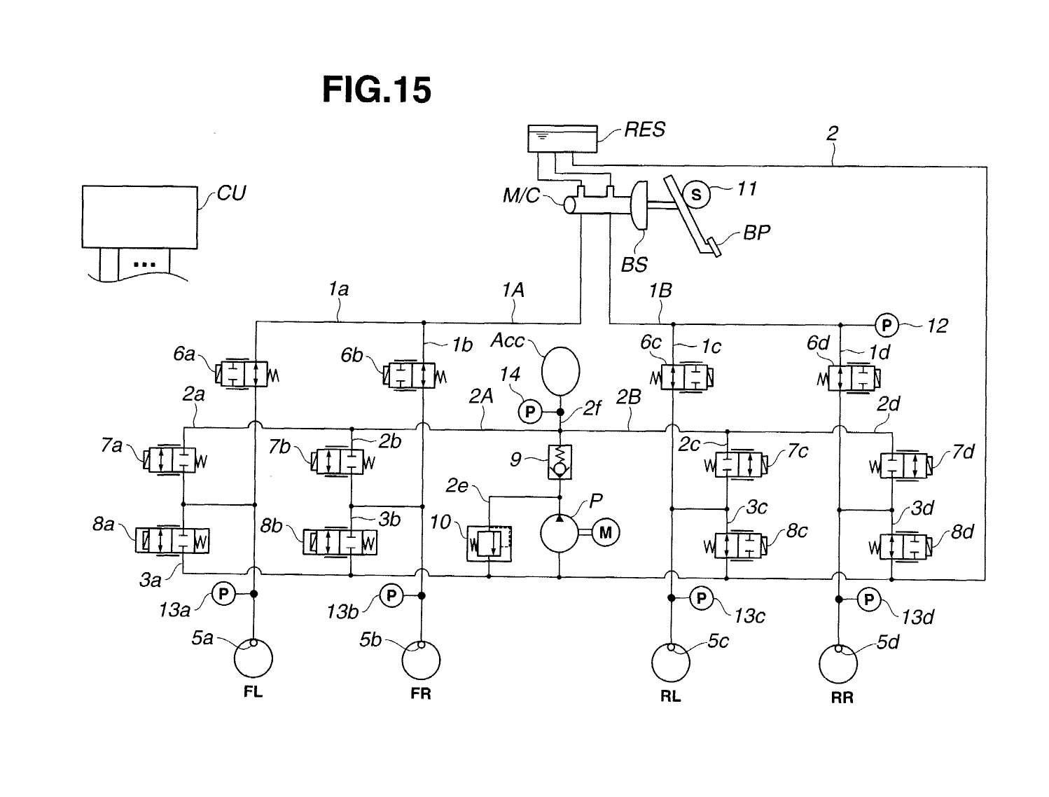

Referring now to FIG. 15, there is shown the hydraulic circuit of the brake control system of the fifth embodiment. The brake control system of the fifth embodiment differs from that of the first embodiment shown in FIG. 1, in that, in the fifth embodiment, a pressure accumulator ACC is further provided as an additional fluid-pressure source.

As seen from the hydraulic circuit of FIG. 15, a fluid line 2f is further connected to second brake circuit 2 (exactly, the branch point of branched circuits 2A-2B), downstream of check valve 9. Accumulator ACC is connected via fluid line 2f to second brake circuit 2. Accumulator ACC is a device that temporarily accumulates or stores high-pressure brake fluid supplied from pump P. An accumulator pressure sensor 14 is installed in fluid line 2f, for detecting the fluid pressure in accumulator ACC and generating a sensor signal indicative of the detected accumulator pressure to control unit CU.

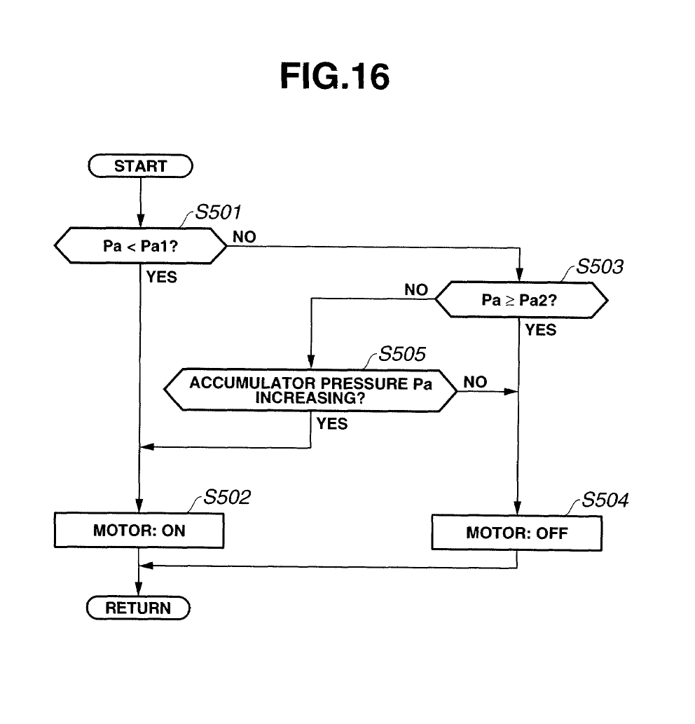

When high-pressure brake fluid is stored in accumulator ACC, the brake fluid can be supplied from accumulator ACC via second brake circuit 2 to wheel-brake cylinders 5a-5d with second pressure-buildup control valves 7a-7d, and whereby wheel-cylinder pressure Pw can be built up. That is, by pre-accumulating or pre-storing high-pressure brake fluid in accumulator ACC according to the pressure-accumulation control flow shown in FIG. 16 (described later), it is possible to easily realize a buildup of wheel-cylinder pressure Pw only by controlling second pressure-buildup control valves 7a-7d to their valve-open states. In the previously-described wheel-cylinder pressure control flow, executed by the system of the first embodiment (see FIGS. 7-11) or the system of the second embodiment (slightly differing from the first embodiment in that a direction of arrangement of each individual front-wheel side first pressure-buildup control valve 6a-6b and a direction of arrangement of each individual rear-wheel side first pressure-buildup control valve 6c-6d are reversed), or in the previously-described wheel-cylinder pressure control flow, executed by the system of the third embodiment, motor M must be energized to drive pump P for each pressure-buildup cycle. By the use of accumulator ACC (in the brake control system of the fifth embodiment shown in FIGS. 15-16), it is unnecessary to energize motor M to drive pump P for each pressure-buildup cycle.

Referring to FIG. 16, there is shown the pressure-accumulation control flow executed within control unit CU, incorporated in the system of the fifth embodiment, when storing high-pressure brake fluid in accumulator ACC by driving pump P. The pressure-accumulation control flow of FIG. 16 is executed as time-triggered interrupt routines to be triggered every predetermined sampling time intervals, under a specified condition where all the second pressure buildup control valves 7a-7d have been fully closed.

At step S501, a check is made to determine, based on accumulator pressure Pa detected by accumulator pressure sensor 14, whether accumulator pressure Pa is less than a predetermined lower limit (a predetermined lower accumulator-pressure threshold value) Pa1 (i.e., Pa<Pa1). When Pa<Pa1, the routine proceeds to step S502. Conversely when Pa≧Pa1, the routine proceeds to step S503. Predetermined lower limit Pa1 is set to a pressure value that accumulator pressure Pa, obtained after an accumulator-pressure drop, substantially corresponding to an amount of brake fluid supplied from accumulator ACC to wheel-brake cylinders 5a-5d for a buildup of wheel-cylinder pressure Pw, has occurred, becomes higher than a maximum value of the required wheel-cylinder pressure.

At step S502, motor M is energized (ON) to drive pump P, and thus brake fluid is sucked in from reservoir RES, and then the pressurized high-pressure brake fluid is supplied from pump P via check valve 9 and fluid line 2f to accumulator ACC. Accumulator ACC can store the high-pressure brake fluid. In this manner, one execution cycle of the pressure-accumulation control flow terminates.

At step S503, a check is made to determine, based on accumulator pressure Pa detected by accumulator pressure sensor 14, whether accumulator pressure Pa is greater than or equal to a predetermined upper limit (a predetermined upper accumulator-pressure threshold value) Pa2 (i.e., Pa≧Pa2). When Pa≧Pa2, the routine proceeds from step S503 to step S504. Conversely when Pa<Pa2, the routine proceeds from step S503 to step S505. Predetermined upper limit Pa2 is set to a pressure value below a withstand pressure of the hydraulic brake circuit shown in FIG. 15.

At step S504, motor M is de-energized (OFF) to stop operation of pump P, and whereby the supply of brake fluid to accumulator ACC stops. In this manner, one execution cycle of the control flow terminates.

At step S505, a check is made to determine, based on a deviation between the previous value Pa_{(old)} of accumulator pressure Pa and the current value Pa_{(new)} of accumulator pressure Pa, both detected by accumulator pressure sensor 14, whether accumulator pressure Pa is increasing. When accumulator pressure Pa is still increasing, the routine proceeds from step S505 to step S502. Conversely when accumulator pressure Pa is not increasing, the routine proceeds from step S505 to step S504.

By the execution of the previously-discussed pressure-accumulation control flow of FIG. 16, accumulator pressure Pa can be controlled to a certain pressure value Pac (Pa1≦Pac≦Pa2) ranging from predetermined lower limit Pa1 to predetermined upper limit Pa2.

Other wheel-cylinder pressure control flows (except for the addition of the pressure-accumulation control flow of FIG. 16), executed by the system of the fifth embodiment shown in FIG. 15 are identical to a modified control flow, which is slightly modified to delete the energization (ON) of motor M from the wheel-cylinder pressure-buildup step S104 of FIG. 7 (the first and second embodiments), a modified control flow, which is slightly modified to delete the energization (ON) of motor M from the wheel-cylinder pressure-buildup step S205 of FIG. 8 (the first and second embodiments), a modified control flow, which is slightly modified to delete the energization (ON) of motor M from the wheel-cylinder pressure-buildup step S306 of FIG. 11 (the first and second embodiments), and a modified control flow, which is slightly modified to delete the energization (ON) of motor M from the wheel-cylinder pressure-buildup step S306 of FIG. 12 (the third embodiment).

### Effects of Fifth Embodiment

(13) As a fluid-pressure source, an apparatus for controlling brakes (a brake control system), made according to the fifth embodiment, includes pump P and accumulator ACC, which stores high-pressure brake fluid, produced by operation of pump P.

With the hydraulic system configuration having accumulator ACC as well as pump P, as the fluid-pressure source, when high-pressure brake fluid is stored in accumulator ACC, the brake fluid can be supplied from accumulator ACC via second brake circuit 2 to wheel-brake cylinders 5a-5d by opening second pressure-buildup control valves 7a-7d, and whereby wheel-cylinder pressure Pw can be built up. That is, by pre-accumulating or pre-storing high-pressure brake fluid in accumulator ACC, it is possible to easily realize a buildup of wheel-cylinder pressure Pw only by controlling second pressure-buildup control valves 7a-7d to their valve-open states. By the use of accumulator ACC, it is unnecessary to energize motor M to drive pump P for each pressure-buildup cycle. Additionally, at a pressure buildup mode (during VDC control, during ABS control, or during BA control), by the use of high-pressure brake fluid stored in accumulator ACC, it is possible to achieve the buildup of wheel-cylinder pressure Pw at a fast pressure-buildup speed.

### Sixth Embodiment

### Hydraulic Circuit of Sixth Embodiment

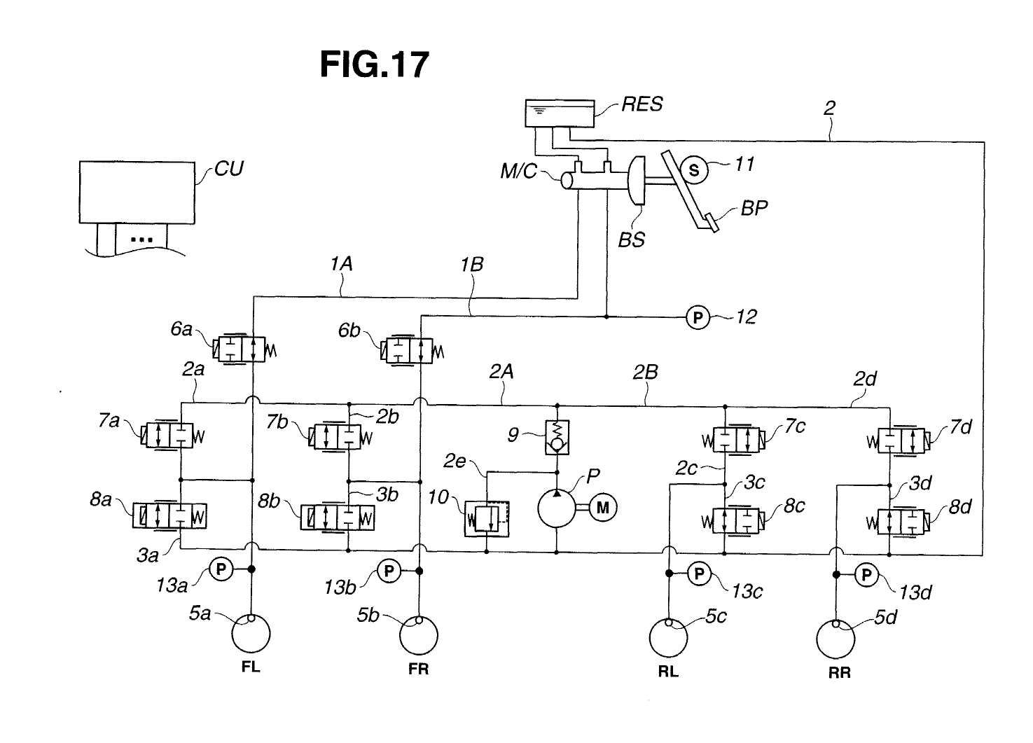

Referring now to FIG. 17, there is shown the hydraulic circuit of the brake control system of the sixth embodiment. The brake control system of the sixth embodiment differs from that of the first embodiment shown in FIG. 1, in that, in the sixth embodiment, first brake circuit 1 and first pressure-buildup control valve 6 are provided only for the front-wheel side (front-left and front-right road wheels FL-FR).

As seen from the hydraulic circuit of FIG. 17, branched circuit 1A of first brake circuit 1, connected to the first fluid-pressure chamber (the first apply pressure chamber) of master cylinder MC, is connected via first pressure-buildup control valve 6a to front-left wheel-brake cylinder 5a. The branched circuit 1A of first brake circuit 1 corresponds to fluid line 1a of the system of the first embodiment. In a similar manner, branched circuit 1B of first brake circuit 1, connected to the second fluid-pressure chamber (the second apply pressure chamber) of master cylinder MC, is connected via first pressure-buildup control valve 6b to front-right wheel-brake cylinder 5b. The branched circuit 1B of first brake circuit 1 corresponds to fluid line 1b of the system of the first embodiment. In the sixth embodiment, first brake circuit 1 and first pressure-buildup control valve 6 are not connected to rear wheel-brake cylinders 5c-5d. Only the second brake circuit 2 is connected to rear wheel-brake cylinders 5c-5d. The other hydraulic system configuration of the sixth embodiment of FIG. 17 is identical to the first embodiment shown in FIG. 1.

With the previously-discussed hydraulic system configuration of the sixth embodiment, the brake control system enables the selection of either first brake circuit 1 or second brake circuit 2, only for the front-wheel side (front road wheels FL-FR). On the other hand, regarding the rear-wheel side (rear road wheels RL-RR), a buildup of wheel-cylinder pressure Pw of each rear wheel-brake cylinder 5c-5d is achieved by only the second brake circuit 2. That is, regarding the rear wheel side (rear road wheels RL-RR), each individual rear wheel-brake cylinder 5c-5d is mechanically disconnected from brake pedal BP, to which a driver's leg power is inputted, and a brake-fluid pressure, substantially corresponding to a driver's braking operation (i.e., a driver's brake-pedal depression), can be produced by electronically controlling actuators (e.g., pump P, second pressure-buildup control valve 7, and pressure-reduction control valve 8), so as to provide a so-called brake-by-wire control system (an electrically-operated hydraulic brake system) for the rear-wheel side. In the same manner as the system of the first embodiment of FIG. 1, the system of the sixth embodiment of FIG. 17 ensures a reaction (a push-back force) of brake pedal BP, in other words, a proper brake-pedal feel.

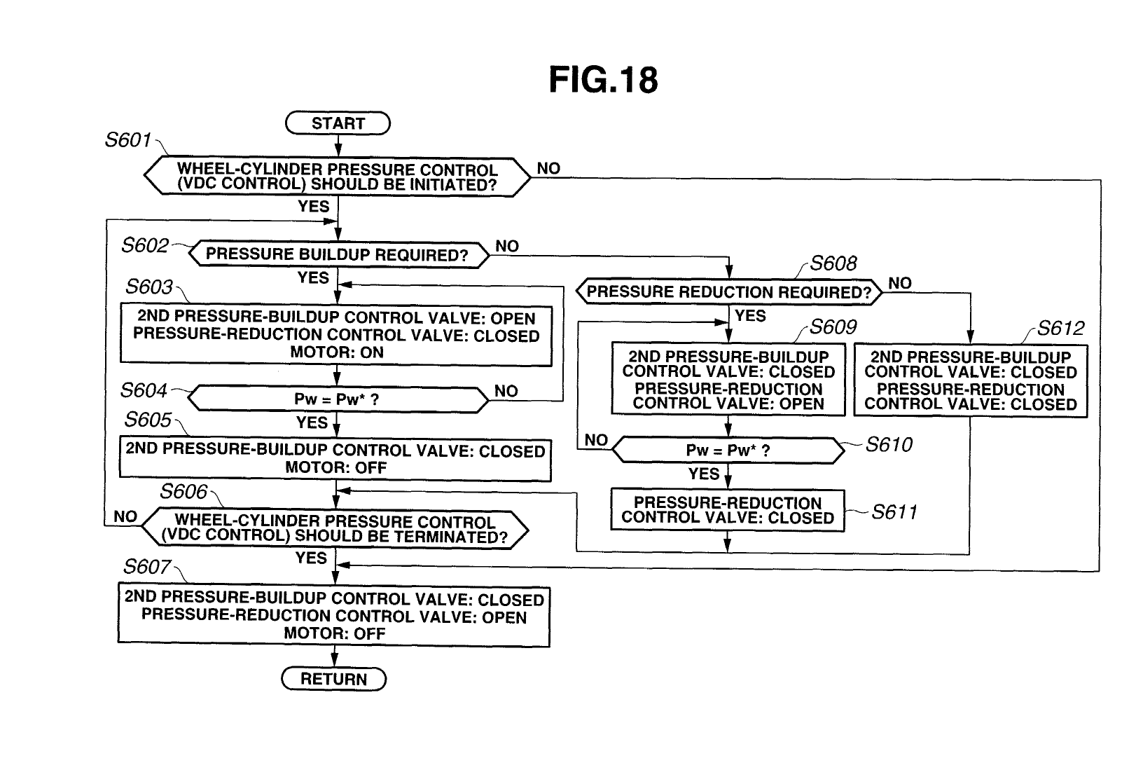

Referring now to FIG. 18, there is shown the flowchart concerning the rear-wheel-side wheel-cylinder pressure control routine executed by control unit CU, incorporated in the system of the sixth embodiment shown in FIG. 17, during VDC control (see steps S601-S612), and containing the procedure at the normal brake mode (see the flow jumped from step S601 to step S607).

At step S601, a check for execution (initiation) of wheel-cylinder pressure control is made, based on the calculation results of vehicle-required braking force calculation section 102 and target wheel-cylinder pressure calculation section 103, for every rear wheel-brake cylinder 5c-5d. When it is determined that at least one of rear wheel-cylinder pressures PWRL-PWRR of the rear road wheels should be controlled, target rear wheel-cylinder pressures PWRL*-PWRR* are inputted and then automatic fluid-pressure control (wheel-cylinder pressure control), based on the inputted target wheel-cylinder pressures, is initiated. Thereafter, the routine proceeds from step S601 to step S602. Conversely when it is determined that none of rear wheel-cylinder pressures PWRL-PWRR should be controlled, the routine proceeds from step S601 to step S607, so as to execute a normal brake mode (described later).

In a similar manner to step S103, at step S602, a check is made to determine, based on a deviation between the calculated target wheel-cylinder pressure Pw* (a VDC command wheel-cylinder pressure) and the detected wheel-cylinder pressure Pw (the actual wheel-cylinder pressure), whether wheel-cylinder pressure Pw of the VDC controlled wheel should be built up. When the answer to step S602 is affirmative (YES), that is, when a buildup of wheel-cylinder pressure Pw of the VDC controlled wheel is required, the routine proceeds from step S602 to step S603. Conversely when the answer to step S602 is negative (NO), that is, when a buildup of wheel-cylinder pressure Pw of the VDC controlled wheel is not required, the routine proceeds from step S602 to step S608.

At step S603, second pressure-buildup control valve 7, associated with the VDC controlled wheel, is activated (ON) and kept open, so as to permit brake-fluid flow through second brake circuit 2 (i.e., either one of fluid lines 2c-2d, associated with the VDC controlled wheel). On the other hand, pressure-reduction control valve 8, associated with the VDC controlled wheel, is kept closed. Additionally, motor M is energized to drive pump P. As a result, the pump pressure (a discharge pressure generated from pump P) is supplied through second pressure-buildup control valve 7, associated with the VDC controlled wheel, that is, via second brake circuit 2 to wheel-brake cylinder 5 of the VDC controlled wheel. In this manner, a buildup of wheel-cylinder pressure Pw of the VDC controlled wheel is achieved by the pump pressure. Thereafter, the routine proceeds from step S603 to step S604.

At step S604, a check is made to determine, based on the actual wheel-cylinder pressure detected by wheel-cylinder pressure sensor 13 associated with the VDC controlled wheel, whether wheel-cylinder pressure Pw of the VDC controlled wheel reaches its target wheel-cylinder pressure Pw*. When target wheel-cylinder pressure Pw* has been reached, the routine proceeds from step S604 to step S605. Conversely when target wheel-cylinder pressure Pw* has not been reached, the routine returns from step S604 to step S603, so as to repeatedly execute a buildup of wheel-cylinder pressure Pw of the VDC controlled wheel.

At step S605, second pressure-buildup control valve 7, associated with the VDC controlled wheel, is deactivated (OFF) and kept closed, so as to cut off second brake circuit 2 (i.e., either one of fluid lines 2c-2d, associated with the VDC controlled wheel). Additionally, motor M is de-energized (OFF) to stop operation of pump P, thereby terminating a wheel-cylinder pressure buildup mode based on the pump pressure. Thereafter, step S606 occurs.

At step S606, a check is made to determine, based on the calculation results vehicle-required braking force calculation section 102 and target wheel-cylinder pressure calculation section 103, whether wheel-cylinder pressure Pw of the VDC controlled wheel should be repeatedly controlled or regulated. When it is determined that wheel-cylinder pressure control of the VDC controlled wheel should be repeatedly executed, target rear wheel-cylinder pressures PWRL*-PWRR* are inputted and then the routine returns to step S602 so as to repeatedly execute automatic fluid-pressure control (wheel-cylinder pressure control) for the VDC controlled wheel. Conversely when it is determined that wheel-cylinder pressure control of the VDC controlled wheel should not be repeatedly executed and thus the VDC control should be terminated, the routine proceeds from step S606 to step S607.

At step S607, regarding the VDC controlled wheel, proceeding to a termination of VDC control, or regarding the VDC noncontrolled wheel, which is not operated at the VDC control brake mode, second pressure-buildup control valve 7 is deactivated (OFF) and kept closed, and pressure-reduction control valve 8 is kept closed. At the same time, motor M is de-energized (OFF) to stop operation of pump P. Thus, second brake circuit 2 (i.e., either one of fluid lines 1c-1d, associated with the VDC controlled wheel, proceeding to a termination of VDC control or the remaining fluid line associated with the VDC noncontrolled wheel, which is not operated at the VDC control brake mode) is blocked, so as to establish fluid communication between reservoir RES and either one of wheel-brake cylinders 5c-5d, associated with the VDC controlled wheel, thereby permitting the wheel-cylinder pressure to be relieved or escaped to reservoir RES. In this manner, the VDC control flow for the rear-wheel side terminates.

In a similar manner to step S109, at step S608, a check is made to determine, based on a deviation between the calculated target wheel-cylinder pressure Pw* (a VDC command wheel-cylinder pressure) and the detected wheel-cylinder pressure Pw (the actual wheel-cylinder pressure), whether wheel-cylinder pressure Pw of the VDC controlled wheel should be reduced. When the answer to step S608 is affirmative (YES), that is, when a reduction of wheel-cylinder pressure Pw of the VDC controlled wheel is required, the routine proceeds from step S608 to step S609. Conversely when the answer to step S608 is negative (NO), that is, when a reduction of wheel-cylinder pressure Pw of the VDC controlled wheel is not required, the routine proceeds from step S608 to step S612.

At step S609, second pressure-buildup control valve 7, associated with the VDC controlled wheel, is deactivated (OFF) and kept closed, so as to block (cut off) second brake circuit 2 (i.e., either one of fluid lines 2c-2d, associated with the VDC controlled wheel). On the other hand, pressure-reduction control valve 8, associated with the VDC controlled wheel, is kept open, so as to establish fluid communication between reservoir RES and either one of wheel-brake cylinders 5c-5d, associated with the VDC controlled wheel, thereby permitting the wheel-cylinder pressure to be relieved or escaped to reservoir RES. In this manner, a reduction of wheel-cylinder pressure Pw of the VDC controlled wheel is achieved. Thereafter, the routine proceeds from step S609 to step S610.

At step S610, a check is made to determine, based on the actual wheel-cylinder pressure detected by wheel-cylinder pressure sensor 13 associated with the VDC controlled wheel, whether wheel-cylinder pressure Pw of the VDC controlled wheel reaches its target wheel-cylinder pressure Pw*. When target wheel-cylinder pressure Pw* has been reached, the routine proceeds from step S610 to step S611. Conversely when target wheel-cylinder pressure Pw* has not been reached, the routine returns from step S610 to step S609, so as to repeatedly execute a reduction of wheel-cylinder pressure Pw of the VDC controlled wheel.

At step S611, pressure-reduction control valve 8, associated with the VDC controlled wheel, is kept closed, so as to block fluid communication between reservoir RES and either one of wheel-brake cylinders 5c-5d, associated with the VDC controlled wheel, thereby terminating a wheel-cylinder pressure reduction mode. Thereafter, the routine proceeds from step S611 to step S606.

In a similar manner to step S113, at step S612, a pressure hold mode for the VDC controlled wheel is executed. Concretely, second pressure-buildup control valve 7, associated with the VDC controlled wheel, is deactivated (OFF) and kept closed, so as to cut off second brake circuit 2 (i.e., either one of fluid lines 2c-2d, associated with the VDC controlled wheel). Additionally, pressure-reduction control valve 8, associated with the VDC controlled wheel, is kept closed, so as to block fluid communication between reservoir RES and either one of wheel-brake cylinders 5c-5d, associated with the VDC controlled wheel. Under these conditions, brake fluid in wheel-brake cylinder 5 of the VDC controlled wheel, is sealed in by means of second pressure-buildup control valve 7 and pressure-reduction control valve 8, all associated with the VDC controlled wheel and fully closed, and thus wheel-cylinder pressure Pw of the VDC controlled wheel remains unchanged. Thereafter, the routine proceeds from step S612 to step S606.

As appreciated from comparison between (i) the wheel-cylinder pressure control routine of FIG. 7 executed by the system of the first embodiment shown in FIG. 1 during VDC control and (ii) the rear-wheel-side wheel-cylinder pressure control routine of FIG. 18 executed by the system of the sixth embodiment shown in FIG. 17 during VDC control, the rear-wheel-side wheel-cylinder pressure control routine (see the rear-wheel-side VDC control flow of FIG. 18) of the system of the sixth embodiment, is identical to a modified control flow, which is slightly modified to delete (i) the step S102 of FIG. 7 concerned with first pressure-buildup control valve 6 and (ii) the activation (ON=valve-closing) of first pressure-buildup control valve 6 in the actuator control step S108 of FIG. 7. Likewise, the rear-wheel-side ABS control flow, executed by the system of the sixth embodiment, is identical to a modified control flow, which is slightly modified to delete (i) the step S203 of FIG. 8 concerned with first pressure-buildup control valve 6, (ii) the deactivation (OFF=valve-opening) of first pressure-buildup control valve 6 in the actuator control steps S216 (see FIG. 9) and S225 (see FIG. 10), (iii) the step S218 of FIG. 9 concerned with first pressure-buildup control valve 6, and (iv) the activation (ON=valve-closing) of first pressure-buildup control valve 6 in the actuator control steps S211 and S224 of FIG. 9. In a similar manner, the rear-wheel-side BA control flow, executed by the system of the sixth embodiment, is identical to a modified control flow, which is slightly modified to delete (i) the deactivation (OFF=valve-opening) of first pressure-buildup control valve 6 in the actuator control step S302 of FIG. 11 and (ii) the step S304 of FIG. 11 concerned with first pressure-buildup control valve 6.

Regarding wheel-cylinder pressure control for the front-wheel side (front road wheels FL-FR), control actions, executed by the systems of the first (see FIG. 1) and sixth (see FIG. 17) embodiments are the same. Therefore, detailed description of front wheel-brake cylinder pressure control, executed by the system of the sixth embodiment, will be omitted because the above description thereon seems to be self-explanatory.

### Effects of Sixth Embodiment

(14) An apparatus for controlling brakes (a brake control system), made according to the sixth embodiment, includes master cylinder MC, wheel-brake cylinder 5, brake booster BS configured to actuate master cylinder MC for a pressure increase of brake fluid in master cylinder MC, first brake circuit 1 configured to supply brake fluid, which is pressure-increased by brake booster BS, to wheel-brake cylinder 5, a fluid-pressure source (i.e., pump P) provided for a pressure increase of brake fluid, separately from brake booster BS, second brake circuit 2 arranged in parallel with first brake circuit 1 and configured to supply brake fluid, which is pressure-increased by the fluid-pressure source (i.e., pump P), to wheel-brake cylinder 5, a manipulated variable detector (i.e., stroke sensor 11) configured to detect a manipulated variable (i.e., a brake-pedal stroke SBP) of brake pedal BP, and control unit CU configured to select either one of a pressure buildup achieved by first brake circuit 1 and a pressure buildup achieved by second brake circuit 2. During the pressure buildup achieved by second brake circuit 2 (i.e., fluid lines 2c-2d), control unit CU executes brake-by-wire (BBW) control that automatically pressurizes brake fluid in wheel-brake cylinder 5 (i.e., rear wheel-brake cylinders 5c-5d) responsively to the detected manipulated variable (brake-pedal stroke SBP).

In other words, the system of the sixth embodiment can be regarded as a specified case where, in the brake control method of the first embodiment (see the item (9)), brake-by-wire control is executed in a manner so as to automatically pressurize brake fluid in rear wheel-brake cylinders 5c-5d responsively to the detected manipulated variable (brake-pedal stroke SBP) during a pressure buildup achieved by only the second brake circuit 2 (fluid lines 2c-2d).

Therefore, by way of the selection of either a pressure buildup achieved by first brake circuit 1 or a pressure buildup achieved by second brake circuit 2, the system of the sixth embodiment can provide the same effects as the item (1). Regarding the rear-wheel side (rear road wheels RL-RR), even during the normal brake mode, wheel-cylinder pressures PWRL-PWRR in rear wheel-brake cylinders 5c-5d are automatically controlled through second brake circuit 2 (i.e., fluid lines 2c-2d). As discussed above, wheel-cylinder pressures PWRL-PWRR of the rear-wheel side (rear wheel-brake cylinders 5c-5d) can be built up by only the second brake circuit 2. That is, the rear wheel-brake cylinder pressures can be automatically controlled, regardless of master-cylinder pressure Pm. Thus, it is possible to increase the degree of freedom of wheel-cylinder pressure control, while ensuring the high brake system's responsiveness.

The system of the sixth embodiment is exemplified in brake-by-wire control, which is executed in a manner so as to automatically pressurize brake fluid in rear wheel-brake cylinders 5c-5d responsively to the detected manipulated variable (brake-pedal stroke SBP) during a pressure buildup achieved by only the second brake circuit 2 (fluid lines 2c-2d). Such brake-by-wire control may be made to the front-wheel side (front road wheels FL-FR), as follows.

For instance, when the detected manipulated variable (brake-pedal stroke SBP) is greater than or equal to predetermined threshold value So (i.e., SBP≧So), wheel-cylinder pressures PWFL-PWFR of the front-wheel side (front wheel-brake cylinders 5a-5b) are built up by only the second brake circuit 2 (fluid lines 2a-2b). Conversely when the detected manipulated variable is less than predetermined threshold value So (i.e., SBP<So), wheel-cylinder pressures PWFL-PWFR of the front-wheel side are built up by only the first brake circuit 1 (fluid lines 1a-1b). With this modified arrangement, it is possible to provide the same effects as the items (8) and (11).

(15) First brake circuit 1 is provided only for the front-wheel brake system that builds up wheel-cylinder pressures PWFL-PWFR in front wheel-brake cylinders 5a-5b of the automotive vehicle. In other words, first brake circuit 1 is not provided for the rear-wheel brake system that builds up wheel-cylinder pressures PWRL-PWRR in rear wheel-brake cylinders 5c-5d.

Therefore, during the normal brake mode, first brake circuit 1 is communicated with the front-wheel side (front road wheels FL-FR) in a manner so as to supply master-cylinder pressure Pm via first pressure-buildup control valves 6a-6b (branched circuits 1A-1B of first brake circuit 1) to wheel-brake cylinders 5a-5b. That is, wheel-cylinder pressures PWFL-PWFR of the front-wheel side are built up by the driver's braking operation. On the other hand, regarding the rear-wheel side (rear road wheels RL-RR), only the second brake circuit 2 is communicated with rear wheel-brake cylinders 5c-5d, in a manner so as to supply pump pressure via second pressure-buildup control valves 7c-7d (fluid lines 2c-2d) to rear wheel-brake cylinders 5c-5d. That is, wheel-cylinder pressures PWRL-PWRR of the rear-wheel side are built up by operation of pump P. As set forth above, master-cylinder pressure Pm is applied to only the front-wheel side (exactly, front wheel-brake cylinders 5a-5b). In the system of the sixth embodiment, because of no brake-fluid supply from master cylinder MC to rear wheel-brake cylinders 5c-5d, the amount of brake fluid, supplied from master cylinder MC to wheel-brake cylinder 5, can be reduced as compared to the first embodiment. Because of such a reduced amount of brake fluid supplied from master cylinder MC, the system of the sixth embodiment can reduce a required stroke of brake pedal BP operated by the driver. This enhances an operability for the brakes, especially, an operability for brake pedal BP operated by the driver.

Additionally, because of the previously-discussed reduced amount of brake fluid supplied from master cylinder MC, master cylinder MC can be downsized, and thus brake booster BS can be downsized. The compact and lighter master-cylinder and booster unit can provide easier installation (enhanced mountability) on the vehicle, and expanded design flexibility, and smaller space requirements of overall brake system.

The systems of the shown embodiments use a vacuum booster, which is linked to a brake-pedal pushrod for amplifying a force transmitted through brake pedal BP, utilizing a vacuum from a source of vacuum, as brake booster BS. Thus, instead of reducing the size of brake booster BS by the previously-discussed reduced amount of brake fluid supplied from master cylinder MC, it is possible to lower the vacuum applied to brake booster BS. It is possible to satisfactorily ensure a required value of wheel-cylinder pressure Pw, even on internal combustion engines, in which the vacuum (below atmospheric pressure) generated from the vacuum source (e.g., an engine intake manifold) is little.

Further, the system of the sixth embodiment is exemplified in rear-wheel-side brake-by-wire control according to which wheel-cylinder pressures PWRL-PWRR of the rear-wheel side (rear wheel-brake cylinders 5c-5d) can be built up by only the second brake circuit 2. In lieu thereof, as a modification, wheel-cylinder pressures PWFL-PWFR of the front-wheel side (front wheel-brake cylinders 5a-5b) can be built up by only the second brake circuit 2. The modification can provide the same operation and effects as discussed above.

### Seventh Embodiment

### Hydraulic Circuit of Seventh Embodiment

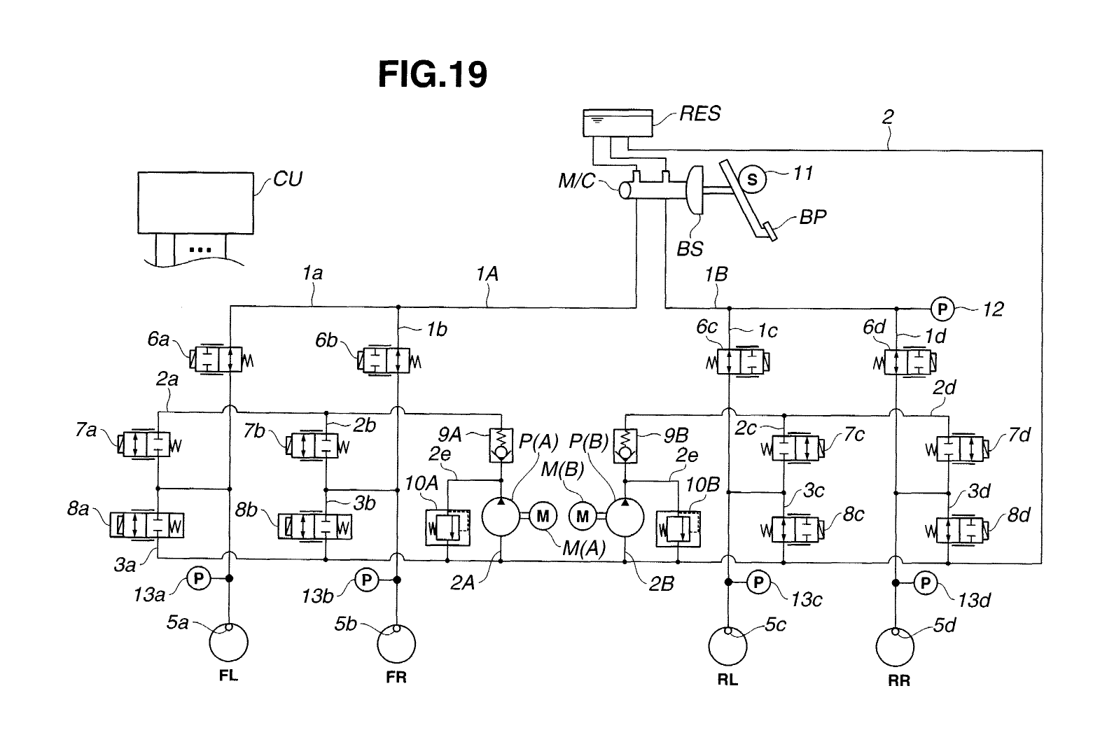

Referring now to FIG. 19, there is shown the hydraulic circuit of the brake control system of the seventh embodiment. The hydraulic circuit of the brake control system of the seventh embodiment shown in FIG. 19 is somewhat different from that of the first embodiment shown in FIG. 1, for the reasons discussed below.

Regarding the hydraulic circuit of the system of the first embodiment (see FIG. 1), check valve 9, pump P, motor M, and relief valve 10 are common to the front-wheel side (front road wheels FL-FR) and the rear-wheel side (rear road wheels RL-RR). Regarding the hydraulic circuit of the system of the seventh embodiment (see FIG. 19), a check valve 9A, a pump P(A), a motor M(A), and a relief valve 10A are provided for the front-wheel side (front wheel-brake cylinders 5a-5b), whereas a check valve 9B, a pump P(B), a motor M(B), and a relief valve 10B are provided for the rear-wheel side (rear wheel-brake cylinders 5c-5d). The other configuration of the hydraulic circuit of the system of the seventh embodiment shown in FIG. 19 is identical to the first embodiment shown in FIG. 1. Thus, the same reference signs used to designate elements in the system of the seventh embodiment shown in FIG. 19 will be applied to the corresponding reference signs used in the system of the first embodiment shown in FIG. 1, for the purpose of comparison of the first and seventh embodiments. Check valve 9A, pump P(A), motor M(A), and relief valve 10A for the front-wheel side, and check valve 9B, pump P(B), motor M(B), and relief valve 10B for the rear-wheel side will be hereinafter described with reference to the accompanying drawings, while detailed description of other elements will be omitted because the above description thereon seems to be self-explanatory.

As can be seen from the hydraulic circuit of FIG. 19, the downstream side of second brake circuit 2 is branched into two branched circuits 2A and 2B. Pump P(A), which is driven by motor M(A), is connected to the downstream side of branched circuit 2A of second brake circuit 2. Pump P(A) sucks brake fluid from reservoir RES, and thus the brake fluid introduced into the pump inlet port is pressurized. The pressurized high-pressure brake fluid is supplied into the more downstream side of branched circuit 2A (i.e., toward second pressure-buildup control valves 7a-7b). Check valve (a one-way directional control valve) 9A is provided in the portion of branched circuit 2A downstream of the pump outlet port, to permit free flow in one direction and to prevent any backflow in the opposite direction (any backflow from the downstream side back to the upstream side). Branched circuit 2A of second brake circuit 2 is further branched into two fluid lines 2a and 2b, downstream of check valve 9A. The downstream ends of fluid lines 2a-2b are connected to respective front wheel-brake cylinders 5a-5b. Second pressure-buildup control valves 7a-7b are disposed in respective fluid lines 2a-2b.

One end of left-hand side relief fluid line 2e is connected to the portion of branched circuit 2A of second brake circuit 2 between pump P(A) and check valve 9A. The other end of left-hand side relief fluid line 2e is connected to the fluid line communicating with reservoir RES, that is, the portion of second brake circuit 2 upstream of pump P(A), or either one of the portions of fluid lines 3a-3d communicating the respective upstream sides of pressure-reduction control valves 8a-8d. Thus, left-hand side relief fluid line 2e is connected through fluid lines 3a-3d and branched circuit 2A to reservoir RES. Pressure relief valve 10A is disposed in left-hand side relief fluid line 2e. The configurations of hydraulic circuits related to check valves 9A-9B, pumps P(A)-P(B), motors M(A)-M(B), and left and right relief valves 10A-10B are the same in the front-wheel side branched circuit 2A and the rear-wheel side branched circuit 2B. Thus, detailed description of check valve 9B, pump P(B), motor M(B), and relief valve 10B for the rear-wheel side will be omitted.

The automatic brake control flow (i.e., VDC control flow, ABS control flow, BA control flow), executed within control unit CU of the system of the seventh embodiment (see FIG. 19), is similar to that of the first embodiment (see FIG. 1), except the following point.

When building up wheel-cylinder pressures PWFL-PWFR in front wheel-brake cylinders 5a-5b, motor M(A) is energized (ON) to drive pump P(A). When building up wheel-cylinder pressures PWRL-PWRR in rear wheel-brake cylinders 5c-5d, motor M(B) is energized (ON) to drive pump P(B).

### Effects of Seventh Embodiment

(16) As a fluid-pressure source, an apparatus for controlling brakes (a brake control system), made according to the seventh embodiment, includes pump P, which is driven by electric motor M. Pump P(A) for the front-wheel side (front wheel-brake cylinders 5a-5b) of the vehicle and pump P(B) for the rear-wheel side (rear wheel-brake cylinders 5c-5d) of the vehicle are provided independently of each other. Thus, pump P(A) and motor M(A), suited to a load capacity of front wheel-brake cylinders 5a-5b and pump P(B) and motor M(B), suited to a load capacity of rear wheel-brake cylinders 5c-5d can be designed or set independently of each other. Therefore, each of pump P(A) and motor M(A) for the front-wheel side and pump P(B) and motor M(B) for the rear-wheel side, employed in the system of the seventh embodiment, can be downsized, as compared to each of pump P and motor M employed in the system of the first embodiment. For the reasons discussed above, when executing either wheel-cylinder pressure control of only the front-wheel side or wheel-cylinder pressure control of only the rear-wheel side, the system of the seventh embodiment enables a reduction in electric power consumption (consumed electric current), as compared to the system of the first embodiment. Additionally, in the system of the first embodiment, four wheel-cylinder pressures PWFL-PWRR in wheel-brake cylinders 5a-5d must be automatically controlled by means of the single pump P and the single motor M. In contrast, the system of the seventh embodiment has only to control two wheel-cylinder pressures (e.g., two front wheel-cylinder pressures PWFL-PWFR in wheel-brake cylinders 5a-5b) by means of one pump (e.g., the front-wheel side pump P(A)) and one motor (e.g., the front-wheel side motor M(A)). Thus, it is possible to enhance both the pressure-buildup responsiveness and the control accuracy during wheel-cylinder pressure control.

### Eighth Embodiment

### Hydraulic Circuit of Eighth Embodiment

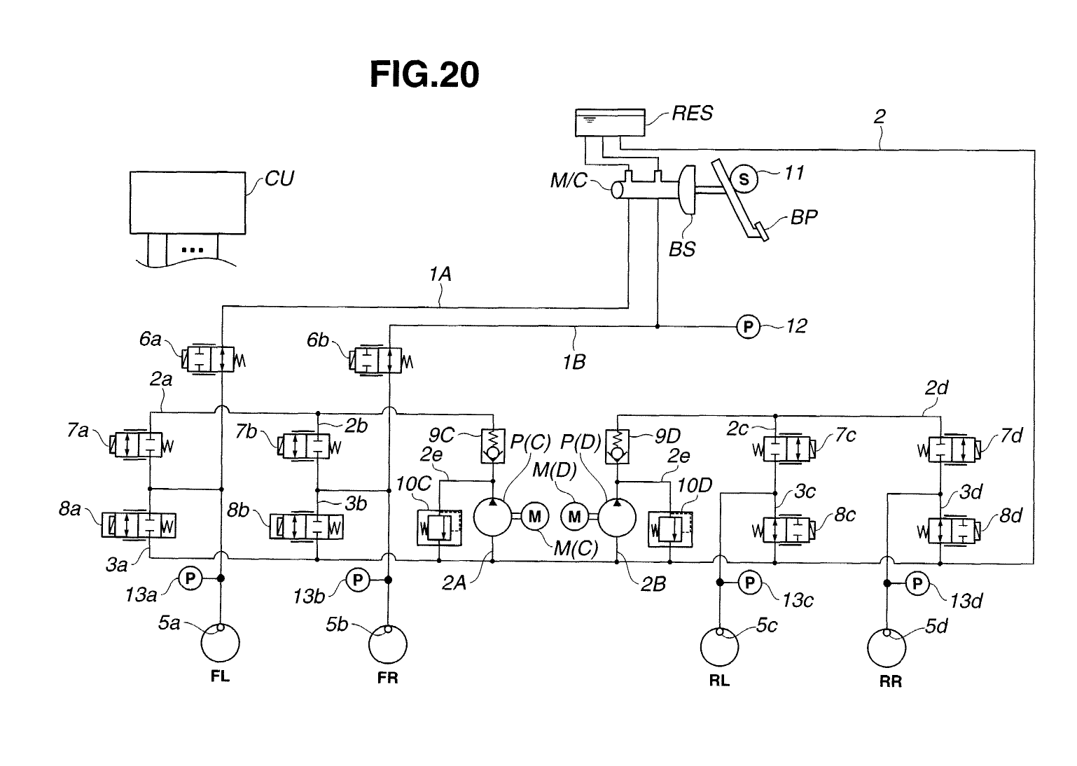

Referring now to FIG. 20, there is shown the hydraulic circuit of the brake control system of the eighth embodiment. The hydraulic circuit of the brake control system of the eighth embodiment shown in FIG. 20 is somewhat different from that of the sixth embodiment shown in FIG. 17, for the reasons discussed below.

Regarding the hydraulic circuit of the system of the sixth embodiment (see FIG. 17), check valve 9, pump P, motor M, and relief valve 10 are common to the front-wheel side (front road wheels FL-FR) and the rear-wheel side (rear road wheels RL-RR). Regarding the hydraulic circuit of the system of the eighth embodiment (see FIG. 20), a check valve 9C, a pump P(C), a motor M(C), and a relief valve 10C are provided for the front-wheel side (front wheel-brake cylinders 5a-5b), whereas a check valve 9D, a pump P(D), a motor M(D), and a relief valve 10D are provided for the rear-wheel side (rear wheel-brake cylinders 5c-5d). The other configuration of the hydraulic circuit of the system of the eighth embodiment shown in FIG. 20 is identical to the sixth embodiment shown in FIG. 17. Thus, the same reference signs used to designate elements in the system of the eighth embodiment shown in FIG. 20 will be applied to the corresponding reference signs used in the system of the sixth embodiment shown in FIG. 17, for the purpose of comparison of the sixth and eighth embodiments. Check valve 9C, pump P(C), motor M(C), and relief valve 10C for the front-wheel side, and check valve 9D, pump P(D), motor M(D), and relief valve 10D for the rear-wheel side will be hereinafter described with reference to the accompanying drawings, while detailed description of other elements will be omitted because the above description thereon seems to be self-explanatory.

In other words, as can be seen from comparison between the two hydraulic circuits shown in FIGS. 19-20, the system of the eighth embodiment (see FIG. 20) differs from that of the seventh embodiment (see FIG. 19), in that, in the eighth embodiment, first brake circuit 1 and first pressure-buildup control valve 6 are provided only for the front-wheel side (front-left and front-right road wheels FL-FR).

As can be seen from the hydraulic circuit of FIG. 20, the first group of pump P(C), motor M(C), and check valve 9C for the front-wheel side is provided in branched circuit 2A of second brake circuit 2, whereas the second group of pump P(D), motor M(D), and check valve 9D for the rear-wheel side is provided in branched circuit 2B of second brake circuit 2. One end of left-hand side relief fluid line 2e is connected to the portion of branched circuit 2A between pump P(C) and check valve 9C. The other end of left-hand side relief fluid line 2e is connected to the fluid line communicating with reservoir RES. In a similar manner, one end of right-hand side relief fluid line 2e is connected to the portion of branched circuit 2B between pump P(D) and check valve 9D. The other end of right-hand side relief fluid line 2e is connected to the fluid line communicating with reservoir RES. Pressure relief valve 10C is disposed in left-hand side relief fluid line 2e, whereas pressure relief valve 10D is disposed in right-hand side relief fluid line 2e. The other configuration of the hydraulic circuit of the system of the eighth embodiment shown in FIG. 20 is identical to the sixth embodiment shown in FIG. 17.

The automatic brake control flow (i.e., VDC control flow, ABS control flow, BA control flow), executed within control unit CU of the system of the eighth embodiment (see FIG. 20), is similar to that of the sixth embodiment (see FIG. 17), except the following point.

When building up wheel-cylinder pressures PWFL-PWFR in front wheel-brake cylinders 5a-5b, motor M(C) is energized (ON) to drive pump P(C). When building up wheel-cylinder pressures PWRL-PWRR in rear wheel-brake cylinders 5c-5d, motor M(D) is energized (ON) to drive pump P(D).

### Effects of Eighth Embodiment

(17) First brake circuit 1 is provided only for the front-wheel brake system that builds up wheel-cylinder pressures PWFL-PWFR in front wheel-brake cylinders 5a-5b of the automotive vehicle. As a fluid-pressure source, an apparatus for controlling brakes (a brake control system), made according to the eighth embodiment, includes pump P, which is driven by electric motor M. Pump P(C) for the front-wheel side (front wheel-brake cylinders 5a-5b) and pump P(D) for the rear-wheel side (rear wheel-brake cylinders 5c-5d) are provided independently of each other. Therefore, the system of the eighth embodiment (FIG. 20) can provide the same effects as the sixth embodiment (see FIG. 17). Additionally, it is possible to set or design (i) pump P(C) and motor M(C), suited to a load capacity of front wheel-brake cylinders 5a-5b and (ii) pump P(D) and motor M(D), suited to a load capacity of rear wheel-brake cylinders 5c-5d, independently of each other. Therefore, each of pump P(C) and motor M(C) for the front-wheel side and pump P(D) and motor M(D) for the rear-wheel side, employed in the system of the eighth embodiment, can be downsized, as compared to each of pump P and motor M employed in the system of the sixth embodiment. For the reasons discussed above, when executing either wheel-cylinder pressure control of only the front-wheel side or wheel-cylinder pressure control of only the rear-wheel side, the system of the eighth embodiment enables a reduction in electric power consumption (consumed electric current), as compared to the system of the sixth embodiment.

Regarding the front-wheel side (front road wheels FL-FR), in particular, during the normal brake mode, fluid communication between first brake circuit 1 (branched circuits 1A-1B) and front wheel-brake cylinders 5a-5b is established, such that master-cylinder pressure Pm is supplied via first pressure-buildup control valves 6a-6b (branched circuits 1A-1B) to wheel-brake cylinders 5a-5b. That is, wheel-cylinder pressures PWFL-PWFR in front wheel-brake cylinders 5a-5b can be built up by the driver's braking operation. In contrast, regarding the rear-wheel side (rear road wheels RL-RR), fluid communication between second brake circuit 2 (branched circuit 2B) and rear wheel-brake cylinders 5c-5d is established, such that pump pressure is supplied via second pressure-buildup control valves 7c-7d (fluid lines 2c-2d) to wheel-brake cylinders 5c-5d. That is, wheel-cylinder pressures PWRL-PWRR of the rear-wheel side are built up by operation of pump P. With the system arrangement of the eighth embodiment (FIG. 20), regarding the rear-wheel side, even during the normal brake mode, pump P(D) and motor M(D) must be operated (energized), and as a result pump P(D) and motor M(D) of the rear-wheel side must be frequently used or operated. For the same reason, with the system arrangement of the sixth embodiment (FIG. 17), regarding the rear-wheel side, even during the normal brake mode, pump P and motor M, common to the front-wheel side and the rear-wheel side, must be operated (energized), and as a result pump P and motor M must be frequently used or operated. As discussed previously, because of the downsized pump P(D) and motor M(D) of the system of the eighth embodiment in comparison with pump P and motor M of the system of the sixth embodiment, the system of the eighth embodiment (see FIG. 20) enables a reduction in electric power consumption (consumed electric current).

Furthermore, in the system of the first embodiment (see FIG. 1), four wheel-cylinder pressures PWFL-PWRR in wheel-brake cylinders 5a-5d must be automatically controlled by means of the single pump P and the single motor M. In a similar manner to the system of the seventh embodiment (see FIG. 19), the system of the eighth embodiment (see FIG. 20) has only to control two wheel-cylinder pressures (e.g., two front wheel-cylinder pressures PWFL-PWFR in wheel-brake cylinders 5a-5b) by means of one pump (e.g., the front-wheel side pump P(C)) and one motor (e.g., the front-wheel side motor M(C)). Thus, it is possible to enhance both the pressure-buildup responsiveness and the control accuracy during wheel-cylinder pressure control.

### Ninth Embodiment

### Hydraulic Circuit of Ninth Embodiment

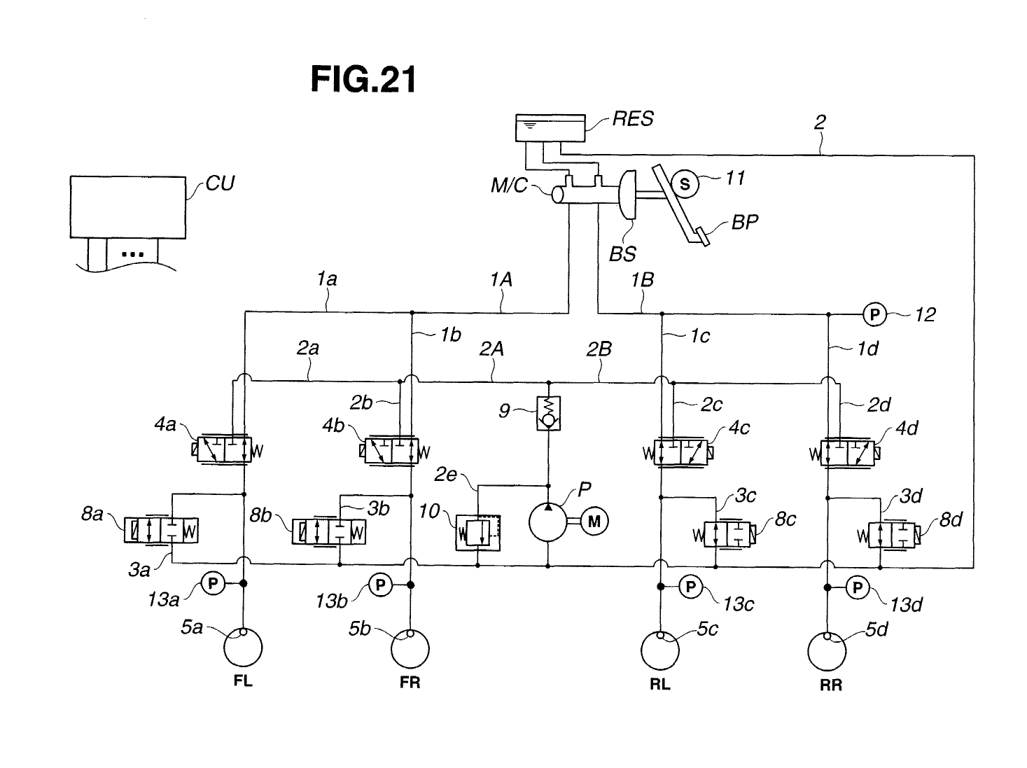

Referring now to FIG. 21, there is shown the hydraulic circuit of the brake control system of the ninth embodiment. The hydraulic circuit of the brake control system of the ninth embodiment shown in FIG. 21 is similar to that of the first embodiment shown in FIG. 1, except that, in the ninth embodiment (see FIG. 21), first and second pressure-buildup control valves 6-7 are united as a three-port valve (hereinafter is referred to as “third pressure-buildup control valve 4”).

As can be seen from the hydraulic circuit of FIG. 21, in the system of the ninth embodiment, third pressure-buildup control valve 4 is provided in the portions of first and second brake circuits 1-2, in which first and second pressure-buildup control valves 6-7 of the system of the first embodiment are disposed. Third pressure-buildup control valve 4 is a normally-open, spring-offset three-port electromagnetic valve. More concretely, third pressure-buildup control valve 4 serves as a so-called proportional valve, which is configured to proportionally change its valve opening depending on a current value of the current flowing through a coil of the electromagnetic valve, thus enabling infinite positioning (indicated by two parallel horizontal bars in the valve symbol of each of third pressure-buildup control valves 4a-4d in FIG. 21). Four third pressure-buildup control valves 4a-4d, which are collectively referred to as “third pressure-buildup control valve 4”, are disposed in respective fluid lines 1a-1d. The downstream ends of fluid lines 2a-2d are also connected to respective pressure-buildup control valves 4a-4d. Each of master cylinder MC and pump P is connected via third pressure-buildup control valves 4a-4d to respective wheel-brake cylinders 5a-5d. The other configuration of the hydraulic circuit of the system of the ninth embodiment shown in FIG. 21 is identical to the first embodiment shown in FIG. 1.

The opening and closing operations of third pressure-buildup control valves 4a-4d are controlled responsively to respective control commands from control unit CU, for establishing (permitting) or blocking (cutting off) the flow of brake fluid flowing through first brake circuit 1 (fluid lines 1a-1d) and for establishing (permitting) or blocking (cutting off) the flow of brake fluid flowing through second brake circuit 2 (fluid lines 2a-2d). When master-cylinder pressure Pm becomes higher than wheel-cylinder pressure Pw (i.e., Pm>Pw), with third pressure-buildup control valve 4 de-energized (OFF), the supply of master-cylinder pressure Pm to wheel-brake cylinder 5 is permitted. With third pressure-buildup control valve 4 energized (ON), the supply of master-cylinder pressure Pm to wheel-brake cylinder 5 is cut off. Conversely when wheel-cylinder pressure Pw becomes higher than master-cylinder pressure Pm (i.e., Pw>Pm), with third pressure-buildup control valve 4 de-energized (OFF), the supply of wheel-cylinder pressure Pw to master cylinder MC is permitted. With third pressure-buildup control valve 4 energized (ON), the supply of wheel-cylinder pressure Pw to master cylinder MC is cut off. In addition to the above, with third pressure-buildup control valve 4 energized (ON), the supply of pump pressure to wheel-brake cylinder 5 is permitted. With third pressure-buildup control valve 4 de-energized (OFF), the supply of pump pressure to wheel-brake cylinder 5 is cut off.

(Third Pressure-Buildup Control Valves)

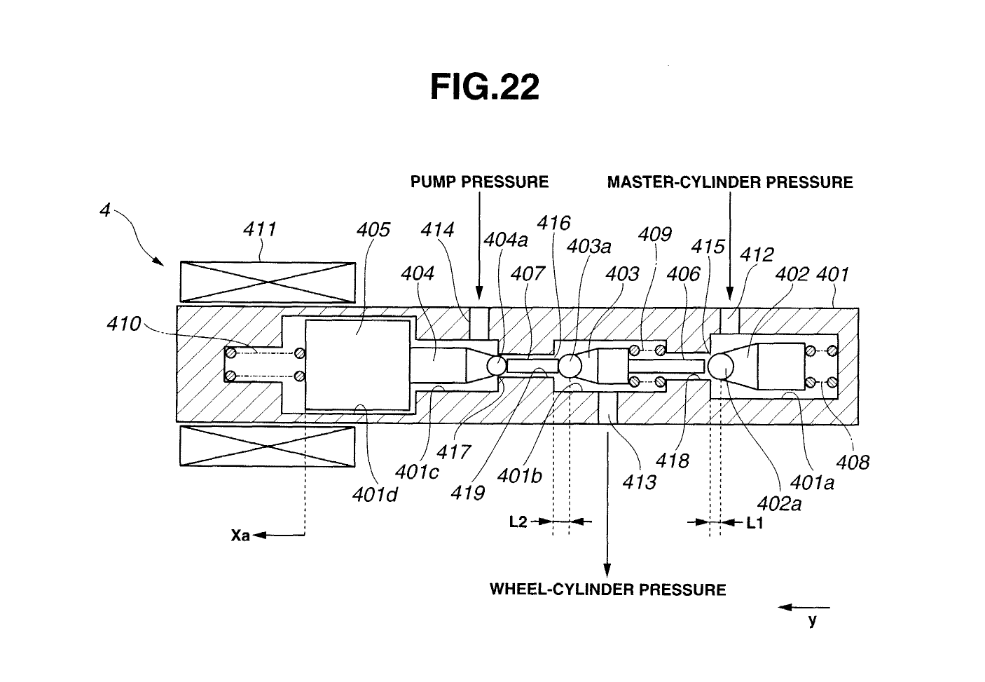

The detailed structure of third pressure-buildup control valve 4 is hereunder described in detail in reference to FIG. 22. FIG. 22 shows the axial cross section of third pressure-buildup control valve 4. In explaining the detailed structure of third pressure-buildup control valve 4, suppose that the axial direction of third pressure-buildup control valve 4 is shown by the arrow y indicative of a y-axis direction, and the y-axis direction oriented from a first plunger 402 to an armature 405 is a positive y-axis direction. As seen in FIG. 22, third pressure-buildup control valve 4 is comprised of a housing 401, the first plunger 402, the second plunger 403, the third plunger 404, armature 405, the first rod 406, the second rod 407, the first spring 408, the second spring 409, the third spring 410, a coil 411, a master-cylinder pressure port 412, a wheel-cylinder pressure port 413, a pump pressure port 414, the first valve seat 415, the second valve seat 416, the third valve seat 417, the first passage 418 and the second passage 419.

Coil 411 is installed on the outer periphery of the side of the positive y-axis direction of housing 401. The first cylinder chamber 401a, the second cylinder chamber 401b, the third cylinder chamber 401c, and the fourth cylinder chamber 401d are defined in housing 401 in that order, from the side of the negative y-axis direction of housing 401 to the side of the positive y-axis direction of housing 401.

Master-cylinder pressure port 412 is configured as a radial bore (a radial through hole), which is formed in housing 401 at the side of the positive y-axis direction of first cylinder chamber 401a. Master-cylinder pressure port 412 opens into or communicates with first cylinder chamber 401a. Master-cylinder pressure port 412 is also connected via first brake circuit 1 (the upstream sides of fluid lines 1a-1d) to master cylinder MC. Wheel-cylinder pressure port 413 is configured as a radial bore (a radial through hole), which is formed in housing 401 substantially at a midpoint of second cylinder chamber 401b. Wheel-cylinder pressure port 413 opens into or communicates with second cylinder chamber 401b. Wheel-cylinder pressure port 413 is also connected via first brake circuit 1 (the downstream sides of fluid lines 1a-1d) to wheel-brake cylinder 5. Pump pressure port 414 is configured as a radial bore (a radial through hole), which is formed in housing 401 at the side of the negative y-axis direction of third cylinder chamber 401c. Pump pressure port 414 opens into or communicates with third cylinder chamber 401c. Pump pressure port 414 is also connected via second brake circuit 2 (fluid lines 2a-2d) to pump P.

First passage 418 is configured as a small-diameter communication passage (an axial through hole extending in the y-axis direction), which is formed in housing 401 between first and second cylinder chambers 401a-401b, in such a manner as to intercommunicate first and second cylinder chambers 401a-401b. In a similar manner, second passage 419 is configured as a small-diameter communication passage (an axial through hole extending in the y-axis direction), which is formed in housing 401 between second and third cylinder chambers 401b-401c, in such a manner as to intercommunicate second and third cylinder chambers 401b-401c.

First plunger 402 is accommodated in first cylinder chamber 401a in such a manner as to be slidable in the y-axis directions. First rod 406 is accommodated in first passage 418 in such a manner as to be slidable in the y-axis directions. Second plunger 403 is accommodated in second cylinder chamber 401b in such a manner as to be slidable in the y-axis directions. Second rod 407 is accommodated in second passage 419 in such a manner as to be slidable in the y-axis directions. Third plunger 404 is accommodated in third cylinder chamber 401c in such a manner as to be slidable in the y-axis directions. Armature 405 is accommodated in fourth cylinder chamber 401d in such a manner as to be slidable in the y-axis directions.

First spring 408 is disposed between the end face of the side of the negative y-axis direction of first plunger 402 and the end face of the side of the negative y-axis direction of first cylinder chamber 401a, such that spring 408 permanently forces first plunger 402 in the positive y-axis direction. Second spring 409 is disposed between the end face of the side of the negative y-axis direction of second plunger 403 and the end face of the side of the negative y-axis direction of second cylinder chamber 401b. Third spring 410 is disposed between the end face of the side of the positive y-axis direction of armature 405 and the end face of the side of the positive y-axis direction of fourth cylinder chamber 401d, such that third spring 410 permanently forces armature 405 in the negative y-axis direction. That is, the spring force of third spring 410 forces the end face of the side of the negative y-axis direction of armature 405 into contact with the end face of the side of the positive x-axis direction of third plunger 404.

First valve seat 415 is formed integral with the stepped portion of housing 401 at the end face of the side of the positive y-axis direction of first cylinder chamber 401a (in other words, at the right-hand opening end of first passage 418, which opening end opens into first cylinder chamber 401a). The tip 402a of the side of the positive y-axis direction of first plunger 402 is arranged to oppose first valve seat 415. Axial movement of first plunger 402 in the positive y-axis direction brings the tip 402a of first plunger 402 into abutted-engagement with first valve seat 415, and then the tip 402a of first plunger 402, serving as a valve element, seats on first valve seat 415. With the tip 402a held on first valve seat 415, the right-hand opening end of first passage 418 (that is, first valve seat 415) is fully closed.

Second valve seat 416 is formed integral with the stepped portion of housing 401 at the end face of the side of the positive y-axis direction of second cylinder chamber 401b (in other words, at the right-hand opening end of second passage 419, which opening end opens into second cylinder chamber 401b). The tip 403a of the side of the positive y-axis direction of second plunger 403 is arranged to oppose second valve seat 416. Axial movement of second plunger 403 in the positive y-axis direction brings the tip 403a of second plunger 403 into abutted-engagement with second valve seat 416, and then the tip 403a of second plunger 403, serving as a valve element, seats on second valve seat 416. With the tip 403a held on second valve seat 416, the right-hand opening end of second passage 419 (that is, second valve seat 416) is fully closed.

Third valve seat 417 is formed integral with the stepped portion of housing 401 at the end face of the side of the negative y-axis direction of third cylinder chamber 401c (in other words, at the left-hand opening end of second passage 419, which opening end opens into third cylinder chamber 401c). The tip 404a of the side of the negative y-axis direction of third plunger 404 is arranged to oppose third valve seat 417. Axial movement of third plunger 404 in the negative y-axis direction brings the tip 404a of third plunger 404 into abutted-engagement with third valve seat 417, and then the tip 404a of third plunger 404, serving as a valve element, seats on third valve seat 417. With the tip 404a held on third valve seat 417, the left-hand opening end of second passage 419 (that is, third valve seat 417) is fully closed.

With first valve seat 415 kept open, fluid communication between master-cylinder pressure port 412 and wheel-cylinder pressure port 413 is established, and thus brake-fluid flow through first brake circuit 1 is permitted. Conversely, with first valve seat 415 kept closed, fluid communication between master-cylinder pressure port 412 and wheel-cylinder pressure port 413 is blocked, and thus first brake circuit 1 is blocked. With second and third valve seats 416-417 both kept open, fluid communication between pump pressure port 414 and wheel-cylinder pressure port 413 is established, and thus brake-fluid flow through second brake circuit 2 is permitted. Conversely, with second and third valve seats 416-417 both kept closed, fluid communication between pump pressure port 414 and wheel-cylinder pressure port 413 is blocked, and thus second brake circuit 2 is blocked.

The function and operation of third pressure-buildup control valve 4 (see FIG. 22) are hereunder described in detail. When electric current is applied from control unit CU to coil 411, current flow through coil 411 produces an electromagnetic force. The electromagnetic force varies depending on an electric current value I of the current flowing through coil 411. The greater the current value I, the greater the electromagnetic force produced from coil 411. The electromagnetic force attracts armature 405 in the positive y-axis direction, such that armature 405 displaces in the positive y-axis direction.

When current value I of the current flowing through coil 411 is “0” (i.e., I=0), the electromagnetic force acting on armature 405 becomes “0”. On the other hand, the spring force of third spring 410 acts on armature 405 in the negative y-axis direction. Third plunger 404 (in abutted-engagement with armature 405), together with armature 405, is forced or pushed in the negative y-axis direction. Axial movement of third plunger 404 in the negative y-axis direction brings the tip 404a of third plunger 404 into abutted-engagement with third valve seat 417, and thus third valve seat 417 becomes closed. Furthermore, by the spring force of third spring 410, second rod 407 (in abutted-engagement with third plunger 404), second plunger 403 (in abutted-engagement with second rod 407), first rod 406 (in abutted-engagement with second plunger 403), and first plunger 402 (in abutted-engagement with first rod 406) are all forced or pushed in the negative y-axis direction. Thus, the tip 403a of second plunger 403 becomes forced off second valve seat 416 and simultaneously the tip 402a of first plunger 402 is forced off first valve seat 415. As a result, second valve seat 416 and first valve seat 415 become kept open.

At this time, the spring force of second spring 409 acts on second plunger 403 in the positive y-axis direction. Additionally, the spring force of first spring 408 acts on first plunger 402 in the positive y-axis direction. Because of spring-force settings defined by the inequality of (spring force F3 of third spring 410)>(spring force F2 of second spring 409)+(spring force F1 of first spring 408), the previously-discussed state of axial positions of plungers 402-404 and armature 405 can be obtained under the specific condition where current value I of the current flowing through coil 411 is “0” (i.e., I=0).

As discussed above, under the condition of I=0 where an axial displacement Xa (described later) of armature 405 is “0”, third valve seat 417 is kept closed, and second valve seat 416 and first valve seat 415 are kept open. Such a valve state (i.e., I=0 and Xa=0) of third pressure-buildup control valve 4 corresponds to a state where, in the system of the first embodiment, first pressure-buildup control valve 6 is kept open and second pressure-buildup control valve 7 is kept closed, and thus second brake circuit 2 is blocked and brake-fluid flow through first brake circuit 1 is permitted.

Assuming that the distance between the tip 402a of first plunger 402 and first valve seat 415 is denoted by reference sign L1 and the distance between the tip 403a of second plunger 403 and second valve seat 416 is denoted by reference sign L2, the relationship between these distances L1-L2 are set or determined to satisfy the inequality L1<L2 under the condition of I=0 (zero current).

As current value I gradually increases from “0”, the electromagnetic force gradually increases from “0”. Armature 405 is attracted in the positive y-axis direction by the electromagnetic force increased in accordance with an increase in current value I. Owing to the increase in current value I, armature 405 begins to slightly displace against the spring force of third spring 410 in the positive y-axis direction. Assuming that the axial displacement of armature 405, created by the attracting force of coil 411, is denoted by “Xa”, third plunger 404 displaces by the same axial displacement Xa as armature 405 in the positive y-axis direction, while being kept in abutted-engagement with armature 405 by the spring force of second spring 409, transmitted via second plunger 403 and second rod 407 to third plunger 404. As a result, third valve seat 417 is kept open.

At this time, second plunger 403 displaces by the same axial displacement Xa as armature 405 in the positive y-axis direction, while being kept in abutted-engagement with second rod 407 by the spring force of second spring 409. First plunger 402 also displaces by the same axial displacement Xa as armature 405 in the positive y-axis direction, while being kept in abutted-engagement with first rod 406 by the spring force of first spring 408.

When the displacement Xa of armature 405 is less than the distance L1 (i.e., Xa<L1), second valve seat 416 is also kept open. Because of the setting (i.e., L1<L2) of two distances L1-L2 under the condition of I=0, when Xa<L1, second valve seat 416 is also kept open. Therefore, under the condition of Xa<L1, first, second, and third valve seats 415-417 are all kept open. Such a valve state (i.e., 0<Xa<L1) of third pressure-buildup control valve 4 corresponds to a state where, in the system of the first embodiment, first pressure-buildup control valve 6 is kept open and second pressure-buildup control valve 7 is kept open, and thus brake-fluid flow through second brake circuit 2 and brake-fluid flow through first brake circuit 1 are both permitted.

Thereafter, when current value I further increases and thus the displacement Xa of armature 405 becomes identical to the distance L1, the tip 402a of first plunger 402 is brought into abutted-engagement with first valve seat 415. As a result, first valve seat 415 is closed. At this time (i.e., when Xa=L1), because of the setting (i.e., L1<L2) of two distances L1-L2 under the condition of I=0, second valve seat 416 is still kept open. Therefore, under the condition of Xa=L1, third valve seat 417 is kept open, second valve seat 416 is kept open, and first valve seat 415 is kept closed. Such a valve state (i.e., Xa=L1) of third pressure-buildup control valve 4 corresponds to a state where, in the system of the first embodiment, first pressure-buildup control valve 6 is kept closed and second pressure-buildup control valve 7 is kept open, and thus brake-fluid flow through second brake circuit 2 is permitted and first brake circuit 1 is blocked.

Thereafter, when owing to a further increase in current value I the displacement Xa of armature 405 exceeds the distance L1 (i.e., L2>Xa>L1), the abutted-engagement between the tip 402a of first plunger 402 and first valve seat 415 (in other words, the closed state of first valve seat 415) is maintained by the spring force of first spring 408. On the other hand, third plunger 404 and second plunger 403 displace by the same axial displacement Xa as armature 405 in the positive y-axis direction by the spring force of second spring 409. That is, under the condition of L2>Xa>L1, third valve seat 417 is kept open, second valve seat 416 is kept open, and first valve seat 415 is kept closed.

Thereafter, when owing to a further increase in current value I the displacement Xa of armature 405 becomes greater than or equal to the distance L2 (i.e., Xa≧L2), the tip 403a of second plunger 403 is brought into and kept in abutted-engagement with second valve seat 416. As a result, second valve seat 416 is closed. Under the condition of Xa≧L2, third valve seat 417 is kept open, second valve seat 416 is kept closed, and first valve seat 415 is kept closed. Such a valve state (i.e., Xa≧L2) of third pressure-buildup control valve 4 corresponds to a state where, in the system of the first embodiment, first pressure-buildup control valve 6 is kept closed and second pressure-buildup control valve 7 is kept closed, and thus first and second brake circuits 1-2 are both blocked.

### Effects of Ninth Embodiment

(18) The apparatus for controlling brakes, made according to the ninth embodiment, includes brake pedal BP to which a driver's braking operation is made, and a manipulated variable detector (i.e., stroke sensor 11) configured to detect a manipulated variable (i.e., a brake-pedal stroke SBP) of brake pedal BP. A first control valve (first pressure-buildup control valve 6) and a second control valve (second pressure-buildup control valve 7) are united as a three-port valve (third pressure-buildup control valve 4). The three-port valve (third pressure-buildup control valve 4) has a first port (master-cylinder pressure port 412) connected to master cylinder MC, a second port (pump pressure port 414) connected to a fluid-pressure source (pump P), and a third port (wheel-cylinder pressure port 413) connected to wheel-brake cylinder 5. Control unit CU is configured to execute, based on the detected manipulated variable of brake pedal BP, switching between (i) a first state where fluid communication between the first port (master-cylinder pressure port 412) and the third port (wheel-cylinder pressure port 413) is established and (ii) a second state where fluid communication between the second port (pump pressure port 414) and the third port (wheel-cylinder pressure port 413) is established.

Therefore, the system of the ninth embodiment of FIGS. 21-22 can provide the same operation and effects as the first embodiment, by controlling a displacement Xa of armature 405 by way of a change in electric current value I of the current supplied to coil 411 in such a manner as to correspond to respective opening-closing states of first and second pressure-buildup control valves 6-7 employed in the system of the first embodiment. Additionally, by the use of third pressure-buildup control valve 4 (the three-port valve), the function of two control valves, namely, first and second pressure-buildup control valves 6-7, can be realized by the single control valve (the three port valve), thereby realizing the compact hydraulic circuit (the downsized hydraulic control unit or the downsized hydraulic modulator).

### [Modifications]

In the system of the first embodiment, used as a pressure control valve (i.e., each of first and second pressure-buildup control valves 6-7, and pressure-reduction control valve 8) is a so-called electromagnetic proportional valve whose valve opening proportionally changes depending on an electric current value of the current flowing through a coil of the electromagnetic valve. Instead of using such a proportional valve, a two-position electromagnetic valve, often called “ON-OFF valve”, which is switchable between a full open state and a fully closed state, may be used. In lieu thereof, first pressure-buildup control valve 6 may be constructed as an ON-OFF electromagnetic valve, whereas each of second pressure-buildup control valve 7 and pressure-reduction control valve 8 may be constructed as a proportional valve. That is, to provide a desired hydraulic modulator for wheel-cylinder pressure control, ON-OFF valves and proportional valves may be properly combined with each other.

The entire contents of Japanese Patent Application No. 2007-238741 (filed Sep. 14, 2007) are incorporated herein by reference.

While the foregoing is a description of the preferred embodiments carried out the invention, it will be understood that the invention is not limited to the particular embodiments shown and described herein, but that various changes and modifications may be made without departing from the scope or spirit of this invention as defined by the following claims.

What is claimed is:

1. An apparatus for controlling brakes, comprising:
a master cylinder;
a wheel-brake cylinder;
a brake booster configured to actuate the master cylinder for a pressure increase of brake fluid in the master cylinder;
a first brake circuit configured to supply brake fluid, which is pressure-increased by the brake booster, to the wheel-brake cylinder;
a first control valve disposed in the first brake circuit for establishing and blocking fluid communication between the master cylinder and the wheel-brake cylinder;
a fluid-pressure source provided for a pressure increase of brake fluid, separately from the brake booster;
a second brake circuit arranged in parallel with the first brake circuit and configured to supply brake fluid, which is pressure-increased by the fluid-pressure source, to the wheel-brake cylinder;
a second control valve disposed in the second brake circuit for establishing and blocking fluid communication between the fluid-pressure source and the wheel-brake cylinder; and
a control unit provided to control operations of the first control valve, the second control valve, and the fluid-pressure source, said control unit configured to selectively control the first control valve and the second control valve when building up wheel-cylinder pressure in the wheel-brake cylinder, and further configured to build up the wheel-cylinder pressure by operating the fluid-pressure source when at least the second control valve is controlled to a valve-open position.

2. The apparatus for controlling brakes, as claimed in claim 1, wherein:
a valve-seat diameter of the first control valve is dimensioned to be greater than a valve-seat diameter of the second control valve.

3. The apparatus for controlling brakes, as claimed in claim 1, further comprising:
a reservoir communicating with a back-pressure chamber of the master cylinder;
a third brake circuit via which the wheel-brake cylinder and the reservoir are connected to each other; and
a third control valve disposed in the third brake circuit for establishing and blocking fluid communication between the wheel-brake cylinder and the reservoir.

4. The apparatus for controlling brakes, as claimed in claim 1, wherein:
the first control valve is a normally-open valve; and
the second control valve is a normally-closed valve.

5. The apparatus for controlling brakes, as claimed in claim 4, wherein:
the normally-open valve is arranged to permit fluid pressure from the master cylinder to act in a direction for opening the normally-open valve.

6. The apparatus for controlling brakes, as claimed in claim 4, wherein:
the normally-open valve is arranged to permit fluid pressure from the wheel-brake cylinder to act in a direction for opening the normally-open valve.

7. The apparatus for controlling brakes, as claimed in claim 2, wherein:
the first control valve is a normally-open valve; and
the second control valve is a normally-closed valve.

8. The apparatus for controlling brakes, as claimed in claim 7, wherein:
the normally-open valve is arranged to permit fluid pressure from the master cylinder to act in a direction for opening the normally-open valve.

9. The apparatus for controlling brakes, as claimed in claim 8, further comprising:
a third brake circuit via which the wheel-brake cylinder and the reservoir are connected to each other; and
a third control valve disposed in the third brake circuit for establishing and blocking fluid communication between the wheel-brake cylinder and the reservoir.

10. The apparatus for controlling brakes, as claimed in claim 1, further comprising:
a brake pedal to which a driver's braking operation is made; and
a manipulated variable detector configured to detect a manipulated variable of the brake pedal,
wherein the control unit is configured to selectively control, based on the detected manipulated variable of the brake pedal, the first control valve and the second control valve, and further configured to control the second control valve to a valve-open position, when the detected manipulated variable of the brake pedal is greater than or equal to a predetermined threshold value.

11. The apparatus for controlling brakes, as claimed in claim 1, wherein:
the first brake circuit is provided only for a front-wheel brake system that builds up the wheel-cylinder pressure in the wheel-brake cylinder of a front-wheel side of an automotive vehicle.

12. The apparatus for controlling brakes, as claimed in claim 4, wherein:
the first brake circuit and the second brake circuit (2) are provided for each individual road wheel of an automotive vehicle;
the first control valve is a normally-open valve;
of these normally-open valves of the road wheels, the normally-open valve, associated with a front-wheel side of the vehicle, is arranged to permit fluid pressure from the master cylinder to act in a direction for opening the front-wheel side normally-open valve; and
of these normally-open valves of the road wheels, the normally-open valve, associated with a rear-wheel side of the vehicle, is arranged to permit fluid pressure from the wheel-brake cylinder to act in a direction for opening the rear-wheel side normally-open valve.

13. The apparatus for controlling brakes, as claimed in claim 4, wherein:
the first brake circuit and the second brake circuit are provided for each individual road wheel of an automotive vehicle;
the first control valve is a normally-open valve;
of these normally-open valves of the road wheels, the normally-open valve, associated with a front-wheel side of the vehicle, is arranged to permit fluid pressure from the wheel-brake cylinder to act in a direction for opening the front-wheel side normally-open valve; and
of these normally-open valves of the road wheels, the normally-open valve, associated with a rear-wheel side of the vehicle, is arranged to permit fluid pressure from the master cylinder to act in a direction for opening the rear-wheel side normally-open valve.

14. The apparatus for controlling brakes, as claimed in claim 1, further comprising:
a brake pedal to which a driver's braking operation is made; and
a manipulated variable detector configured to detect a manipulated variable of the brake pedal,
wherein the first control valve and the second control valve are united as a three-port valve, the three-port valve has a first port connected to the master cylinder, a second port connected to the fluid-pressure source, and a third port connected to the wheel-brake cylinder, and the control unit is configured to execute, based on the detected manipulated variable of the brake pedal, switching between a first state where fluid communication between the first port and the third port is established and a second state where fluid communication between the second port and the third port is established.

15. An apparatus for controlling brakes, comprising:
a master cylinder;
a wheel-brake cylinder;
a brake booster configured to actuate the master cylinder for a pressure increase of brake fluid in the master cylinder;
a first brake circuit configured to supply brake fluid, which is pressure-increased by the brake booster, to the wheel-brake cylinder;
a fluid-pressure source provided for a pressure increase of brake fluid, separately from the brake booster;
a second brake circuit arranged in parallel with the first brake circuit and configured to supply brake fluid, which is pressure-increased by the fluid-pressure source, to the wheel-brake cylinder;
a manipulated variable detector configured to detect a manipulated variable of the brake pedal; and
a control unit configured to select either one of a pressure buildup achieved by the first brake circuit and a pressure buildup achieved by the second brake circuit,
wherein, during the pressure buildup achieved by the second brake circuit, the control unit executes brake-by-wire control that automatically pressurizes brake fluid in the wheel-brake cylinder responsively to the detected manipulated variable.

16. The apparatus for controlling brakes, as claimed in claim 15, wherein:
the control unit is configured to select the pressure buildup achieved by the second brake circuit, when the detected manipulated variable of the brake pedal is greater than or equal to a predetermined threshold value.

17. The apparatus for controlling brakes, as claimed in claim 16, wherein:
the first brake circuit is provided only for a front-wheel brake system that builds up the wheel-cylinder pressure in the wheel-brake cylinder of a front-wheel side of an automotive vehicle.

18. The apparatus for controlling brakes, as claimed in claim 3, wherein:
the control unit is further configured to control the first control valve and the third control valve to their valve-open positions, when a desired pressure-reduction speed of the wheel-cylinder pressure in the wheel-brake cylinder is greater than or equal to a predetermined speed value.

19. The apparatus for controlling brakes, as claimed in claim 1, wherein:
the fluid-pressure source comprises a pump and an accumulator, which stores high-pressure brake fluid, produced by operation of the pump.

20. The apparatus for controlling brakes, as claimed in claim 1, wherein:
the fluid-pressure source comprises a pump, which is driven by an electric motor;
the pump for a front-wheel side of an automotive vehicle and the pump for a rear-wheel side of the vehicle are provided independently of each other.

21. The apparatus for controlling brakes, as claimed in claim 20, wherein:
the first brake circuit is provided only for a front-wheel brake system that builds up the wheel-cylinder pressure in the wheel-brake cylinder of the front-wheel side of the vehicle.

22. A method of controlling brakes, using a brake control system having a master cylinder, a wheel-brake cylinder, a brake booster configured to actuate the master cylinder for a pressure increase of brake fluid in the master cylinder, a first brake circuit configured to supply brake fluid, which is pressure-increased by the brake booster, to the wheel-brake cylinder, a fluid-pressure source provided for a pressure increase of brake fluid, separately from the brake booster, and a second brake circuit arranged in parallel with the first brake circuit and configured to supply brake fluid, which is pressure-increased by the fluid-pressure source, to the wheel-brake cylinder, comprising:
controlling, responsively to a manipulated variable of a brake pedal, switching among a pressure buildup achieved by only the first brake circuit, a pressure buildup achieved by only the second brake circuit, and a pressure buildup achieved by both the first brake circuit and the second brake circuit.

23. The method of controlling brakes, as claimed in claim 22, wherein:
executing brake-by-wire control that automatically pressurizes brake fluid in the wheel-brake cylinder responsively to the manipulated variable, during the pressure buildup achieved by only the second brake circuit.

24. The method of controlling brakes, as claimed in claim 22, wherein:
executing brake-assist control that assists a driver's braking operation, during the pressure buildup achieved by both the first brake circuit and the second brake circuit.
